(19) United States
(12) Patent Application Publication
(10) Pub. No.: US 2015/0262499 A1
(43) Pub. Date: Sep. 17, 2015

(54) HEALTH MANAGEMENT SYSTEM

(71) Applicant: Novu LLC, Saint Louis Park, MN (US)

(72) Inventors: James C. Wicka, Chanhassen, MN (US); John D. Wicka, Chanhassen, MN (US); Thomas C. Wicka, Edina, MN (US)

(21) Appl. No.: 14/428,263

(22) PCT Filed: Sep. 13, 2013
(86) PCT No.: PCT/US2013/059709

§ 371 Date: Mar. 13, 2015

Related U.S. Application Data
(60) Provisional application No. 61/701,385, filed on Sep. 14, 2012.
(60) Provisional application No. 61/764,860, filed on Feb. 14, 2013.

(51) Int. Cl. G09B 7/02; G06F 19/00; G06Q 30/02

(52) U.S. Cl. CPC G09B 7/02; G06Q 30/0226; G06F 19/3481; G06F 19/3406

(57) ABSTRACT

A health management system that guides and encourages users to make healthy lifestyle choices.

This application is being filed on 13 Sep. 2013, as a PCT International patent application, and claims priority to U.S. Provisional Patent Application No. 61/701,385, filed Sep. 14, 2012, and U.S. Provisional Patent Application No. 61/764,860, filed Feb. 14, 2013, the disclosures of which are hereby incorporated by reference herein in their entirety.

### BACKGROUND

Customized health management is commonly provided through personal interaction with a personal trainer, nutritionist, therapist, or similar health care professionals. Health care professionals commonly provide education about health and life style management as well as motivation and support in an individual's personal attempts to change their health and life style. Personal interaction with a health care professional, however, has various limitations, such as the limitation on the amount of time a single health care professional can dedicate to an individual patient. Further, personal interaction with health care professionals is often quite costly.

### SUMMARY

In general terms, the present disclosure is directed to a health management system. In one possible configuration, and by non-limiting example, the health management system guides and encourages users to make healthy lifestyle choices. In some configurations, and as another example, a system provides rewards to encourage users to perform certain activities within the system.

One aspect is a method comprising: displaying, on a user interface, an initial assessment; calculating one or more scores based on answers received in response to the initial assessment; displaying, on the user interface, a recommended goal based on at least one of the one or more scores; receiving a selected goal; displaying, on the user interface, a recommended plan based on the selected goal and at least one of the one or more scores; receiving a selected plan; displaying, on the user interface, a recommended program based on the selected plan and at least one of the one or more scores; receiving a selected program; and based on user program performance, updating at least one of the one or more scores.

Another aspect is a method comprising: sending, via an input device, answers based on an initial assessment of questions; viewing, on a user interface, a recommended goal presented in response to the answers and further viewing at least one alternate goal; selecting, via the input device, a goal; viewing, on the user interface, a recommended plan presented in response to the goal selected and further viewing at least one alternate plan; selecting, via the input device, a plan; viewing, on the user interface, a recommended program presented in response to the plan selected and further viewing at least one alternate program; and selecting, via the input device, a program.

A further aspect is a method of guiding a person toward a healthier lifestyle, the method comprising: prompting the person to complete an initial assessment; identifying a healthier lifestyle goal for the person based at least in part on one or more scores computed from answers to the initial assessment; identifying and presenting to the person a recommended plan based at least in part on the selected goal and at least one of the one or more scores; identifying and presenting to the person a recommended program based at least in part on the selected plan and at least one of the one or more scores; and monitoring the person's progress according to the recommended program and updating at least one of the one or more scores based at least in part on the person's progress.

Yet another aspect is a method of providing rewards to users of a system, the method comprising: defining point rewarding activities within the system; awarding points to users for performing one or more of the activities; providing rewards to the users in exchange for at least some of the points, wherein the rewards have no per-unit cost to the system provider.

A further aspect is a method of rewarding activity within an online community, the method comprising: providing a rewards engine configured to manage points for users within the online community; providing a point definition engine, the point definition engine operable to receive an identification of events within the online community for which points are to be awarded; and operating the rewards engine to award points to users within the online community when the identified events occur within the online community.

Another aspect is a method of providing rewards to patients for following the advice of a health care professional, the method comprising: receiving an identification of one or more actions recommended by a health care professional for a person; awarding points to the person when the person performs the recommended actions; and providing a reward to the person in exchange for at least some of the points.

Yet another aspect is a system including at least a processing device and a computer readable storage medium, wherein the computer readable storage medium stores data instructions, which when executed by the processing device cause the processing device to execute any one or more of the methods described herein.

Another aspect is a method of challenging users. The method includes presenting a list of challenges to a first user; receiving a selection of a first challenge in the list of challenges from the first user; receiving periodic user entries from the first user relating to the first challenge; scoring the user entries in relation to entries received from other users; ranking the first user in relation to the other users; and presenting the ranking to the first user.

### BRIEF DESCRIPTION OF THE DRAWINGS

FIG. 1 is a diagram illustrating an exemplary health management system environment.

FIG. 2 illustrates an exemplary architecture of a computing device.

FIG. 3 is a schematic block diagram of an example health management system.

FIG. 4 is a schematic block diagram of an example health management engine.

FIG. 5 is a schematic block diagram of an example assessment engine.

FIG. 6 is a schematic block diagram of an example score calculation engine.

FIG. 7 is a schematic block diagram of an example goal creation engine.

FIG. 8 is a schematic block diagram of an example social connection engine.

FIG. 9 is a flow chart illustrating one method of creating and participating in a challenge.

FIG. 10 is a schematic block diagram of an example point redeeming engine.

FIG. 11 is a flow chart illustrating one method of utilizing the health management system of FIG. 1 from the perspective of the health management server and a user.

FIG. 12 is a screenshot illustrating one example of an initial assessment.

FIG. 13 is a screenshot illustrating one example of a life score evaluation.

FIG. 14 is a screenshot illustrating one example of a goal recommendation and selection screen.

FIG. 15 is a screenshot illustrating one example of a plan recommendation and selection screen.

FIG. 16 is a screenshot illustrating one example of a ParQ Assessment screen.

FIG. 17 is a screenshot illustrating one example of a program recommendation and selection screen.

FIG. 18 is a screenshot illustrating one example of a screen displayed to a user after selecting a program.

FIG. 19 is a screenshot illustrating one example of an audio/visual resource.

FIG. 20 is a screenshot illustrating one example of a plan recommendation and selection screen.

FIG. 21 is a screenshot illustrating one example of a nutritional evaluation.

FIG. 22 is a screenshot illustrating one example a program recommendation and selection screen.

FIG. 23 is a screenshot illustrating one example a plan recommendation and selection screen.

FIG. 24 is a screenshot illustrating one example of a health management user home page.

FIG. 25 is a screenshot illustrating one example of a check-in screen.

FIG. 26 is a screenshot illustrating one example of a user profile screen.

FIG. 27 is a screenshot illustrating one example of an edit profile screen.

FIG. 28 is a screenshot illustrating one example of an activity stream screen.

FIG. 29 is a screenshot illustrating one example of a rewards screen.

FIG. 30 is a screenshot illustrating one example point redemption screen.

FIG. 31 is a screenshot illustrating one example of a user profile screen.

FIG. 32 is a screenshot illustrating one example of a user profile screen.

FIG. 33 is a screenshot illustrating one example of a user profile screen.

FIG. 34 is a screenshot illustrating one example of a user profile screen.

FIG. 35 is a screenshot illustrating one example of a user profile screen.

FIG. 36 is a screenshot illustrating one example of a local living screen.

FIG. 37 is a screenshot illustrating one example of an invite screen.

FIG. 38 is a screenshot illustrating another example of the invite screen.

FIG. 39 is a screenshot illustrating one example of a challenge monitoring screen.

FIG. 40 is a screenshot illustrating another example of the challenge monitoring screen shown in FIG. 39.

FIG. 41 is a screenshot illustrating another example of the challenge monitoring screen shown in FIG. 39.

FIG. 42 is a screenshot illustrating another example of a challenge monitoring screen.

FIG. 43 is a screenshot illustrating another example of the challenge monitoring screen shown in FIG. 42.

FIG. 44 is a screenshot illustrating another example of a challenge monitoring screen.

FIG. 45 is a screen shot illustrating another example of a challenge monitoring screen.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In general, the present disclosure describes systems and methods involving a health management system that encourages users to make choices that will lead to a healthier lifestyle. In some embodiments, the health management system provides a wide variety of resources, such as health wellness training, education, routines, schedules, examinations, progress monitoring, and the like, which are directed at improving the overall health, fitness, and lifestyle of its users.

In some embodiments, users interact with the health management system through an electronic user interface which provides many of the benefits associated with a personal trainer, for example, without the inconvenience associated with frequent face-to-face meeting. Further, some embodiments include a dynamic learning engine and recommendation engine that is customized to present each user with a unique schedule of activities based on the user's individual needs and desires. The programs provided by the health management system encompass a wide spectrum of health related topics, such as nutrition, fitness, weight management, stress relieving, and life purpose. Furthermore, some embodiments of the health management system provide an interactive social network which enables the users to share various information, such as program progress, achievements, activities, and the like, with friends, family, co-workers, and other connections on the social networking site.

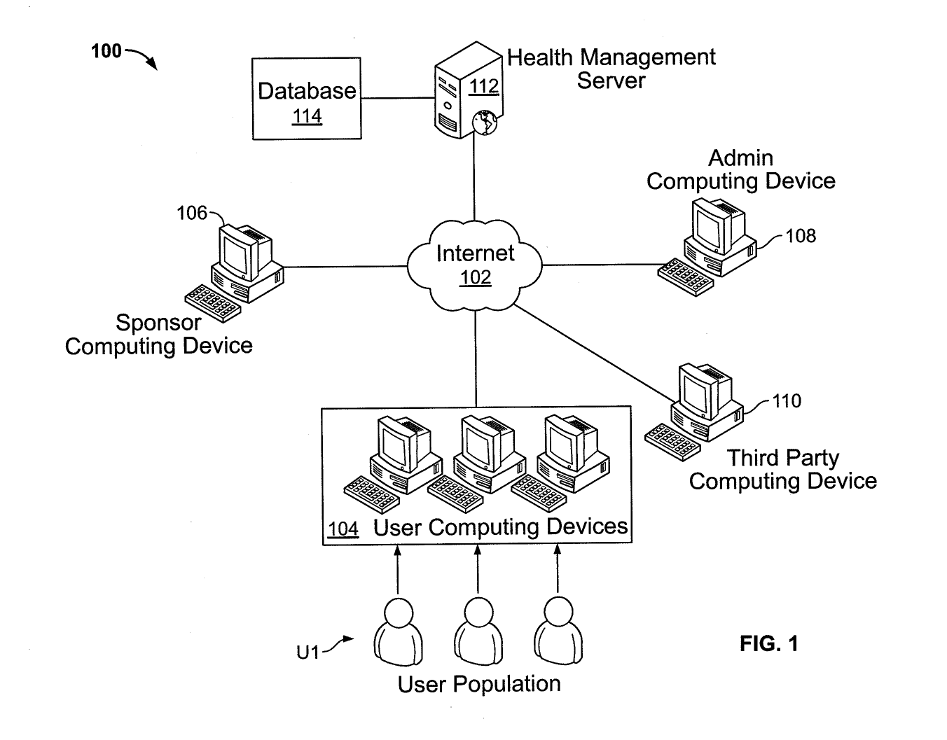

FIG. 1 is a schematic block diagram illustrating an exemplary health management system environment 100. The health management system environment 100 includes a network 102, user computing devices 104, a sponsor computing device 106, an administrative computing device 108, a third party computing device 110, and a health management server 112. The health management server 112 is configured to utilize a database 114. The plurality of user computing devices 104 is operated by a plurality of users, such as a user U1.

The network 102 is a data communication network that communicates digital data between computing devices. One example of the network 102 is a local area network. Other embodiments include other networks, however, such as the Internet or other data communication networks. The network 102 can also be a combination of multiple networks. The network 102 can include wired communication, wireless communication, optical communication, and combinations of communication types.

The user computing devices 104 are configured to communicate with the health management server 112 through the network 102. The user computing devices 104 are operated by a plurality of users, such as user U1. The users operate the user computing devices 104 to interact with the health management server 112. The computing devices 104 are located at any location accessible to the plurality of users, such as, for example, at the residence or business place of the users. Alternatively, the computing devices may be portable computing devices, such as laptop computers, electronic tablets, smart phones, or the like, and thus may be accessible at any location. The users utilize the user computing devices 104 to interact with the health management server 112 and access services provided by the health management server 112.

The sponsor computing device 106 is also configured to communicate with the health management server 112 though the network 102. The sponsor computing device 106 is operated by a sponsor associated with the user population. For example, the sponsor may be an employer, insurance provider, or other third-party paying for the services provided by the health management server 112. The user population may access the paid services by interacting with the health management server 112. In some embodiments, a user, such as user U1, may pay for accessing the health management server 112 without relying on a sponsor's payment.

The third party computing device 110 is also configured to communicate with the health management server 112, and any other computing devices connected to the network, including, for example, the user computing devices 102, the sponsor computing device 106, and/or the administrative computing device 108. The third party computing device 110 provides external resources and/or services for users of the health management server 112. For example, in one embodiment, the third party computing device 110 is an external, electronically accessible retailer, which allows the user population to redeem points earned during interaction with the health management server 112 for products sold by the retailer. In other embodiments, the third party computing device 110 can be charities, foundations, gymnasiums, travel agencies, or any other third party which provides services, products, and/or resources for the user population. In some embodiments, the third party computing device is additionally, or alternatively, a server which enables user to access third party resources.

The health management server 112 is configured to communicate with all computing devices connected to the network 102. More specifically, the health management server 112 utilizes the database 114 to provide resources such as health-related services to the user population. The administrative computing device 108 may be utilized by an administrator of the health management system 100 to alter functions, settings, and like on the health management server 112.

In general, the users interact with the health management server 112 to access various health-related programs. The programs are categorized under various goals, such as, for example, nutrition, fitness, weight management, life purpose, stress, and the like. After a survey of questions, the health management server 112 recommends a goal that would likely be compatible with the specific user's lifestyle, motivation, and interests. Thereafter, a user may either select the recommended goal or continue with an alternate goal. The user is then presented with a plan within a goal. For example, if the user selects the goal, “Nutrition,” the health management server 112 may recommend a “Protein” plan to the user. Finally, the user is presented with a structured program for a specified amount of time, for example, two weeks, which includes activities, tasks, training, and education directed at the plan. For example, if the user enters the “Protein” plan, the two-week program associated with this plan may engage the user to consume a certain amount of protein each day for two-weeks. Alternatively, the two-week program may be more or less detailed, having the same or different activities, tasks, training, and/or educational items each day.

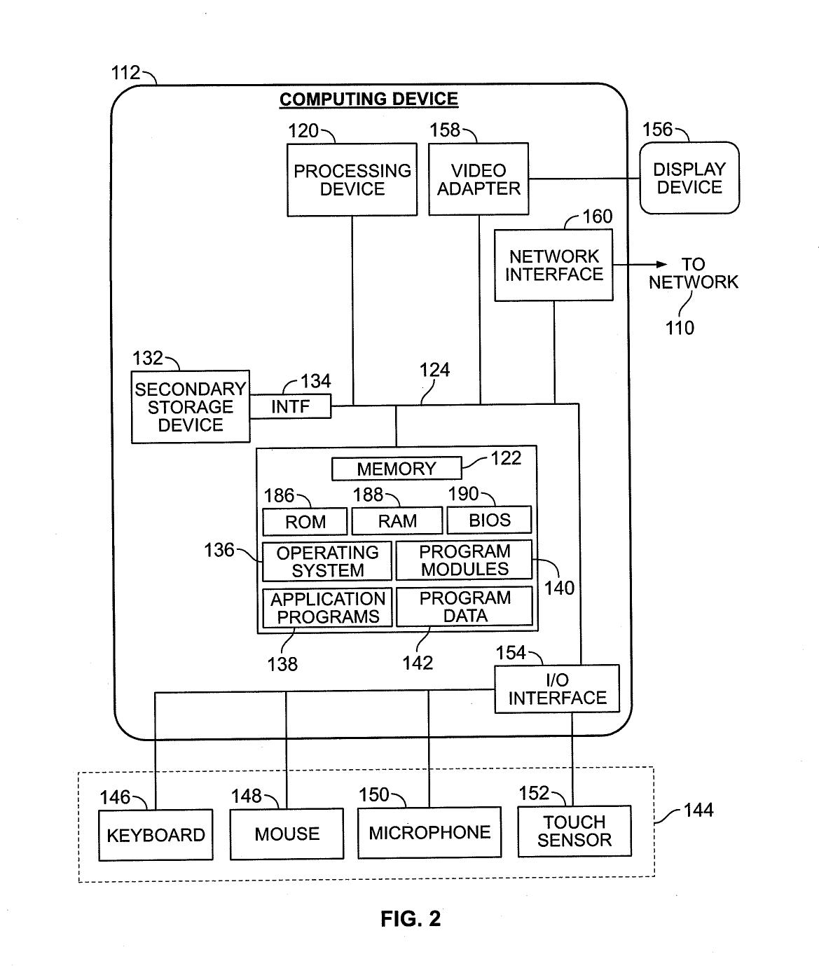

FIG. 2 illustrates an exemplary architecture of a computing device that can be used to implement aspects of the present disclosure, including the health management server 112 and/or computing devices 104, 106, 108, 110, and will be referred to herein as the server 112. One or more computing devices, such as the type illustrated in FIG. 2, are used to execute the operating system, application programs, and software modules (including the software engines) described herein.

The server 112 includes, in some embodiments, at least one processing device 120, such as a central processing unit (CPU). A variety of processing devices are available from a variety of manufacturers, for example, Intel or Advanced Micro Devices. In this example, the server 112 also includes a system memory 122, and a system bus 124 that couples various system components including the system memory 122 to the processing device 120. The system bus 124 is one of any number of types of bus structures including a memory bus, or memory controller; a peripheral bus; and a local bus using any of a variety of bus architectures.

Examples of computing devices suitable for the server 112 include a desktop computer, a laptop computer, a tablet computer, a mobile phone device such as a smart phone, or other devices configured to process digital instructions.

The system memory 122 includes read only memory 126 and random access memory 128. A basic input/output system 130 containing the basic routines that act to transfer information within server 112, such as during start up, is typically stored in the read only memory 126.

The server 112 also includes a secondary storage device 132 in some embodiments, such as a hard disk drive, for storing digital data. The secondary storage device 132 is connected to the system bus 124 by a secondary storage interface 134. The secondary storage devices and their associated computer readable media provide nonvolatile storage of computer readable instructions (including application programs and program modules), data structures, and other data for the server 112.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 132 or memory 122, including an operating system 136, one or more application programs 138, other program modules 140, and program data 142. The database 114 may be stored at any location in the memory 122, such as the program data 142, or at the secondary storage device 132, or on a separate computing device.

In some embodiments, server 112 includes input devices to enable the user to provide inputs to the server 112. Examples of input devices 144 include a keyboard 146, pointer input device 148, microphone 150, and touch sensitive display 152. Other embodiments include other input devices 144. The input devices are often connected to the processing device 120 through an input/output interface 154 that is coupled to the system bus 124. These input devices 144 can be connected by any number of input/output interfaces, such as a parallel port, serial port, game port, or a universal serial bus. Wireless communication between input devices and interface 154 is possible as well, and includes infrared, BLUETOOTH® wireless technology, 802.11a/b/g/n, cellular or other radio frequency communication systems in some possible embodiments.

In this example embodiment, a touch sensitive display device 156 is also connected to the system bus 124 via an interface, such as a video adapter 158. The touch sensitive display device 156 includes touch sensors for receiving input from a user when the user touches the display. Such sensors can be capacitive sensors, pressure sensors, or other touch sensors. The sensors not only detect contact with the display, but also the location of the contact and movement of the contact over time. For example, a user can move a finger or stylus across the screen to provide written inputs. The written inputs are evaluated and, in some embodiments, converted into text inputs.

In addition to the display device 156, the server 112, and any of the computing devices in the system, can include various other peripheral devices (not shown), such as speakers or a printer.

When used in a local area networking environment or a wide area networking environment (such as the Internet), the server 112 is typically connected to the network through a network interface, such as a wireless network interface 160. Other possible embodiments use other communication devices. For example, some embodiments of the server 112 include an Ethernet network interface, or a modem for communicating across the network.

The server 112 typically includes at least some form of computer-readable media. Computer readable media includes any available media that can be accessed by the server 112. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the server 112. Some embodiments include non-transitory computer readable storage media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

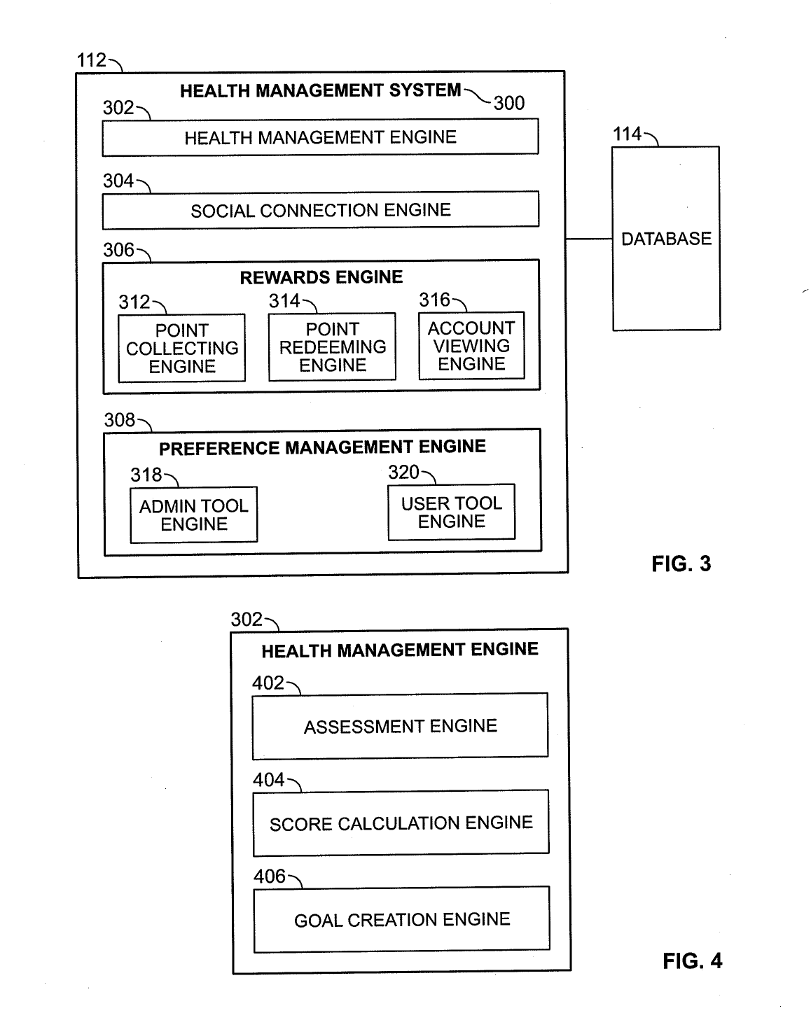

Now referring to FIG. 3, one embodiment of the health management server 112, health management system 300, is shown. The health management system 300 includes a health management engine 302, a social connection engine 304, a rewards engine 306, and a preference management engine 308. The rewards engine 306 includes a point collecting engine 312, a point redeeming engine 314, and an account viewing engine 316. The preference management engine includes an administrative tool engine 318 and a user tool engine 320. The health management system is in data communication with the database 114.

The health management engine 302 is configured to assess the user of the system 300, calculate various scores associated with the user, and determine system recommendations to the user. The health management engine 302 initially presents the user with several assessment questions to determine an initial gauge of the motivation, interests, and goals of the user. To accomplish this, the health management engine 302 calculates one or more scores, such as a life score, a c-score, or a progress score. The health management engine 302 then utilizes the one or more calculated scores to determine which goals, programs, and plans would benefit the user. More details regarding the health management engine 302 is discussed below with reference to FIG. 4.

The social connection engine 304 is configured to enable users of the system 300 to interact with other members of the system. For example, in some embodiments, the social connection engine enables users to create and manage a public profile, interact with social connections, share and view information relating to social connections, and create, recommend, or participate in challenges (discussed in greater detail below). In general, the social connection engine 304 enables the user population to communicate about health-related topics and share progress on the site. Furthermore, the social connection engine 304 enables the user population to connect with members having the same or similar interests and goals, in an effort to increase the motivation and participation of individual users.

In yet further embodiments, the social connection engine 304 enables users to communicate with external websites, parties, computing devices, or the like. For example, in some embodiments, the social connection engine 304 enables users to connect to Facebook and/or Twitter accounts, or other known social media sites. Also, the social connection engine 304 may allow users to communicate with various support groups so that users may engage in motivational communications with external groups and/or people. More information about the social connection engine 304 is discussed below with reference to FIG. 8.

The rewards engine 306 is configured to enable users to collect, view, and redeem points. In general, the rewards engine 306 acts as a motivational engine configured to increase user participation by rewarding positive progress and continuation with the goals, plans, and programs, social interaction, application tasks, and many other interactions with the system. The rewards engine 306 includes the point collecting engine 312, the point redeeming engine 314, and the account viewing engine 316.

The point collecting engine 312 rewards points to users based on completion of activities, participation in activities, and/or continued progress in goals, plans, and/or programs. For example, in some embodiments, the point collecting engine 312 distributes points to users for completing a two-week program within a plan, participating in a challenge, or participating in a new activity. In other embodiments, points may be given for various alternate reasons, and generally act as a motivational tool for user participation. In some embodiments, the point collecting engine 312 stores a listing of all previous point rewards for individual users, thereby preventing users from collecting points for completing the same activities more than once. However, in alternate embodiments, users may simply be awarded a lesser number of points for completing an activity more than once.

The point redeeming engine 314 enables users to redeem the points they have collected for services, products, charitable donations, and the like. For example, in some embodiments, the point redeeming engine 314 interacts with the third party computing device 110 to provide users with a wide variety of options. For example, a user may purchase products or sign-up for services, such as gym memberships, by using the points earned during interacting with the health management system 300. Alternatively, or additionally, users may redeem points for charitable donations. For example, a user may redeem 1,000 points and earn a charitable donation of $50 to a charity of the user's choice. It is understood that the numbers used herein are only examples, and varying points may be redeemed for varying levels of charitable donations, products, prizes, services, or the like.

The account viewing engine 316 enables the user population to determine the number of points collected and redeemable by an individual user. In some embodiments, the user may be able to view any previous redemptions made, how many points remain, and how many points were collected since the last redemption. In some embodiments, users are able to view how many points are needed to purchase the product, prize, service, and/or charitable donation they wish to purchase.

The preference management engine 308 enables users and administrators to alter system settings. The preference management engine 308 includes the administrative tool engine 318 and the user tool engine 320. Administrators and users may utilize the tools 318, 320, respectively, to adjust settings to their preferences. For example, users may alter social networking privacy settings, goal/plan/program settings, activity settings, and the like via the user tool engine 320. Administrators may add or delete users, third party members, and/or sponsors via the administrative tool engine 318. In some embodiments, administrators may block user activity if reported as inappropriate and/or offensive.

In yet further embodiments, administrators may configure the rewards engine 306 so that administrators may control whether and how many points a user is awarded for various activities/actions within the system. For example, administrators may configure the rewards engine 306 such that users may be rewarded points for any activity a user engages in within the system. In other words, administrators may ensure that the system operates with a full integrated rewards system such that any user interaction with the system may be connected with the rewards engine 306. For example, the administrator may configure points to be awarded to users for interacting in social activities. Alternatively, or additionally, points may be awarded when user's follow a health care professional's recommendations and/or advice (if any). One example of a rewards configuration is shown on page A4 of Appendix A. It is understood that various other settings may be altered via the tools 318, 320.

The database 114 includes data that is utilized by one or more of the health management engine 302, the social connection engine 304, the rewards engine 306, and the preference management engine 308. For example, the database 114 may include training and educational items, videos, articles, goal/plan/program schedules, predetermined counts associated with score calculations, one or more lists of points associated with different activities, a list of all users, sponsors, and third parties, a list of all challenges and groups created by users in the social network, user information and the like. User information may include user responses to questions, a list of evaluations taken by a user, calculated scores, point collecting and spending information, personal background information, and the like. It is understood that all engines shown in FIG. 3 have access to the database 114 and may access it at any time to collect data stored within the database 114. In some embodiments, the database 114 is part of server 112, while in other embodiments, the database 114 is one or more separate computing devices.

Referring now to FIG. 4, one embodiment of the health management system 300 is shown. The health management system 300 includes an assessment engine 402, a score calculation engine 404, and a goal creation engine 406.

The assessment engine 402 is configured to present the user with various assessments at various levels of interaction with the health management system 300. For example, the assessment engine 402 asks users several questions to determine basic information about the user and the user's motivation level, interests, and goals. For example, upon beginning interaction with the health management system 300, the assessment engine 402 will present an initial assessment to the user. The initial assessment includes a variety of questions, including, for example, questions related to biographical data, health measurement data, general user interests (e.g., likes, dislikes), previous experiences with health-related improvement, user lifestyle, and the like. The score calculation engine utilizes this information to calculate scores relating to the user's recommended participation level and goal/plan/program.

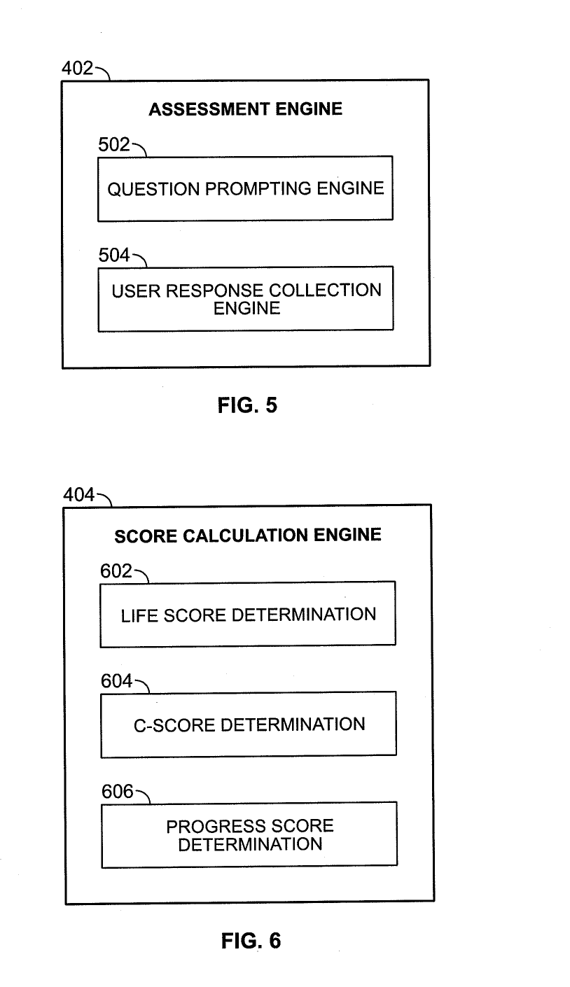

After the initial assessment, the assessment engine 402 may present the user with various other assessment questions at different times during its interaction with the site. For example, after the user selects a goal, the assessment engine 402 may prompt the user with further assessment questions to determine which plan in the goal to recommend, and further which program in the plan to recommend. In some embodiment, the assessment engine 402 may prompt the user during or after plans and/or programs to gauge the user's continued interest, motivation, and/or happiness with the plans and/or programs. The assessment engine is discussed in greater detail below with references to FIG. 5.

The score calculation engine 404 is configured to calculate various scores relating to the user throughout the user's interaction with the health management system 300. For example, after the initial assessment, the score calculation engine 404 utilizes the user's responses to calculate a life score. The life score represents the user's present health status, motivation to change, and interests. Thereafter, the goal creation engine 406 utilizes the life score to recommend an appropriate goal for the user.

The score calculation engine 404 calculates the life score, c-score, and progress score. In general, the life score is an initial score that is calculated based on the initial assessment taken by the user. The life score acts as a measure of the user's overall wellness at the time of taking the initial assessment. The life score is presented to the user upon completion of the initial assessment and may motivate the user to engage with the system to learn more about his/her health and wellness. In some embodiments, the life score only changes when the initial assessment is retaken.

The c-score is a determination of the user's desire to change. On the most basic level, the c-score is a representation of the user's motivation. In some embodiments, user's with a high c-score are self-motivated and need little encouragement and reinforcement to complete tasks related to health and life improvement. On the other hand, users with a low c-score may require additional support and guidance to encourage such users to complete activities focused on self-improvement. In some embodiments, the system may determine more than one c-score based on different categories of health, such as, for example, fitness, nutrition, and well-being.

In general, the progress score is a measurement of the user's current health state. In some embodiments, unlike the life score, the progress score continues to change based on the user's interaction or lack of interaction with the system. As discussed in greater detail below, the user's progress score is representative of the user's need to change in conjunction with the user's desire to change over three areas of health: fitness, nutrition, and well-being. Thus, in some embodiments, the progress score incorporates one or more c-scores and aggregates these c-scores with scores representative of the need to change to determine the overall progress score. The various scores and how they are calculated are discussed in more detail below with respect to FIG. 6.

The goal creation engine 406 is configured to utilize information from the assessment engine and the score calculation engine and recommend a goal for the user. The goal creation engine 406, for example, recommends one of nutrition, fitness, weight management, purpose, and stress. After the user either selects the recommended goal or chooses an alternative goal, the goal creation engine 406 utilizes more information from the assessment engine 402 and/or the score calculation engine 404 to recommend a plan to the user. In some embodiments, a plan is composed of several 2-week programs. Again, after the user either selects the recommended plan or chooses an alternative plan, the goal creation engine 406 utilizes more information from the assessment engine 402 and/or the score calculation engine 404 to recommend a program to the user.

In some embodiments, once a user has selected and completed a program, the goal creation engine 406 utilizes more information for engines 402, 404 to either recommend a new goal, plan, and/or program. In some embodiments, the goal creation engine 406 may recommend activities, challenges, groups, events, local activities, and the like, from the social network that the engine 406 determines may be beneficial or of interest to the user. In alternate embodiments, the social connection engine 304 may instead, or alternatively, utilize the one or more scores and/or other information stored in the database 114 about the user to recommend activities, challenges, groups, events, local activities, and the like, to users.

Now referring to FIG. 5, one embodiment of the assessment engine 402 is shown. The assessment engine 402 includes a question prompting engine 502 and a user response collection engine 504.

As discussed above, the assessment engine 402 prompts a user with assessment queries and receives responses from a user. The question prompting engine 502 accesses the database 114 for questions and/or question hierarchies for prompting the user. For example, the question prompting engine 502 may access a general initial assessment presented to each user during his first interaction with the website. Alternatively, the question prompting engine 502 may access goal, plan, and/or program evaluations directed at specific goals, plans, and/or programs. For example, in some embodiments, a specific program may require a certain level of physical strength. To ensure that a user is capable of enduring the required level of physical activity, the question prompting engine 502 can access a physical activity questionnaire from the database 114 and present the questionnaire to the user. In yet further embodiments, different plans may include different evaluations so that the system can determine whether a user would be motivated and/or interested in engaging in the plan. In such scenarios, the question prompting engine may enter the database 114 to access the corresponding evaluation questions.

In alternate embodiments, the question prompting engine 502 may also base question prompting, at least in part, on responses already collected in the user response collection engine 504 and/or responses stored in the database 114, by response and program progress history and trending, and associated progressive response algorithms.

After the question prompting engine 502 presents the user with one or more questions, the user response collection engine 504 collects the user answers and stores them in the database 114. In some embodiments, history and trending of responses over repeat answering may be stored in the database 114 as well. Thereafter, the system may access the answers for determinations about the particular user's interests, motivations, desires, needs, general information, etc. In some embodiments, this eliminates the need for the question prompting engine 502 to ask repeated questions to the user. Instead, the system may simply access answers to previously presented questions which are stored in the database 114.

Now referring to FIG. 6, one example of the score calculation engine 404, score calculation engine 600, is illustrated. The score calculation engine 600 includes a life score determination engine 602, a c-score determination engine 604, and a progress score determination engine 606.

The life score determination engine 602 determines the user's initial life score. In some embodiments, the life score represents a measure of the user's overall wellness at the time of taking the initial assessment. The life score may only be changed if the user decides to later retake the initial assessment. In calculating the life score, the life score determination engine 602 may interact with the database 114 to determine various count totals associated with different questions and answers in the initial assessment. Based on the user's answers and the predetermined counts, the life score determination engine 602 either gives or takes away a certain number of counts. Thereafter, the life score determination engine 602 aggregates the total number of counts. In some embodiments, this number represents the user's life score which is then presented to the user after the initial assessment.

The life score determination engine 602 also tracks cohort scores which are groupings of life scores of members that are in the same demographic categories as the user. It is presented to the user at the same time as the results of the life score once the user completes his/her initial assessment. In some embodiments, the cohort score is hidden by default, but with the user having an option to view it. In general, cohort scores can be categorized by member age and/or gender, but can also be categorized by various other groupings, for example, employment characteristics (e.g., company, department, and location), demographics, geography, medical condition or insurance product, or a consumer sector. Thus, the cohort score categorization is flexible and can be configured by the system or by administrators of the system to meet users' and/or system's needs.

The c-score determination engine 604 calculates one or more c-scores associated with the user. As stated above, the c-score is a determination of the user's desire to change and represents the user's self-motivation. In some embodiments, the c-score determination engine 604 may determine one or more c-score for the user based on motivation levels in different areas of health, such as, for example, fitness, nutrition, and well-being. Upon initially interacting with the system, a user's one or more c-scores may be determined based upon the initial assessment, in a similar fashion as described above for the life score. However, in other embodiments, as the user continues to engage and interact with the system, the c-score determination engine 604 continually updates the one or more c-scores to reflect the user's interaction levels, progress, success, dedication, and the like. To calculate the score, in some embodiments, the c-score determination engine 604 may access the database 114 to determine predetermined count totals that are either added or subtracted from the one or more c-scores based on activities accomplished or unaccomplished by the user. For example, the database 114 may indicate that for logging into the system every day, the user will receive 5 counts that are added to the user's c-score. In other embodiments, the database 114 may indicate that for completing a fitness activity in the amount of time scheduled by the system, the user's fitness c-score will be increased by 7 counts. In some embodiments, the one or more c-scores are not presented to the user, but instead, used as sub-scores to calculate the progress score which is presented to the user. In some embodiments, the life score (discussed above) may be determined based on associated c-scores. In yet further embodiments, the life score may be determined based on c-score and one or more alternate scores chosen by an administrator. A basic algorithm of the inputs used to calculate the life score and c-score in one embodiment is shown on page A2 of Appendix A.

The progress score determination engine 606 calculates the user's progress score which is a general representation of the user's evolving health state. Unlike the life score, the progress score represents change, and thus, alters based on the user's interaction with the system. In some embodiments, the progress score is initially calculated based on the initial assessment and continues to evolve based on the user's interaction and engagement with the system. In some embodiments, the user's progress score is representative of both the user's desire to change and the user's need to change. Thus, the progress score determination engine 606 may access the c-score determination engine 604 and utilize the user's one or more c-scores to aggregate together to determine a progress score. In some embodiments, the progress score determination engine 606 determines the progress score based on the user's need to change and desire to change in three categories: fitness, nutrition, and well-being. Thus, the progress score determination engine 606 determines a score representative of the user's need to change for each category. The progress score determination engine 606 then adds this score with the user's c-score in the specific category. Finally, the progress score determination engine 606 aggregates each sub-score in each category to determine an overall progress score. Information used to calculate the progress score (and continually update the score) may be accessed from the database 114 and any other information about the user that the user allows the system to access. For example, in some embodiments, the progress score may be based on medical records of the user accessed through an electronic medical records system.

In alternate embodiments, the progress score is completely independent of the life score and the individual c-scores. Instead, in such embodiments, the progress score is a measure of engagement and interaction with the system and the system's offerings. In these embodiments, progress score determination engine 606 is determined exclusively from members' interactions with the system. As such, each discrete interaction contributes a certain value to the progress score, but with diminishing returns (as the overall score increases, the contributing value decreases). This is due to the fact that the progress number, in some embodiments, may be capped at a certain maximum score, such as, for example, 600. In such embodiments, the progress score can also decrease over time, if members decrease their engagement with the system over time. In some embodiments, however, the level of reduction of the progress score for not engaging in a certain activity is not as great as the level of addition to the score for completing the same action. A basic algorithm of the inputs used to calculate the progress score for this embodiment is shown on page A3 of Appendix A.

As the user engages with the system, the user's individual c-scores for each category and the user's need to change scores for each category are modified, which causes a change in the overall progress score. Thus, the progress score may increase or decrease based on user interaction levels and dedication to the system. In some embodiments, as the progress score changes, information may be sent to the electronic medical records system to update information in the user's medical record.

In some embodiments, the progress score and life score are the only scores that are presented to the user. In other embodiments, one or more sub-scores for the progress score are also presented to the user. For example, the aggregate of the c-score and the need to change score for each category (fitness, nutrition, well-being, and the like), or a standardized version of each, is presented to the user along with the overall progress score.

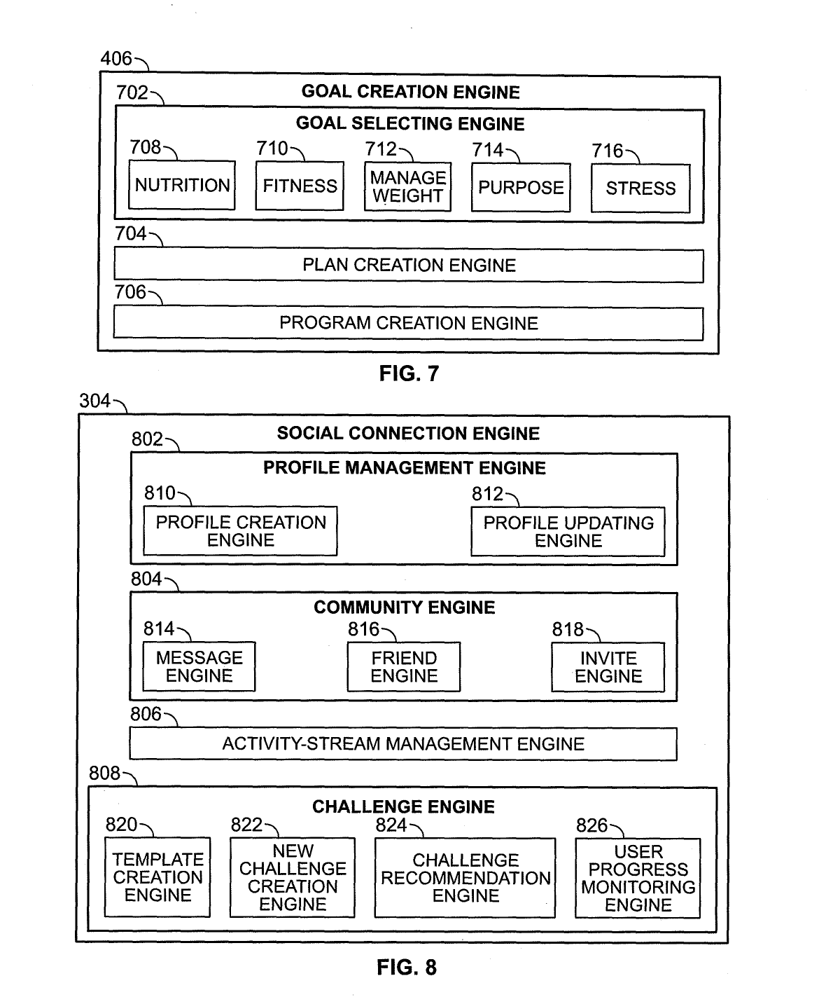

Now referring to FIG. 7, one example of the goal creation engine 406 is shown. In the example, the goal creation engine 406 includes a goal selecting engine 702, a plan creation engine 704, and a program creation engine 706. The goal selecting engine 702 includes a nutrition goal 708, a fitness goal 710, a weight management goal 712, a life purpose goal 714, and a stress reducing goal 716.

The goal selecting engine 702 utilizes information about the user to recommend one of the goals 708-716 for the particular user. In some embodiments, other goals may additionally exist, such as, for example, sleep improvement/management, smoking cessation, financial health goals, health essentials, cognitive goals, relationships, chronic condition management, depression, work, drug adherence, family wellness. In order to recommend a goal, the goal selecting engine 702 utilizes information about the user, such as, stored responses to questions stored in the database 114, previous site activity, previous goal/plan/program completion information, and the like. For example, if the user is new to the site, the goal selecting engine 702 may simply utilize the results of the initial assessment to determine which goal should be recommended to the user. More specifically, as discussed above, the goal selecting engine 702 may utilize one or more of the calculated scores to recommend a goal to the user. In some embodiments, upon presenting the user with a recommended goal, the user has an option of selecting the recommended goal or choosing an alternative goal.

Once the user has selected a goal, the plan creation engine 704 recommends a plan within the goal which suits the user's interests, motivations, desires, and/or needs. In some embodiments, a further assessment may be required to gather more information about a user prior to recommending a plan within a goal. In alternative embodiments, the system may have enough information about the user stored in the database 114 to recommend a plan without prompting the user with any further questions. Similarly to the goal selecting engine 702, the plan creation engine 704, may utilize the results of assessments, evaluations, users' activity and previous goal/plan/program completion information, and/or calculated scores to recommend a plan within the selected goal. In some embodiments, upon presenting the user with a recommended plan, the user has an option of selected the recommended plan or choosing an alternative plan.

In yet further embodiments, a selected goal may not include previously stored plans associated with the goal. Thus, the plan creation engine 704 may utilize the question prompting engine 502 to prompt the user with a series of questions to determine information about the user. In some embodiments, the plan creation engine 704 utilizes the responses to the series of questions and/or information previously stored in the database 114 to create a unique plan for the user incorporating information collected about the user.

Once the user has selected a plan within a goal, the program creation engine 706 selects or creates a program within the plan. In some embodiments, programs are a short term set of daily activities to be completed by the user. An example of a short term length is two weeks. In yet further embodiments, programs may be between one week to four weeks in length, depending on the type of program. Similar to the goal selecting engine 702 and the plan creation engine 704, the program creation engine 706 utilizes information stored in the database 114 about the user and/or utilizes the question prompting engine 502 to prompt the user with new questions to determine which program best suits the user. In yet further embodiments, a selected plan may not include predetermined programs. In such cases, the system may utilize assessments, evaluations, and/or user responses from previous questionnaires to create a program particularly suited to the individual user. In yet further embodiments, the program creation engine 706 may not recommend a program because it is not available to a user prior to the user completing a prerequisite program. Thus, in some embodiments, the program creation engine 706 may recommend some programs only after other prerequisite programs have been first completed. More information about the various goals, plans, and programs are discussed below with reference to the several screen shots included herein.

Now referring to FIG. 8, one example of the social connection engine 304 is shown. In the example, the social connection engine 304 includes a profile management engine 802, a community engine 804, an activity-stream management engine 806, and a challenge engine 808. The profile management engine includes a profile creation engine 810 and a profile updating engine 812. The community engine 804 includes a message engine 814, a friend engine 816, and an invite engine 818. The challenge engine 808 includes a template creation engine 820, a new challenge creation engine 822, a challenge recommendation engine 824, and a user progress monitoring engine 826. The social connection engine 800 is connected to the database 114. In general, the social connection engine 304 manages the social connection aspects of the system 300.

The profile management engine 802 manages user and administrative profiles for the system. More specifically, the profile management engine 802 controls the creation and maintenance of profiles. For example, the profile management engine 802 allows a user to input information which is then shared with other users via a profile. In some embodiments, the type and amount of information shared is controlled by the user's preferences. For example, a user may choose not to share certain personal information with the public. Alternatively, a user may choose to share information only with a certain group of people. The profile management engine 802 enables a user to select privacy controls, share the level of information desired, and later revise and maintain profile information.

The profile creation engine 810 enables a new user to create a user profile. In some embodiments, the profile creation engine 810 presents the user with a series of questions that, once answered, are shared on the user profile. For example, some questions may determine basic background information about the user, such as the user's name, gender, email, phone number, address, etc. Other questions may determine more detailed information about the user, such as the user's interests, needs, desires, lifestyle, etc. The profile creation engine 810 may also enable a user to share one or more photographs with his or her connections.

The profile updating engine 812 enables a user to revise and maintain a previously created profile. For example, a user may input certain information when creating a new profile. Thereafter, certain information may later change and the user may want to alter the information originally inputted into the profile. For example, a user's name may change. The profile updating engine 812 enables a user to alter basic information, personal information, information relating to interests, hobbies, dislikes, needs, desires, lifestyles, etc. Furthermore, the profile updating engine 812 enables a user to add and/or delete photographs from the user's profile. In some embodiments, the profile updating engine 812 also enables a user to alter privacy settings so that various members of the user's community of connections may view selected portions of the user's profile.

The community engine 804 is configured to control aspects of community interaction. For example, the community engine 804 enables a user to communicate with other members, connect with other members, and engage with other members via invitations to groups, events, challenges, and the like. In some embodiments, the community engine 804 controls the users' interaction with groups and events. Furthermore, in some embodiments, the community engine 804 may recommend groups, events, and friends to a user based on the user's interaction with the system and other information stored in the database 114 about the user. In yet further embodiments, the community engine 804 may also control the user's interaction with support groups or other internal or external grouping of people and/or resources intended to encourage the user. For example, an external support group may be a grouping of individuals not associated with the system. The community engine 804 may enable a user to communicate with the external support group through emails, messages, and the like. Alternatively, an internal support group may be a grouping of users on the website with a similar interest. The community engine 804 may enable a user to communicate with the internal support group in a similar fashion. Users may be enabled to alter privacy settings based on level of desired contact with external or internal individuals.

The community engine 804 includes the message engine 814, the friend engine 816, and the invite engine 818. Each of the engines 814, 816, 818 enables a user to interact with other users in the social community. For example, the user may “invite” a person the user knows to be a friend or social connection on the system. Thereafter, the user and the new social connection may interact, share information, follow each other's daily activities, send messages, and the like. The invite engine 818 allows the user to invite other social connections and members of the overall social community to groups, events, challenges, and the like.

For example, groups may include associations of one or more members of the system which have a common interest. In some embodiments, a user may create a group based on a personal interest and invite other users to join the group. Alternatively, in some embodiments, administrators may create a group and invite users to join the group. In yet further embodiments, users may browse the system through a search or navigation input and view groups that may be of interest to the user. Thereafter, the user may find a group and ask the founders of the group to join the group. In some embodiments, events may also be created by users, administrators, or entire groups. Similarly as discussed above, users may be invited to events, or request to join events.

The community engine 804 may also enable user to browse through local events, activities, attractions, volunteer events, and the like, which are external to the system. For example, in some embodiments, the community engine 804 may provide a user with a local events pages which allows the user to view social opportunities that exist in a geographical location near the user. In some embodiments, the users may be able to browse the events, activities, and attractions. In other embodiments, the system may recommend local events, attractions, and activities, to a user based on information stored about the user in the database 114. In yet further embodiments, users may have to pay a separate payment for such a service.

The activity-stream management engine 806 accumulates data and presents the data to the user as an activity stream of user information. For example, the activity stream may be information about the user's social connections. In some embodiments, the activity stream may include one or more posts about the user's social connections indicating that the social connection has completed an activity, joined a group, made a friend, completed a challenge, completed a goal, or the like. In fact, the activity stream may display various types of information about the user's social connections. In some embodiments, the activity stream provides up to date information that is newly refreshed so to provide the latest information about the user's social connections to the user. The activity stream may also include information about events, groups, challenges, updates to goals, programs, and plans, and the like.

The challenge engine 808 controls the creation and user engagement with challenges. In general, a challenge is an activity created by a user or an administrator. The challenge is then either sent to a user or found by a user for user engagement. For example, a user may create a challenge in which the activity is to run a half marathon. The user may then send the challenge to a social connection and “challenge” the social connection to engage in the challenge. If the social connection agrees to participate in the challenge, and accomplishes the challenge, the social connection may be awarded one or more points.

The template creation engine 820 enables a user or administrator to create a challenge. In some embodiments, the template creation engine 820 is presented to the user as a series of questions to determine the type of activity, the location of the activity, the details of the challenge, and the like. In some embodiments, the creator of the challenge may be able to indicate how many points the challenge is worth if completed. In other embodiments, however, only an administrator may be able to indicate a point total.

The new challenge creation engine 822 handles the submission of challenge templates created by users and/or administrators. The new challenge creation engine 822 may allow public access to the challenge and determine if any users may be interested in joining the newly created challenge.

The challenge recommendation engine 824 allows a user to recommend a challenge to a social connection. In some embodiments, based on various privacy settings, the challenge recommendation engine 824 may allow a user to recommend a challenge to members of the community that are not friends with the user.

The user progress monitoring engine 826 monitors the challenges that a user has indicated that he/she will participate in and determines whether the user will be awarded points based on the level of completion. In some embodiments, the user progress monitoring engine 826 may require the user to provide documentation indicative that the user has in fact completed the challenge. In other embodiments, the user progress monitoring engine 826 may not require any documentation or proof. The user progress monitoring engine 826 may interact with the rewards engine 306 to award the user with a certain number of points for each completed or partially completed challenge.

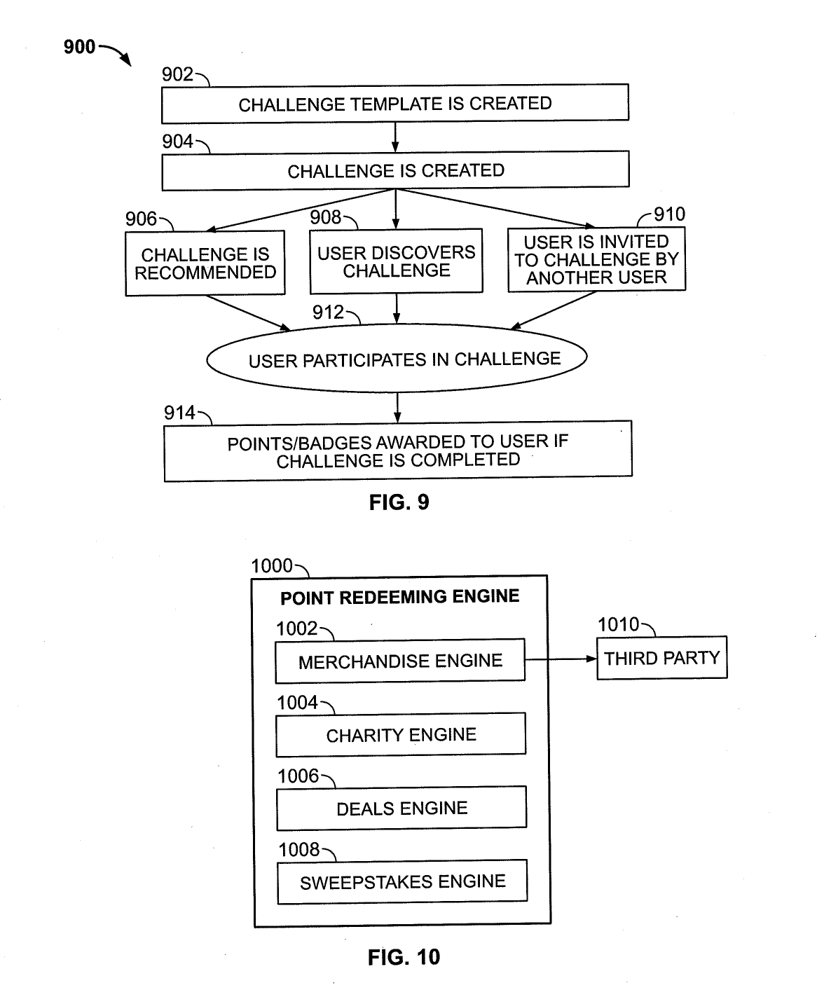

Now referring to FIG. 9, one embodiment of a method 900 of creating and engaging in a challenge is illustrated. The method 900 includes operations 902, 904, 906, 908, 910, 912, and 914. As indicated above, a challenge is any activity that a user or a system administrator “challenges” other user of the system to complete. For example, a user may “challenge” another user to participate in a half-marathon. In another example, a user may “challenge” another user to lose three pounds in a week. Based on whether users participate and/or complete the challenge, points may be awarded to the users.

The method 900 begins at operation 902 in which a challenge template is created. A challenge template can be one of many templates and is prepared by users of the system and/or system administrators. In some embodiments, the challenge template includes the name of the activity, information related to the activity, the times and deadlines associated with the activity, and any other information that a user would likely need to participate in the activity. For example, if the challenge is to run a particular marathon, the template would include the name of the marathon, the location of the marathon, the date and time of the marathon, and any other parts the challenge including, for example, the time under which users must complete the marathon.

At operation 904, the challenge is created. Thus, either a user or an administrator of the system completes and submits a challenge template. Thereafter, the challenge may be accessed by any users of the system. In alternate embodiments, the creator of the challenge may limit privacy settings associated with the challenge thereby ensuring that only portion of all users of the system may view the challenge. For example, in some embodiments, the creator indicates that only social connections connected to the user can view and participate in the challenge.

After the challenge is created, a user comes across the challenge in one of several ways. For example, at operation 906 the challenge is recommended to the user by the system. Based on information stored about the user in the database 114, the system determines that the user may have an interest in the particular challenge. For example, if the user indicated in a previous assessment that the user has participated in several previous marathons, the system may utilize this information to determine that the user may be interested in participating in a challenge to run a marathon.

Alternatively, or additionally, the user may separately discover the challenge at operation 908. For example, the user may browse social connections and notice that a social connection created or is participating in the challenge. In this way, the user may be introduced to the challenge.

Again, alternatively, or additionally, the user may be invited to participate in the challenge at operation 910. For example, a user may determine that a friend may enjoy a certain challenge. Thereafter, the user may send a challenge invitation to the friend. An invitation of this nature may be accomplished by the invite engine 818, discussed above with reference to FIG. 8.

At operation 912, after the user discovers the challenge through one or more of operations 906, 906, and 910, the user participates in the challenge. After completing the challenge, the user indicates to the system by a user input that the activity was completed. In some embodiments, the user is required to input details associated with the challenge to verify that the challenge was in fact completed. In other embodiments, the system does not require any further information, and simply proceeds to operation 914 once the user indicates that he/she has completed the challenge.

At operation 914, the system awards the user with points and/or badges for participating and completing the challenge. In some embodiments, the system may award points and/or badges for both participating and completing the challenge, however, in other embodiments, the system may require that the user complete the challenge before any points are awarded. The value of points and/or badges that the user is awarded may depend on various factors including whether the template indicated how many points the challenge was worth, whether the user has participated in the same or similar challenges in the past, the level of difficulty of the challenge, and various other factors relating to the individual and/or the challenge.

Now referring to FIG. 10, one example of the point redeeming engine 314 is depicted. The point redeeming engine 314 includes a merchandise engine 1002, a charity engine 1004, a deals engine 1006, and a sweepstakes engine 1008. The point redeeming engine 314 may access the database 114 and one or more third parties 1010.

In general, the point redeeming engine 314 enables the user to redeem points that have been earned. Points can be redeemed, for example, for merchandise, charitable donations, product and service deals, sweepstakes, or the like. In this way, the system motivates a user to engage in goals, plans, programs, activities, and social interaction by providing a point awarding and redeeming system.

The merchandise engine 1002 controls the user's interaction with third parties, such as the third party 1010, to redeem points for merchandise. In some embodiments, merchandise may include products and services provided by the one or more third parties 1010. The merchandise engine 1002 interacts with the one or more third parties 1010 to provide merchandise at discounted rates to the user. Thus, by redeeming points, the users may receive merchandise from the one or more third parties 1010 by paying a discounted rate or, in some embodiments, no money at all. In some embodiments, the system provides a full shopping experience to its users wherein the merchandise engine 1002 procures the products and services.

The charity engine 1004 controls the user's interaction with the one or more third parties 1010 to redeem points for charitable donations. For example, the charity engine 1004 may contract with third party charities so that for every 1000 points redeemed, a $50 charitable donation is given to that specific charity. The various point totals and dollar amounts may differ based on the charity and other external and internal factors.

The deals engine 1006 allows the user to interact with the one or more third parties 1010 to redeem deals for products and services in a locality proximal to the user. For example, the deals engine 1006 enables the user to browse for different third-parties and redeem points for coupons and discounted offers at various locations, including for example, restaurants, movie theaters, entertainment locations, stores, barbers, gyms, and the like. For example, a user may redeem 50 points to receive $10 off at a local restaurant near the user's residence.

The sweepstakes engine 1008 allows the user to engage in sweepstakes. In some embodiments, two sweepstakes exist in the system: a point's sweep and a tasks sweep. For example, the point's sweep may allow a user to redeem points to purchase one or more raffle tickets for a sweepstakes. If the raffle ticket is chosen, the user may receive merchandise, deals, or the like. Alternatively, the tasks sweep is a sweepstakes in which a user receives a raffle ticket for completing a certain activity, such as, for example, a program, daily activity, plan, goal, challenge, and the like. Similarly, if the raffle is chosen, the user may receive a prize, such as merchandise, deals, etc.

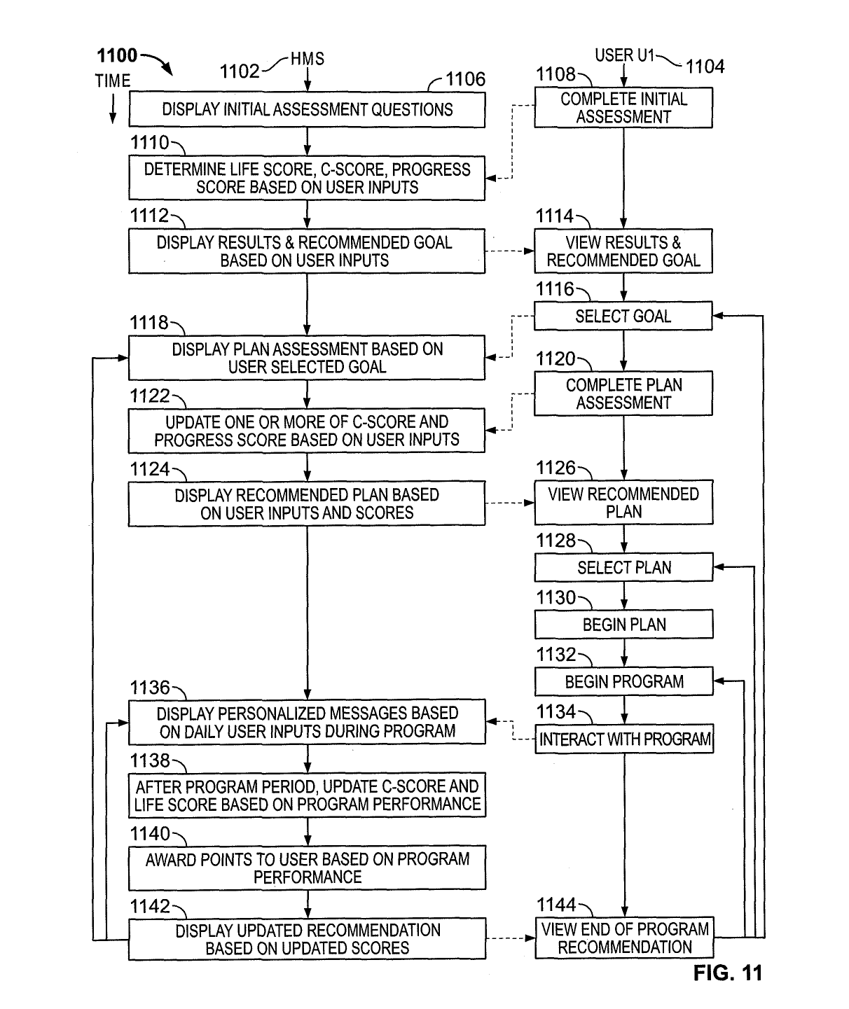

Now referring to FIG. 11, a dual flow chart 1100 is depicted. The dual flow chart 1100 includes a method 1102 of operating the health management system and a method 1104 of using the health management system.

At operation 1106, the health management system displays one or more initial assessment questions to the user. As stated above, the initial assessment questions are directed at determining a current health status of the user, a motivation to change of the user, and a user's need to change. At operation 1108, the user views the displayed initial assessment and completes the assessment. In some embodiments, the user completes the assessment by utilizing an input device to input answers to each question.

At operation 1110, the system determines an initial life score, one or more c-scores, and a progress score for the user. As stated above, these calculations are carried out, for example, by one or more of the life score determination engine 600, the c-score determination engine 604, and the progress score determination engine 606.

At operation 1112, one or more of the scores are displayed to the user along with an explanation and a recommended goal. In some embodiments, only the life score is displayed to the user at this time. Alternatively, in some embodiments, one or more of the life score, the c-score, and the progress score are displayed to the user. At operation 1114, the user views the displayed information. At operation 1116, the user decides whether to proceed with the recommended goal or to choose an alternate goal.

At operation 1118, the system receives and processes the goal selection and displays a plan assessment based on the user selected goal. The plan assessment may include a series of questions which will assist the system in determining which plan should be suggested to the user. It is understood that in some embodiments, the operation 1118 is skipped and instead, a recommended plan is simply presented to the user. If a plan assessment is presented to the user, at operation 1120, the user inputs answers to the plan assessment, via an input device, and submits the answers to the system. Thereafter, the system may utilize the responses provided by the user to update one or more of the c-score(s) and progress score at operation 1122.

Based on the results of the plan assessment and the updated scores, if any, the system displays a recommended plan to the user at operation 1124. At operation 1126, the user views the recommended plan and the alternate plan options, if any exist. Thereafter, at operation 1128, the user selects a plan.

At operation 1130, the user may begin the selected plan. However, in some embodiments, the user may be presented with a recommended program and alternate programs and select a program within the selected plan. Alternatively, if only one program exists within a plan, the user may automatically begin the program at the operation 1132. In yet further embodiments, the user may be presented with a program assessment prior to receiving a program recommendation, if at all. The program assessment may be similar to the plan assessment and allow the system to better understand which program is suited for the particular user. Eventually, the user will begin a program at the operation 1132 and interact and engage with daily activities associated with the program at operation 1134.

During the program, the system may display personalized messages based on daily user inputs during the program at operation 1136. At the operation 1136, the system may also present explanations, daily activities, educational and motivational material, instructional videos, and the like to the user.

After the program period, at operation 1138, the system may update one or more of the c-score(s) and progress score. These scores may be modified to reflect the user's participation, daily motivation, diligence, success, results, and the like.

At the operation 1140, the point collecting engine 312 may award points to the user based on his/her performance. The total points awarded may be presented to the user. At operation 1142, the system displays updated recommendations based on the updated scores and/or previous performance. The system may recommend that the user modify his/her goal, plan, and/or program. Alternatively, the system may recommend that the user redo the program or change to a different plan or program within the selected goal or plan. At operation 1144, the user views the displayed information and decides how to proceed. Regardless of the system recommendations, the user is enables to pave his/her own course by selecting goals, plans, programs, and the like, that are not recommended by the system.

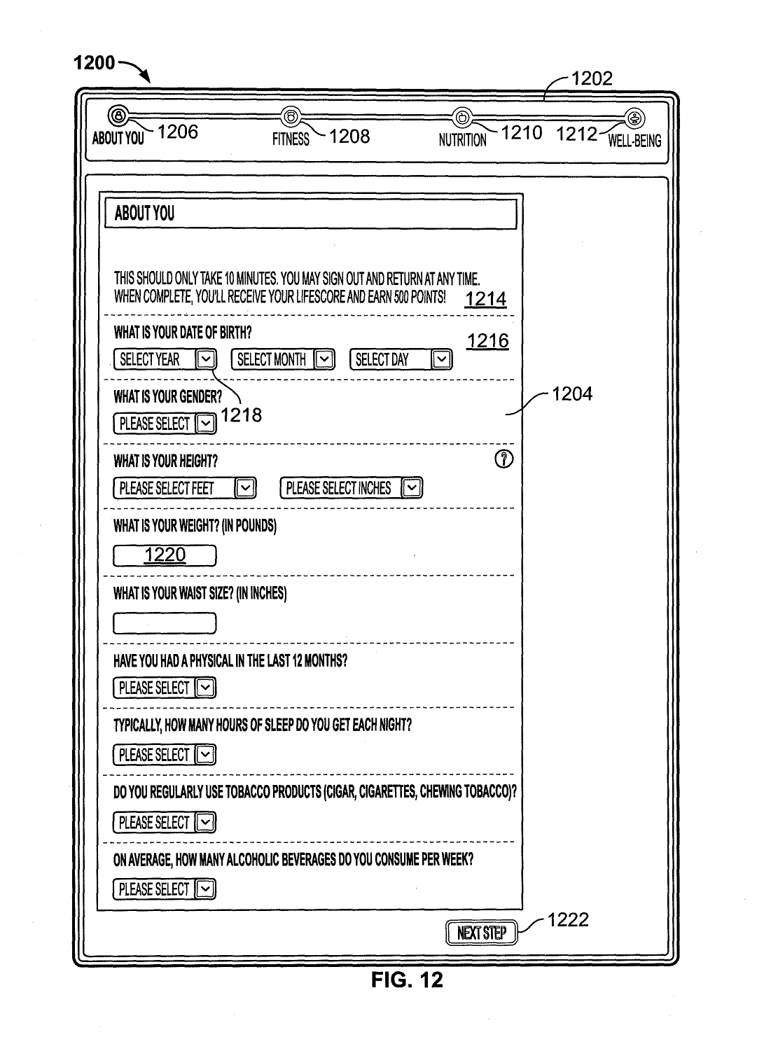

Now referring to FIG. 12, a screenshot 1200 illustrating one example of an initial assessment is shown. The screenshot 1200 includes a heading bar 1202 and a questionnaire 1204. The heading bar 1202 includes status points 1206, 1208, 1210, and 1212. The questionnaire 1204 includes an introductory explanation 1214, several questions, such as question 1216, a pull-down menu 1218, a text box 1220, and a continuation button 1222.

In general, the screenshot 1200 depicts one example of an initial assessment presented to the user via the question prompting engine 502, discussed above with reference to FIG. 5. In the example, the initial assessment is intended to determine basic information such as the background of the user, the fitness of the user, the nutritional lifestyle of the user, and the general well-being of the user. The information gathered during the initial assessment is collected by the user response collection engine 504 and stored in the database 114. Thereafter, the information may be utilized to calculate various scores by the score calculation engine 600, as discussed above with reference to FIG. 6.

The screenshot 1200 is one example of a presentation of an initial assessment questionnaire to a user. The screenshot 1200 includes the heading bar 1202 which has the status points 1206-1212. The status points 1206-1212 indicate which portion of the assessment the user is currently viewing. The status points to the right of the current status point indicate the portion that remains in the assessment. For example, in the screenshot 1200, the user is being presented with the “About You” portion of the assessment, as indicated by the status point 1206. As shown, status point 1206 includes an icon within the circle that the other status points 1208-1212 do not include. In the example, after the user has completed the “About You” portion of the assessment, the user will continue to the “Fitness”, “Nutrition”, and “Well-Being” portions of the assessment.

The questionnaire 1204 includes several questions that are presented to the user and the introductory explanation 1214 instructing the user about the questionnaire 1204 and providing the user with other information related to the questionnaire 1204.

In some embodiments, the user is presented with several questions having different answer methods. For example, the question 1216 includes the pull-down menu 1218 with various answer choices. Thus, to answer the question, the user must click on the pull-down menu 1218 and select an answer choice in the pull-down menu 1218. Alternatively, the questionnaire 1204 may include questions having answer text boxes, such as the text box 1220. In such a scenario, the user may input an answer by utilizing an input device, such as a keyboard. In alternate embodiments, questions may be multiple choice questions and/or may have radio button answers. It is understood that various different kinds of question-answer types may be utilized by the system.

Upon filling out the questionnaire 1204, the user may click on the continuation button 1222 to proceed to the next page in the questionnaire 1204. In some embodiments, the questionnaire 1204 may include a back button, which allows the user to review previously submitted answers in the questionnaire 1204. In yet further embodiments, the questionnaire 1204 may include a final submit button, which allows the user to submit all responses from previous pages and/or a current page to the system for storing, gathering, and processing. Thereafter, the responses may be utilized for various score calculations and/or system recommendations.

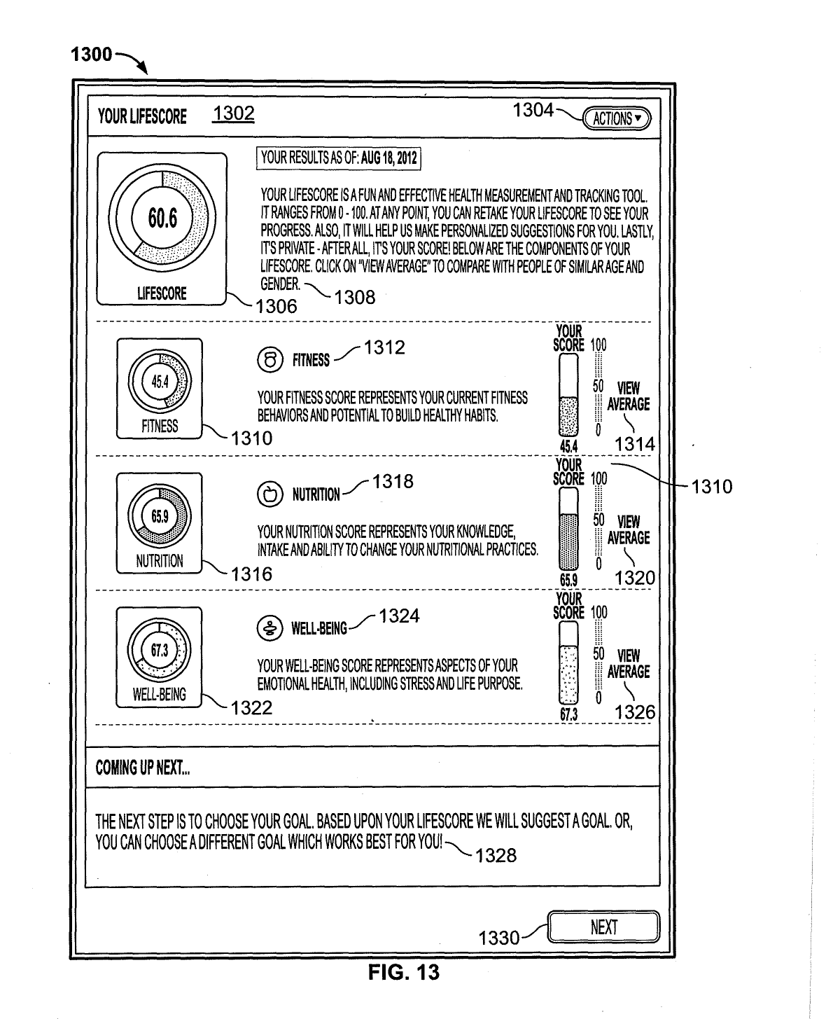

Now referring to FIG. 13, a screenshot 1300 illustrating one example a life score evaluation is illustrated. The screenshot 1300 includes a heading bar 1302, a score icon 1306, a score explanation 1308, a score breakdown 1310, a next step explanation 1318, and a continuation button 1320. The heading bar 1302 includes an actions button 1304. The score breakdown 1310 includes a fitness sub-score 1312, a nutrition sub-score 1314, and a well-being sub-score 1316.

In general, the screenshot 1300 is one example of a screen that is displayed to a user after completing an initial assessment, such as that shown in the screenshot 1200. The screenshot 1300 presents a user with a life score calculation based on the responses provided by the user in the initial assessment. In some embodiments, the life score is based on an accumulation of several sub-scores. In some embodiments, the sub-scores include scores for fitness, nutrition, and well-being. In other embodiments, various other sub-scores may be used to calculate the overall life score. In general, the life score is provided as a rough health measurement of the user and acts as a starting point from which the user may track later progress or regress.

As discussed above with reference to FIGS. 4 and 6, the life score is calculated by the score calculation engine 404, and more specifically, the life score determination engine 602. The life score determination engine 602 correlates user responses to count totals stored in the database 114 and aggregates the count totals to determine one or more scores related to the life score. For example, in some embodiments, the life score determination engine 602 may determine sub-scores in a similar fashion for one or more categories, such as, for example, fitness, nutrition, and well-being.

The heading bar 1302 indicates to the user that a calculated life score is currently being displayed. The heading bar 1302 also includes the actions button 1304 which allows the user to engage in various actions, such as, signing out, viewing the user profile, reviewing/altering settings, viewing points, and various other activities associated with the site.

The score icon 1306 indicates, by visual representation, the user's calculated life score. In some embodiments, however, the calculated life score may merely be presented as a number without a corresponding visual representation. The score explanation 1308 explains information about the life score to the user. For example, the score explanation 1308 indicates the life core is a health management score that acts as a tracking tool. The score explanation 1308 further indicates to the user that the life score may be retaken to view progress and/or digress, and that the life score is private. In some embodiments, more or less information may be presented to the user in the score explanation 1308.

The score breakdown 1310 includes the various components, or sub-scores, determined from the initial assessment, which combine to calculate the overall life score. In the example, the sub-scores are associated with fitness, nutrition, and well-being. In alternate embodiments, the sub-scores may include fewer or more categories, such as, stress level, weight management, happiness, and the like. In some embodiments, the categories are all related to the health management of the individual.

Each sub-score 1312, 1314, and 1316 include graphic representations of the sub-scores, a sub-score explanation, and a comparative tool to compare the user's individual sub-score with average sub-scores by the overall community of users. In some embodiments, users are able to compare their calculated sub-scores with the average sub-score achieved by members in the community with similar age, gender, interests, and the like.

The next step explanation 1318 enables the user to understand the next step after the viewing the calculated life score. Finally, the user may click the continuation button 1320 to proceed to the next step. In alternative embodiments, the next step explanation 1318 is not included or a lesser or greater explanation the following steps is provided.

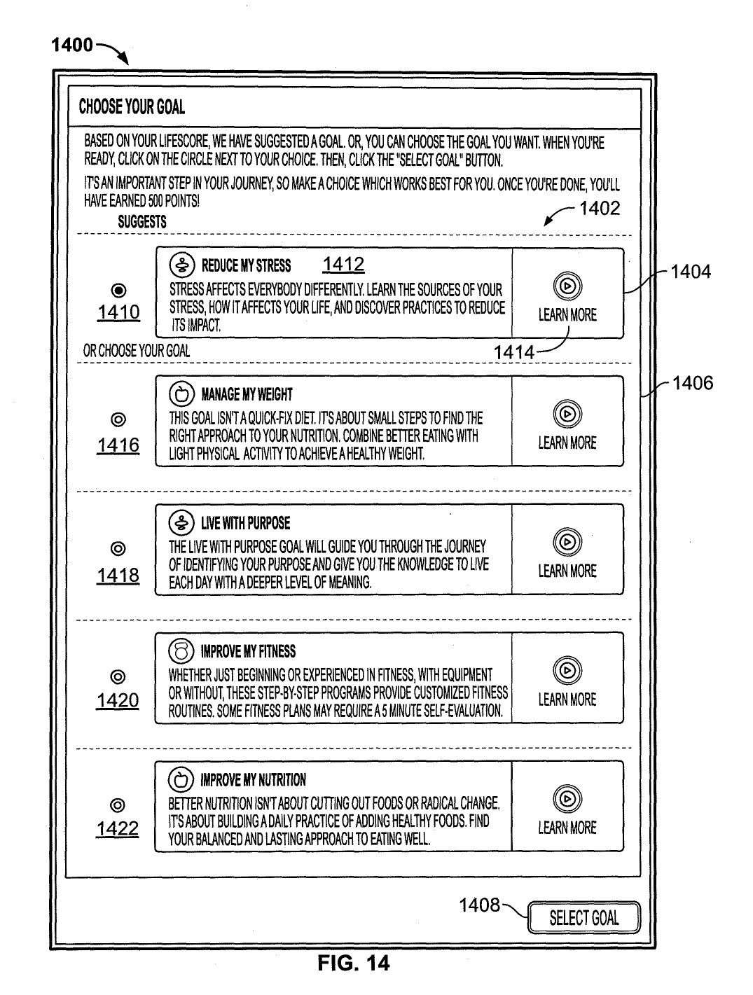

Now referring to FIG. 14, an example screenshot 1400 which depicts a goal recommendation and selection page is shown. The screenshot 1400 includes a heading bar 1402, a goal recommendation 1404, alternate goals 1406, and a continuation button 1408. The goal recommendation 1404 includes a radio button 1410, a goal explanation 1412, and a learn more button 1414. The alternate goals 1406 include a “Manage My Weight” goal 1416, a “Live with Purpose” goal 1418, an “Improve My Fitness” goal 1420, and an “Improve My Nutrition” goal 1422.

In general, the screenshot 1400 presents the user with a recommended goal. The recommended goal is determined by the goal creation engine 406, discussed above, based on the answers provided by the user in the initial assessment and any other information previously stored in the database 114 relating to the user.

In the example embodiment, the heading bar 1402 includes a narrative explaining to the user that the system has recommended a goal. The narrative further explains that the user is free to select any of the presented goals, even if it is not the goal recommended by the system. In this way, the system strives to enable the user to engage is a personal health journey which, instead of including mandatory programs, allows the user to mold the experience to his or her interests and desires, thereby increasing user motivation.

In the example embodiment, the goal recommendation 1404 is “Reduce My Stress.” The goal explanation 1412 explains to the user the focus of the “Reduce My Stress” goal. In other embodiments, the goal explanation 1412 includes less or more information relating to the recommended goal, including, the various plans within the goal, the objectives of the goal, and any other relevant information related to the goal.

The recommended goal includes the learn more button 1414 which allows the user to learn more information about the recommended goal. For example, if the user clicks on the learn more button 1414, the user may be presented with an instructional video describing the recommended goal in greater detail. In other embodiments, the user may be directed to another screen which includes a listing of plans and/or programs associated with the goal so that the user has an understanding of what activities he/she would engage in if he/she selects the recommended goal. As shown in the screenshot 1400, all goals, even the alternate goals 1406 includes a learn more button so that the user has access to information about all goals provided by the system. In the example embodiment, if the user decides to select the recommended goal 1404, the user clicks on the radio button 1410 and then selects the continuation button 1408 to select the goal. In alternative embodiments, various other methods of selection may exist, such as, a check box, a text box for user input, a highlighting option, or any other method of goal selection which enables the user to select a goal.

In the example embodiment, the alternate goals 1406 include the “Manage My Weight” goal 1416, the “Live with Purpose” goal 1418, the “Improve My Fitness” goal 1420, and the “Improve My Nutrition” goal 1422. In alternate embodiments, any one of the alternate goals 1406 may be the goal recommendation 1404, based on the particular user and information collected by the system about the user. Each of the alternate goals 1406 includes goal explanations, learn more buttons, and radio buttons for goal selection.

In this way, the system enables the user to access information about each goal prior to making a selection. Thus, the system attempts to recommend a goal suitable for the individual user, but ultimately, allows the user to understand each goal and select a goal that the user most values. As such, the user feels more motivated to engage in the selected goal because instead of being a mandatory goal selected by the system, the goal is selected by the user based on the individual user's selection criteria.

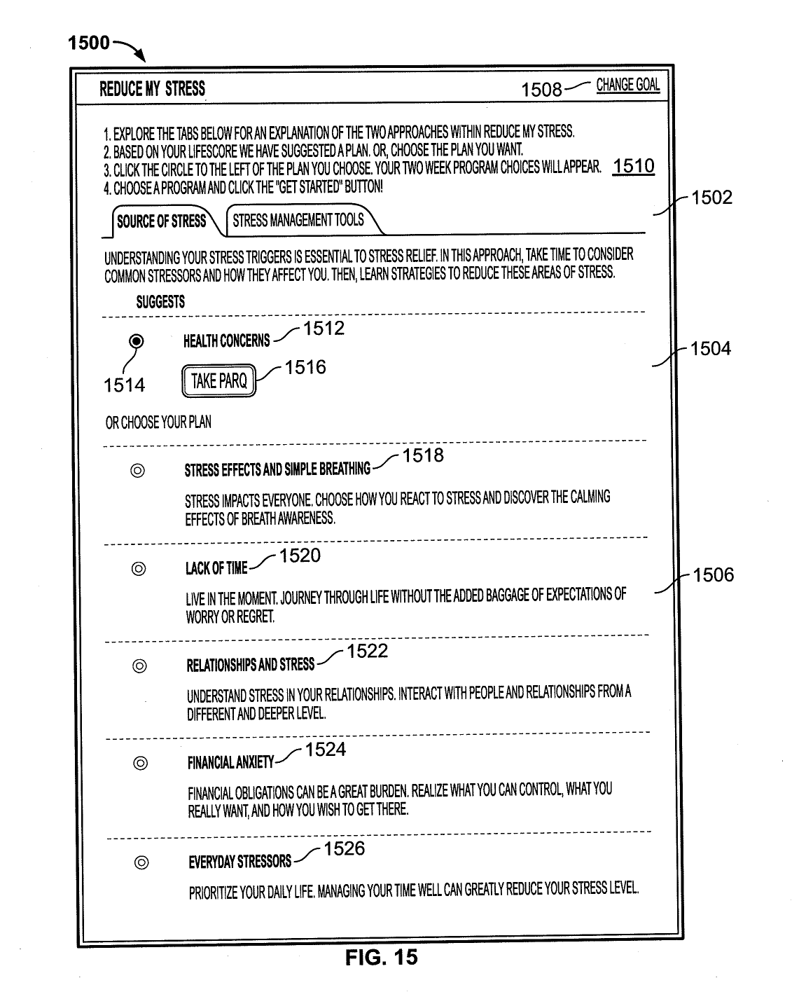

Now referring to FIG. 15, a screenshot 1500 is shown, which depicts an example plan recommendation and selection screen for the “Reduce My Stress” goal. The screenshot 1500 includes a heading 1502, a plan recommendation 1504, and alternate plans 1506. The heading 1502 includes a change goal button 1508 and an introductory explanation 1510. The plan recommendation 1504 includes a plan title 1512, a radio button 1514, and a ParQ button 1516. The alternate plans 1506 include other plans 1518, 1520, 1522, 1524, and 1526.

In general, the screenshot 1500 depicts a screen that is presented to a user after selection of a goal in, for example, the screenshot 1400. After selecting either a recommended or alternate goal, the user is presented with recommended and alternate plans associated with the selected goal, if plans within the goal exist. In the example embodiment, after selecting the “Reduce My Stress” goal, the user is presented with a recommended plan entitled, “Health Concerns,” and five alternate plans associated with the “Reduce My Stress” goal.

As stated above, the recommended plans are generated by the plan creation engine 704, as discussed above with reference to FIG. 7. The plan creation engine 704 utilizes the user selected goal, one or more scores, and information stored in the database 114 to determine a plan that is well-suited for the user.

The heading 1502 includes the change goal button 1508 and the introductory explanation 1510. The introductory explanation 1510 may include instructions so that the user understands what the page is displaying, a description of the selected goal and the plans associated with the selected goal, or any other information relating to the goal and/or plans. The change goal button 1508 allows the user to select a different goal in the event that the user is unhappy with the available plans associated with the selected goal. In this way, the system continues to promote user selection and motivation, by allowing the user to experience a journey molded by the particular user.

The plan recommendation 1504 includes the plan title 1512, which in the example is, “Health Concerns.” The plan recommendation 1504 further includes a radio button 1514 by which the user may select the recommended plan, “Health Concerns.” As stated above, in some embodiments, the radio button 1510 may be any other type of button that allows the user to select the plan.

The plan recommendation 1504 further includes a ParQ button 1516. In some embodiments, a ParQ button exists so that the user is presented with a ParQ Assessment. In some embodiments, a ParQ Assessment is a series of questions presented to the user to determine whether the user is capable of engaging in a certain level of physical activity. In this way, the system can determine whether or not the user is capable of engaging in the plan because the plan includes activities that require a certain level of physical activity. In some embodiments, if a user selects a plan that requires a ParQ Assessment which indicates that the user does not possess the capability to perform the degree of physical activity needed for the plan, the system may recommend an alternate plan to the user and/or allow the user to select from the group of alternate plans 1506.

The alternate plans 1506 include the remaining plans associated with the “Reduce My Stress” goal. In the example embodiment, the alternate plans 1506 include the “Stress Effects and Simple Breathing” plan 1518, the “Lack of Time” plan 1520, the “Relationships and Stress” plan 1522, the “Financial Activity” plan 1524, and the “Everyday Stressors” plan 1526. In other embodiments, fewer or more plans relating to reducing stress may be available. Each alternate plan 1506 includes a radio button with the user may utilize to select the plan and a brief explanation of the plan under the plan's title, as shown. It is understood that the placement of descriptions, titles, and buttons may differ in varying embodiments.

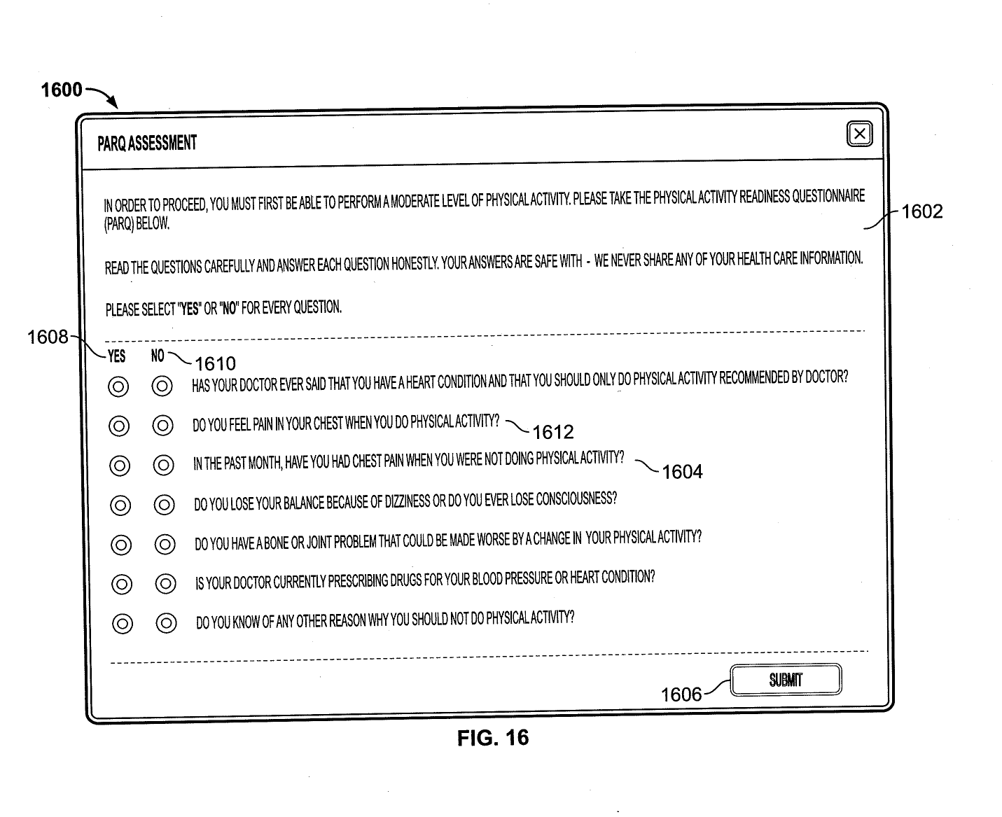

Referring now to FIG. 16, a screenshot 1600 depicting one example of a ParQ Assessment is shown. The screenshot 1600 includes an explanation header 1602, assessment questions 1604, and a continuation button 1606. The assessment questions 1604 include “Yes” and “No” radio buttons 1608 and 1610 and individual questions, such as question 1612.

In general, the screenshot 1600 is one example of a ParQ Assessment that is presented to a user upon clicking the ParQ button 1516 in FIG. 15. In some embodiments, the ParQ Assessment depicted in screenshot 1600 enables the system to assess any limitations a user may have with respect to physical activity. For example, if a particular plan selected by the user requires the user to engage in a certain level of physical activity, a user may be required, in some embodiments, to take a ParQ Assessment in order to continue with the plan. In other embodiments, in addition or as an alternative to the ParQ Assessment, the system may require a physician or other health care professional's approval for a user to participate in a given goal, plan, program, challenge, or the like.

In some embodiments, the ParQ Assessment is stored in the database 114 and is accessed by one or more of the goal selecting engine 702, the plan creation engine 704, and the program creation engine 706 to determine a physical activity level of the user. Various types of ParQ Assessments may be stored in the database 114 for later use by the various engines. For example, different ParQ Assessments related to strength, flexibility, medical issues, agility, and the like, may exist in the database 114. Based on the type of goal, plan, or program at issue, the engines select the appropriate ParQ Assessment and present it to the user.

In some embodiments, the explanation header 1602 explains what a ParQ Assessment is to a user. Furthermore, the explanation header 1602 may include instructions on how to complete the ParQ Assessment.

The assessment questions 1604 include questions such as the question 1612. The questions may be directed to various aspects of physical and/or emotional health. For example, the questions 1604 may determine whether the user experiences pain when engaging in physical activity. Furthermore, the questions 1604 may determine whether the user is actively taking any medications which may affect the user's ability to engage in physical activity. It is understood that different embodiments may include different questions than those shown on the screenshot 1600.

The assessment questions 1604 are answered by the user selecting one of either the “Yes” or “No” radio buttons 1608, 1610. In other embodiments, the questions 1604 may be answered in several other ways, such as through an input text box, multiple choice answer selection, checkbox, or the like. Also, it is understood, that various different types of ParQ Assessments may exist, and the questions 1604 may vary based on the goal, plan, or program related to the ParQ Assessment.

Upon completing the ParQ Assessment, the user may submit the answers by selecting the continuation button 1606. In some embodiments, after submitting the answers, the user will be informed whether the user has demonstrated though the answers that he/she is capable of performing the physical activity needed to complete the goal, plan, or program associated with the ParQ Assessment.

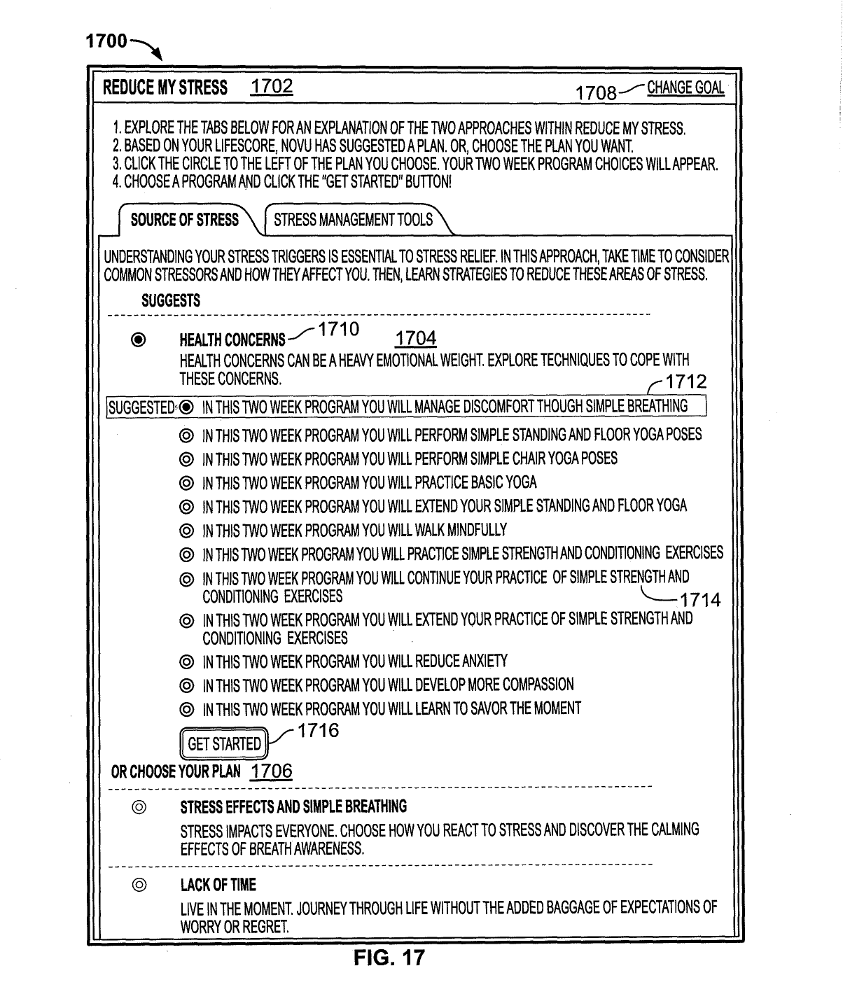

Referring now to FIG. 17, a screenshot 1700 of one example of program recommendations for a selected plan is shown. The screenshot 1700 includes a heading 1702, program recommendation 1704, and alternate plans 1706.

The heading 1702 includes a goal changing button 1708. The program recommendation 1704 includes a selected plan title 1710, a suggested program description 1712, alternate programs 1714, and a continuation button 1716.

In general, the screenshot 1700 is one example of a screenshot which is presented to a user after selecting either a recommended or alternate plan. Thereafter, as shown in FIG. 17, the user is presented with a program recommendation 1704, alternate programs 1714, and an option to switch to alternate plans 1706 if the user is unhappy with the selection of programs associated with the selected plan.

As stated above, the recommended plans are generated by the program creation engine 706, as discussed above with reference to FIG. 7. The program creation engine 706 utilizes the user selected goal and plan, one or more scores, and information stored in the database 114 to determine a program that is well-suited for the user.

In the example embodiment of FIG. 17, the selected plan is “Health Concerns” within the selected goal of “Reduce My Stress.” The heading 1702 includes a goal changing button 1708 with allows the user to switch goals in the event that the user is unhappy with the selections of plans and/or programs within the selected goal. In some embodiments, the heading 1702 also includes instructions and/or a description of the recommended programs and how the user should proceed. For example, in screenshot 1700, the heading 1702 teaches the user how to select a program and begin the selected program.

The program recommendation 1704 includes the selected plan title 1710, which in this example is “Health Concerns.” In the example embodiment, the suggested program description 1712 is highlighted and indicated with the word, “Suggested.” The display may be presented to a user in alternate forms in various embodiments. In the example, alternate programs 1714 associated with the selected plan title 1710 are displayed to the user below the suggest program description 1712. In some embodiments, such as the screenshot 1700, the alternate programs 1714 include brief explanations of what each program entails. In alternate embodiments, the alternate programs 1714 include titles without descriptions or detailed descriptions that include far greater detail than the brief explanation showed in the current example.

The user has an option to proceed with the suggest program description 1712 or choose one of the alternate programs 1714. Once the user has selected a program to proceed with, the user may select the continuation button 1716 to proceed.

Alternatively, the user may review the suggested and alternate programs 1712, 1714 and determine that no particular program addresses the user's individual goals, interests, needs, or the like. In this event, the user may change the selected plan by choosing a plan from the alternate plans 1706, or as discussed above, change the selected goal by pressing the goal changing button 1708. In alternate embodiments, one or more secondary continuation buttons may exist in the event that the user selects a plan from the alternate plans 1706.

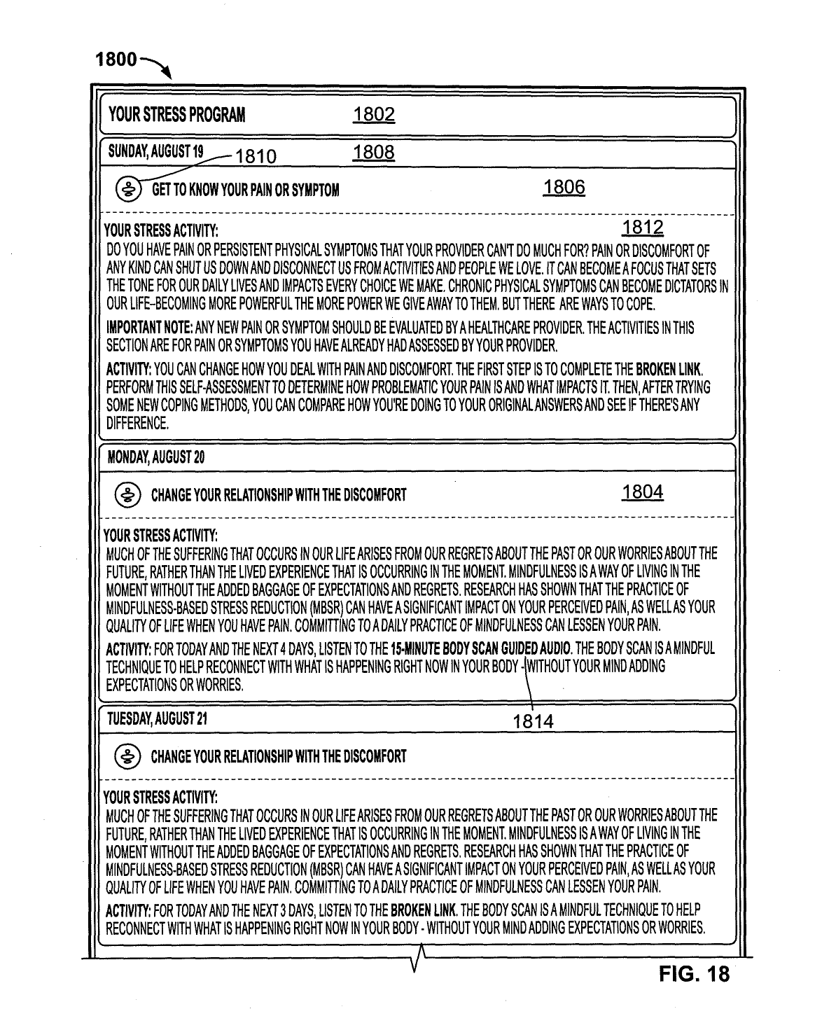

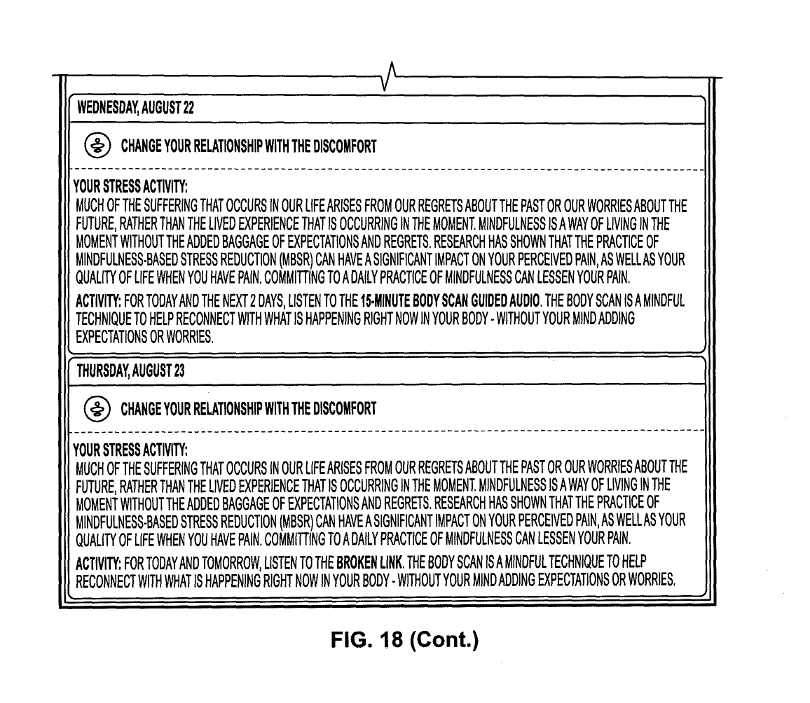

Now referring to FIG. 18, screenshot 1800, one example of a screenshot which is may be displayed to a user after selecting a program within a selected plan, is shown. More specifically, the screenshot 1800 is one example of a screenshot that is presented to the user after the user selects the suggested program description 1712 and presses the continuation button 1716 in FIG. 17. In some embodiments, the screenshot 1800 is not automatically shown to a user; instead, the user must specifically navigate to the screen from the user profile or home page.

The screenshot 1800 includes a heading 1802 and a program schedule 1804. The program schedule includes daily activities, such as a daily activity 1806, a date header 1808, an explanation link 1810, and an activity description 1812. The activity description 1812 may include links to audio and/or visual resources, such as link 1814.

In general, the screenshot 1800 includes a day-to-day program schedule 1804 which explains each activity a user must complete during a predetermined time period to complete the full program. As explained above, a program may vary in length, from between one week to three weeks, with some programs being more or less than this amount of time. The screenshot 1800 shows five days of a program schedule 1804. In some embodiments, the program schedule 1804 includes more daily activities than those shown in the example. The further daily activities may be viewed by a user by scrolling down on the screenshot 1800 or clicking a continuation button which displays a further page to the user.

The heading 1802 includes a title which describes what the user is viewing. For example, in the screenshot 1800, the heading 1802 includes the words, “Your Stress Program,” which indicates to the user that he/she is viewing a program of activities associated with the user selected program.

The program schedule 1804 includes daily activities, such as the daily activity 1806. The daily activity 1806 includes the date header 1808 so that the user understands which day the daily activity 1806 should be completed. In some embodiments, the daily activity includes a link 1810 which describes the desired result of the daily activity 1806. The link 1810 may also include an explanation of why the daily activity 1806 is included in the program schedule 1804 and/or the importance of the daily activity 1806 in the larger scheme of the selected program.

In some embodiments, the daily activity 1806 also includes the activity description 1812. The activity description 1812 may include a description of the daily activity 1806, how to accomplish the activity 1806, important notes relating to the daily activity 1806, educational information relating to the importance of completing the daily activity 1806, motivational information, or the like.

The activity description 1812 may also include audio or visual links, such as the link 1814, which includes further audio and/or visual descriptions of how to complete the daily activity 1806. In some embodiments, the activity description 1812 may include links to videos showing models of completing the activity, education and/or motivational information relating to the activity, or links to third party resources related to the daily activity 1806. In general, the activity description 1812 and any links included in the activity description 1812 are directed at explanations of how to accomplish the daily activity 1806.

In some embodiments, the program schedule 1804 is stored in the database 114 with an associated program. After a program has been selected by the user, the program creation engine 706 accesses the program schedule associated with the selected program from the database 114 and presents the program schedule to the user.

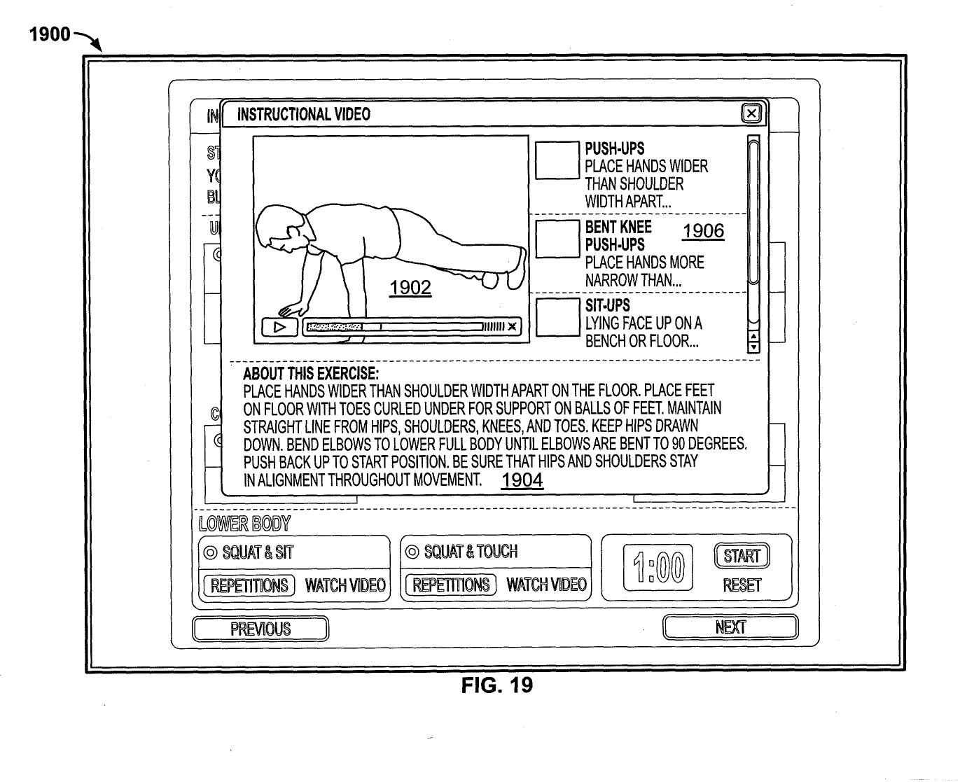

Now referring to FIG. 19, a screenshot 1900, which is one example of a screenshot which is presented to the user after clicking an audio and/or visual link, such as the link 1814 in FIG. 18, is shown. The screenshot 1900 includes a video 1902, a description 1904, and alternate links 1906. The video 1902, the description 1904, and the alternate links 1906 are examples of external resources and audio/visual information that is stored in the database 114 and accessed by one or more of the engines discussed above, such as, for example, the goal creation engine 406.

In general, the screenshot 1900 is one example of what is presented to the user if a link, such as the link 1814 is selected by the user. In the example, a video 1902 is presented to the user. In some embodiments, the video 1902 includes one or more examples of how to complete a daily activity in a program schedule, such as the program schedule 1804 shown in FIG. 18.

In the example, the screenshot 1900 also includes the description 1904. In some embodiments, the description 1904 includes an explanation of what is shown in the video 1902 or further examples and instructions relating to the video 1902 and/or the daily activity associated with the video 1902. Furthermore, the screenshot 1900 includes the alternate links 1906 for other videos associated with the program schedule and/or daily activity. It is understood that the video 1902 and the alternate links 1906 are examples of videos that may be presented to a user, and various different videos, audio instructions, pictures, and the like, may be presented to the user as an aid in better understanding a daily activity.

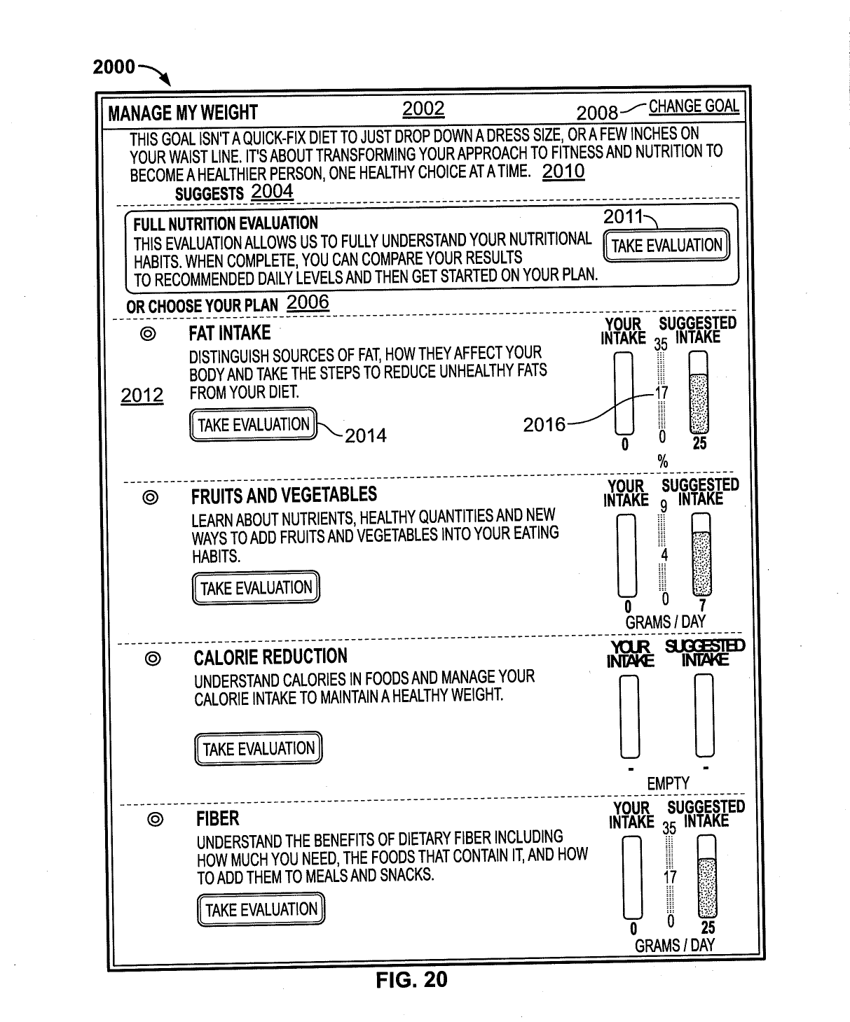

Referring now to FIG. 20, a screenshot 2000 is shown, which depicts an example plan recommendation and selection screen for the “Manage My Weight” goal. The screenshot 2000 includes a heading 2002, a plan recommendation 2004, and alternate plans 2006. The heading 2002 includes a change goal button 2008 and an introductory explanation 2010. The plan recommendation 2004 includes a nutritional evaluation button 2011. The alternate plans 2006 include alternate plans, such as a plan 2012, a secondary evaluation button 2014, and intake comparison graphs 2016.

In general, the screenshot 2000 is one example of a screenshot that may be presented to a user after selecting the “Manage My Weight” goal. The screenshot 2000 is similar to the screenshot 1500 shown in FIG. 15. However, because the screenshot 2000 is related to a different goal, some differences exist between the screenshot 1500 and the screenshot 2000. For example, in the screenshot 2000, the plan recommendation 2004 includes a nutritional evaluation. Instead of suggesting a plan, in the example, the system recommends that the user take a full nutritional evaluation to better determine which nutritional plan suits the user. In alternate embodiments, however, if the system has already stored nutritional information about the user from previous evaluations and/or questionnaires, the system may omit the nutritional evaluation, and instead, suggest a plan.

Alternatively, the user may select one of the alternate plans 2006, such as, for example, the alternate plan 2012 entitled, “Fat Intake.” The alternate plans 2006 each include the secondary evaluation button 2014. The secondary evaluation button 2014 may redirect the user to a screen in which the user is presented with the full nutritional evaluation. Alternatively, the secondary evaluation button 2014 may redirect the user to an evaluation which has questions related only to the related plan. For example, if the user clicks on the secondary evaluation button 2014, the user may be presented with a questionnaire including questions related to fat intake.

The alternate plans 2006 represent one embodiment of the plans associated with the “Manage My Weight” goal. However, it is understood that other plans may exist under the “Manage My Weight” goal such as, for example, Calcium, Fiber, Carbohydrates, Protein, and various others.

The alternate plans 2006 each also include the intake comparison graphs 2016. The graphs illustrate to the user the user's individual intake with a suggested intake. For example, the intake comparison graph 2016 is related to the individual and suggests intakes related to fat. However, other intake comparison graphs under other plans may be related to the respective plans. The information used to create the intake comparison graphs may include answers from the full nutritional evaluation, the individual plan evaluations, initial or subsequent assessments, results from previously completed goals, plans, or programs, and/or the like.

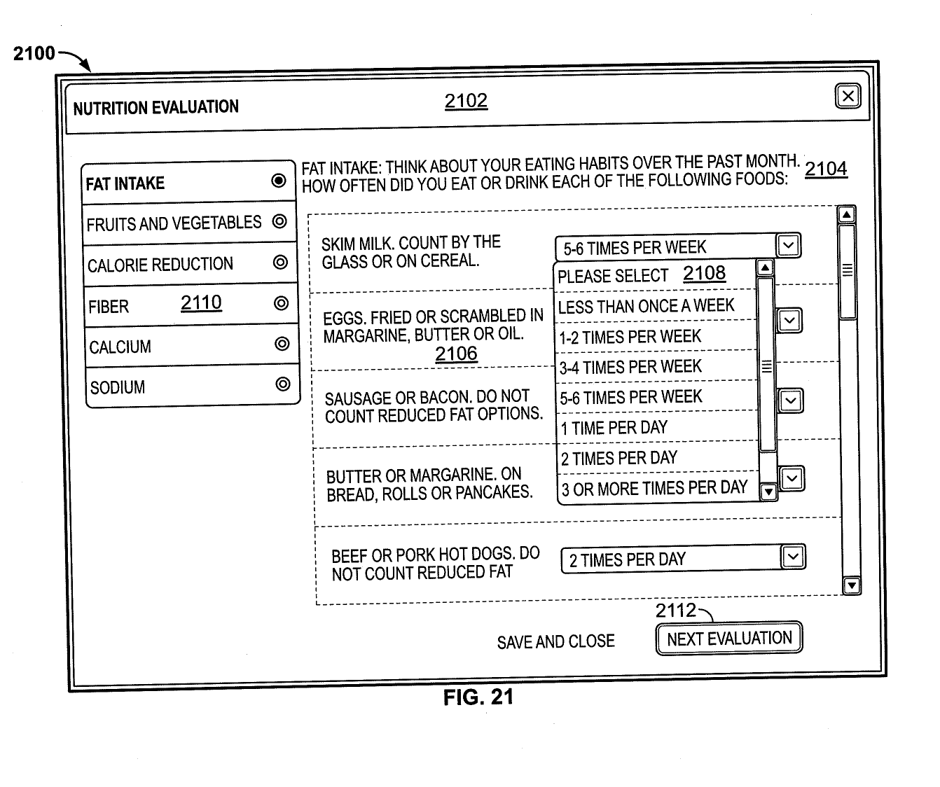

Referring now to FIG. 21, a screenshot 2100 depicting an example nutritional evaluation, such as one that may be presented to the user upon selecting the nutritional evaluation button 2011 (FIG. 20) is shown. The screenshot 2100 includes a heading 2102, an explanation 2104, questions 2106, a pull-down menu 2108, a tracker 2110, and a continuation button 2112.

In general, the screenshot 2100 illustrates one example of a nutritional evaluation which is presented to a user after selecting the plan recommendation 2004 or by simply requesting to complete a nutritional evaluation. The nutritional evaluation is one example of an evaluation that is stored in the database 114 for accessing by one or more of the engines discussed above, such as, for example, the plan creation engine 704.

The screenshot 2100 includes the heading 2102 which informs the user that a “Nutrition Evaluation” is being presented. The explanation 2104 includes one or more descriptions about the evaluation. In some embodiments, the explanation 2104 may include descriptions about the specific portion of the evaluation or about the various portions of the evaluation and/or the entire evaluation. In other embodiments, the explanation 2104 includes alternatively or additionally instructions on how to complete the evaluation.

The screenshot 2100 also includes the questions 2106. The questions are answered by utilizing various pull-down menus such as the pull-down menu 2108. The user may select an answer by clicking an answer choice on the pull-down menu 2108. In alternate embodiments, the answers may be presented to the user in alternative formats. In yet further embodiments, the user may input a response through a text box without selecting from a group of predetermined answer choices. Alternatively, the user may input the answer through an input device such as a microphone without physically typing the response.

In some embodiments, the evaluation includes the tracker 2110 which indicates to the user which portion of the nutritional evaluation is currently being displayed. For example, in the screenshot 2100, the questions 2106 are directed at “Fat Intake.” This is understood because the circle next to the plan title, “Fat Intake” on the tracker 2110 is darker than the other circles next to the other plan titles. In other embodiments, more or less sections may exist in the evaluation. For example, in some embodiments, the evaluation may include questions relating to other plans not listed on the screenshot 2100, such as, Calcium, Fiber, Carbohydrates, Protein, and various others.

Upon completing the questions 2106, the user may click on the continuation button 2112 to continue to the next section of the evaluation and/or to complete the evaluation and view the results. Thereafter, in some embodiments, the system may utilize the results of the evaluation to recommend a plan within the “Manage My Weight” goal, such as a specific nutritional area (e.g., Sodium, Calcium, Fiber, etc.).

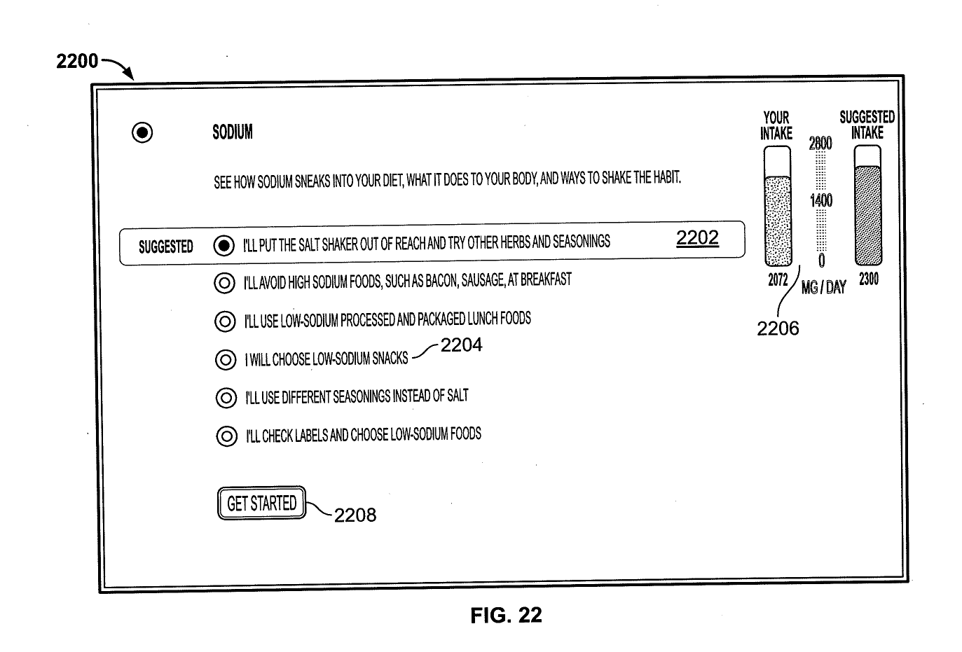

Now referring to FIG. 22, an example screenshot 2200 of suggested and alternate programs related to a “Sodium” plan within the “Manage My Weight” goal is shown. The screenshot 2200 includes a suggested program 2202, alternate programs 2204, “Sodium” intake comparison graphs 2206, and a continuation button 2208.

The screenshot 2200 is similar to the screenshot 1700, and includes the suggest program 2202 and the alternate programs 2204. However, in some embodiments, the screenshot 2200 differs from the screenshot 1700 because the screenshot 2200 includes the “Sodium” intake comparison graphs 2206. As stated above, the intake comparison graphs 2206 may be based on one or more sources of information about the user's nutritional intake, such as, answers from the full nutritional evaluation, the individual plan evaluations, initial or subsequent assessments, results from previously completed goals, plans, or programs, and/or the like.

In some embodiments, the user can select the suggested program 2202 or any one of the alternate programs 2204. Once the user selects a program, the user may click on the continuation button 2208 to begin the selected program. As stated above, all programs may vary in length, for example, from one week to three weeks, with some programs even exceeding three weeks. In some embodiments, however, programs are two weeks in length so as to provide stability and continuation in a certain health management area, while still being short enough as to maintain the user's interest.

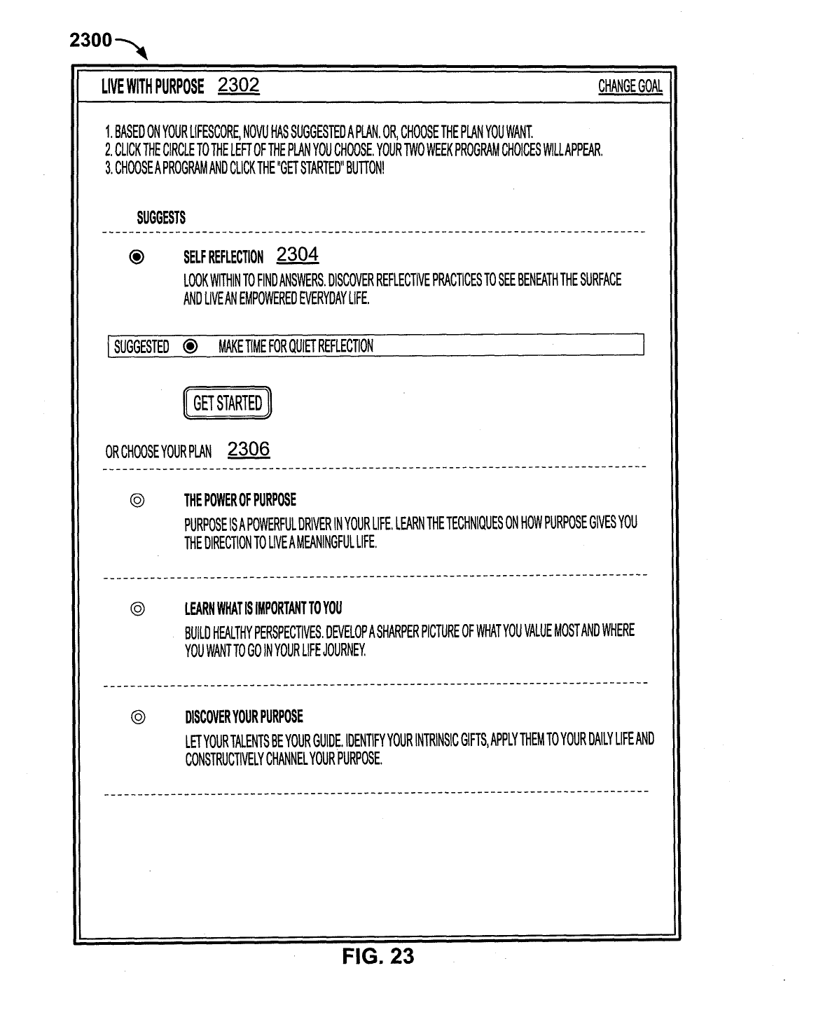

Referring now to FIG. 23, an example screenshot 2300, which is one example of a display presenting suggested and alternate plans relating to the “Live with Purpose” goal is shown. The screenshot 2300 is similar to the screenshots 1500, 2000. The screenshot 2300 includes a heading 2302, a recommended plan 2304, and alternate plans 2306.

The heading 2302 includes a change goal button and an introductory explanation similar to the screenshot 1500. However, the introductory explanation in the heading 2302 is related to the goal, “Live with Purpose.”

In the example, the recommended plan 2304 and the alternate plans 2306 are presented similarly as in the screenshot 1500. It is understood that the plans 2304, 2306 may be presented in various other formats. Furthermore, the explanation accompanying the plans 2304, 2306 may include more or less detail about the purpose and focus of the plans 2304, 2306.

In some embodiments, a plan may be associated with only one program. In such embodiments, at the time the system suggests a plan, the system may simultaneously suggest the one program within the plan. As shown, the one associated program is highlighted within the “Self Reflection” suggested plan because it may be the only program within the plan.

In the embodiment, the alternate plans 2306 displayed are only examples of plans that exist within the “Live with Purpose” goal. It is understood that several other plans may exist relating to, for example, career explorations, relationship strengthening, hobby discovering, and others.

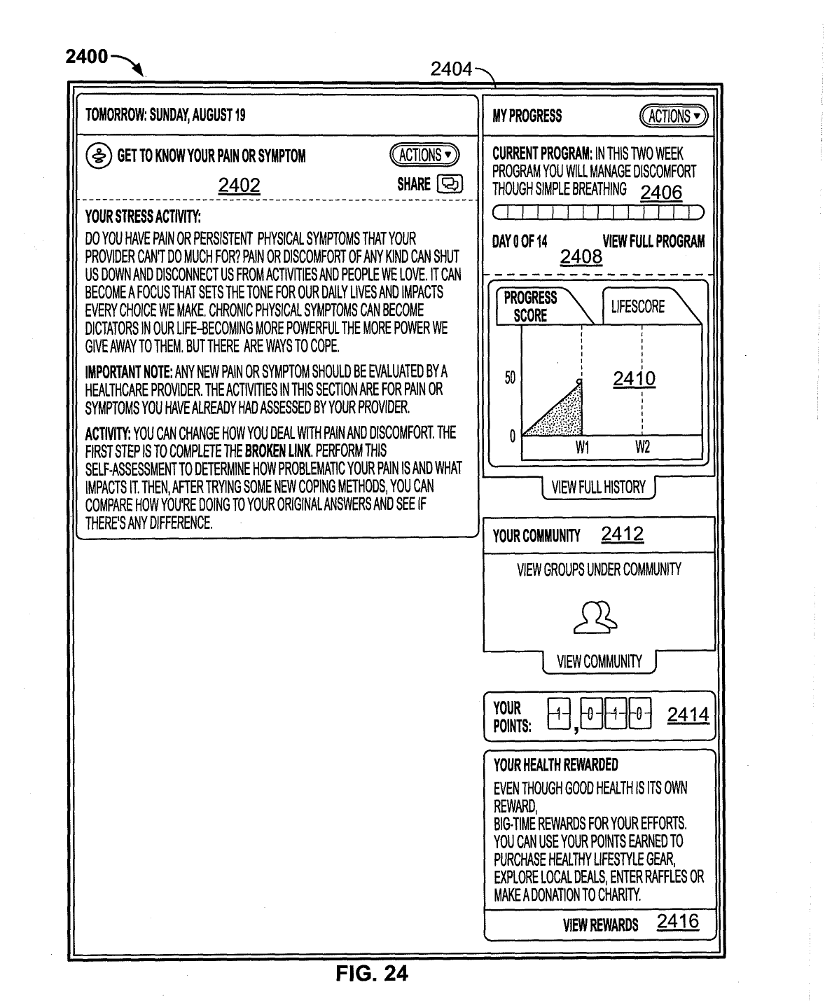

Now referring to FIG. 24, an example screenshot 2400, which is one example of a health management home page, is shown. The screenshot 2400 includes at least one daily activity 2402 and a side bar 2404. The side bar 2404 includes a progress description 2406, a program schedule link 2408, a progress graph 2410, a community link 2412, a point total 2414, and a rewards link 2416. The health management home page is one example of a screen that is displayed to the user with the help of both the goal creation engine 406 and the social connection engine 304.

In general, the screenshot 2400 is one example of a screen which is displayed to the user after selecting a program and, in some instances, viewing a full program schedule, such as that illustrated in FIG. 18.

The at least one daily activity 2402 is at least one daily activity from the program schedule (e.g., the program schedule illustrated in FIG. 18). In the example, the program has not yet begun, therefore the only daily activity shown is tomorrow's daily activity. However, in other embodiments, if the program has begun, the at least one daily activity 2402 can include today's daily activity and/or tomorrow's daily activity. In yet further embodiments, the at least one daily activity 2402 can include the entire week's daily activities and/or coaching messages.

In some embodiments, coaching messages are messages that are similar to those that would be provided by a personal trainer, but instead, are provided by the system automatically. In some instances, the coaching messages are personalized based on information stored about the user in the database 114 and may provide encouragement. In yet further embodiments, the system may email, text, or call users (via robotic calls) to reach out to users of the system. Such communications may be intended to motivate users to continue with selected goals/plans/programs, activities, events, challenges, or the like. In yet further embodiments, the coaching messages may be sent via a health care professional to the user via messages, email, text, voicemail, or even phone calls. In such scenarios, a health care professional may review a user's history and current status, score, and any other information stored in the database 114, and provide customized feedback and motivational messages to a user.

The side bar 2404 generally includes information and links that are relevant to the user. For example, the side bar 2404 includes the progress description 2406 which provides information regarding to the user's current program. In some embodiments, the progress description 2406 includes the title of the current program, the amount of progress accomplished in the current program, the amount of days completed in the current program, the amount of days remaining in the current program, and the like. In some examples, such as in the progress description 2406, the amount of days completed and/or remaining may be displayed to the user via a graphical bar.

The side bar 2404 also includes the program schedule link 2408. The program schedule link 2408 allows the user to view the entire program schedule instead of just a piecemeal view, such as that shown in the at least one daily activity 2402. The program schedule link 2408 may redirect the user to a screenshot similar to the screenshot 1800.

The side bar 2404 further includes the progress graph 2410. The progress graph 2410 includes statistics related to the user. For example, the progress graph 2410 may include a graphical representation of the user's updated scores, such as the progress score and the life score. Alternatively, the progress graph 2410 may further include a written description explaining the progress graph 2410 and any score fluctuations in one or more scores. In some embodiments, the progress graph 2410 may include a link to a full history of the one or more score updates so that a user may monitor all changes to the one or more scores.

The side bar 2404 further includes the community link 2412. The community link 2412 enables the user to view the community by clicking on the link. In some embodiments, the community link 2412 may include sub-links showing community connections, groups, challenges, and the like. In yet further embodiments, the community link 2412 may additionally or alternatively include sub-links showing suggestions for community connections, groups, challenges, and the like, that the system determines based on one or more scores, answers from evaluations stored in the database 114, and any other information stored in the database 114 about the user. In yet further embodiments, a live community activity feed may also be presented to the user upon clicking the community link 2412.

The side bar also includes the point total 2414 and the rewards link 2416. The point total 2414 indicates to the user the current point balance. The rewards link 2416 includes a link that, when clicked by the user, redirects the user to a rewards page (discussed in greater detail below). In general, the rewards page allows the user to redeem points for various rewards, such as, for example, products, charitable donations, deals, and the like. In some embodiments, the rewards link 2416 also redirects the user to a screen in which all previous point redemptions may be viewed.

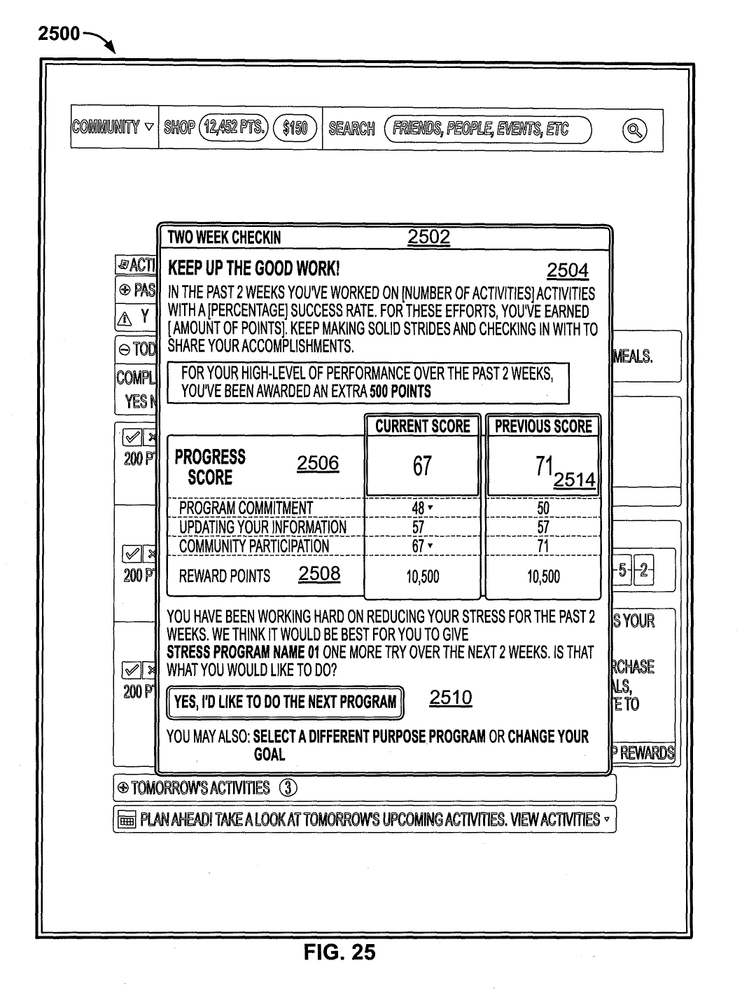

Referring now to FIG. 25, a screenshot 2500, which is one example of a check-in screen, is shown. The screenshot 2500 includes a heading 2502, an explanation 2504, a progress score indicator 2506, a points indicator 2508, and a continuation recommendation 2510. The progress score indicator 2506 includes a current progress score indicator 2512 and a previous progress score indicator 2514.

In general, the screenshot 2500 is one example of a check-in screen that may be presented to a user at least once in a certain predetermined time period. For example, in some embodiments, a check-in screen is displayed to a user once every two weeks. In other embodiments, a check-in screen is displayed to a user at the time a user is scheduled to complete a program.

The screenshot 2500 generally indicates the user's overall progress. In some embodiments, the screenshot 2500 includes the heading 2502 which indicates what the user is viewing. For example, in the current situation, the user is viewing a “Two Week Checkin.” The explanation 2504 describes information related to the user. For example, in some embodiments, the explanation 2504 includes the number of activities worked on by the user in a certain time period, a percentage success rate, and the amount of points earned during the time period and/or overall.

The progress score indicator 2506 includes information relating to the calculation of the progress score and a visual indication of any upward or downward fluctuation in the score progress score since the last check-in. For example, the progress score may be displayed via several sub-scores, such as sub-scores related to program commitment, community participation, and information updates. As illustrated in the progress score indicator 2506, the current progress score indicator 2512 and the previous progress score indicator 2514 may show the scores and/or sub-scores side-by-side so that the user is able to more clearly view any fluctuations. Furthermore, the sub-scores allow the user to see which areas may need improvement and/or which areas are advancing the progress of the progress score.

The points indicator 2508 indicates to the user the current rewards points and the previous amount of rewards points. In some embodiments, this indicator may act as a motivator by showing the user his/her advancement in the system.

The screenshot 2500 also includes a continuation recommendation 2510. Based on the results from the previous two weeks, the system provides a recommendation on how to continue. For example, if the user was successful in the program, the system may recommend another program. Alternatively, the system may recommend changing plans and/or goals. In yet further embodiments, if the user has not yet completed the current program, the system may recommend completing the current program. The continuation recommendation 2510 is calculated similarly to previous recommendations discussed herein and may be based on information about the user stored in the database 114 such as responses to questionnaire/evaluations, information voluntarily provided by the user, one or more scores such as the progress score, and any other information related to the user's motivation, interests, needs, and the like.

The continuation recommendation 2510 also includes a continuation button which allows the user to proceed with the recommendation. Alternatively, the continuation recommendation 2510 may include links that, when clicked by the user, allow the user to change the current goal, plan, and/or program.

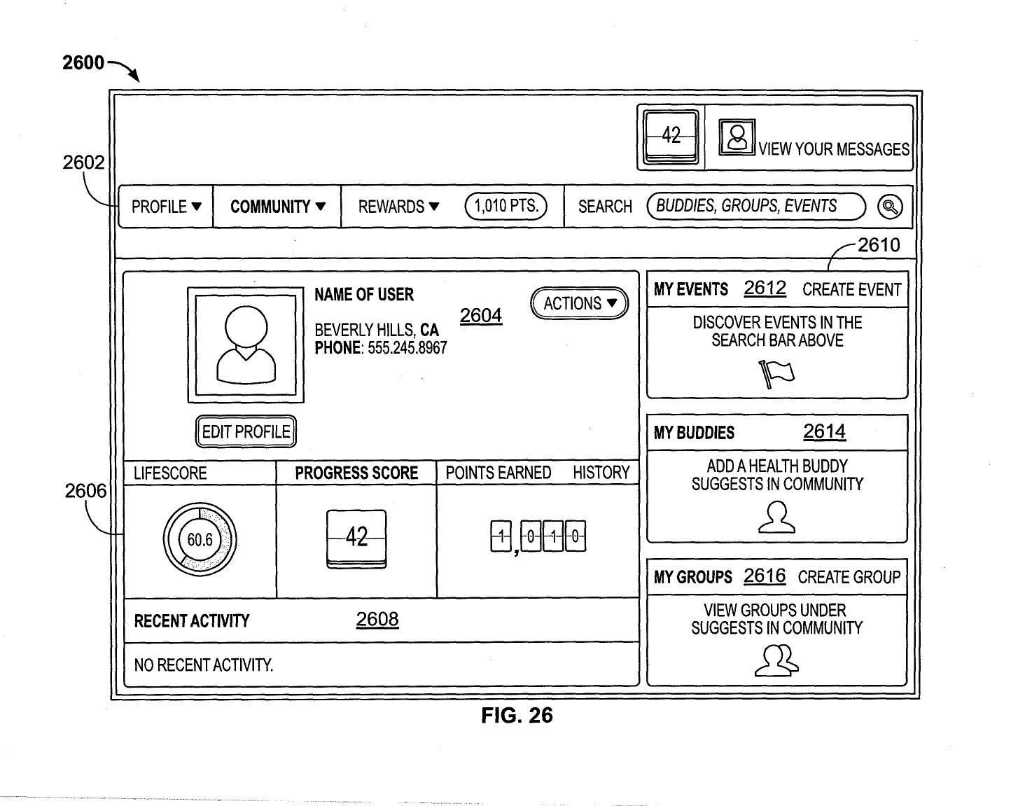

Now referring to FIG. 26, a screenshot 2600, which is one example of a user profile, is shown. The screenshot 2600 includes a heading 2602, a user description 2604, a progress bar 2606, recent activity 2608, and a side bar 2610. The side bar 2610 includes community information such as user events 2612, user connections 2614, and user groups 2616.

In general, the screenshot 2600 is an example user profile and includes information specific to the user, including progress information, personal information, activity information, and community information. The screenshot 2600 also includes links to various different pages that may be of interest to the user.

In some embodiments, the heading 2602 includes one or more links that may be of interest to the user. For example, the heading 2602 may include links to various aspects of the user profile, such as updating, maintaining, or viewing more specific details relating to the user profile. The heading 2602 may also include links to various aspects of the user's community, such as links to friend's pages, upcoming events, an activity stream including community information, challenge browsing, or the like. Further, in some embodiments, the heading 2602 may include a link to a rewards page where the user may redeem points earned for rewards. The heading 2602 may also include a search bar which allows the user to search for specific social connections, groups, events, challenge, activities, and the like. In yet further embodiments, the heading 2602 may additionally or alternatively include a graphical representation of the user's current progress score and a link to view any messages received from the user's community.

The screenshot 2600 also includes the user description 2604. The user description 2604 may include personal information voluntarily inputted by the user. The user description 2604 may also include any voluntarily added photographs uploaded to the system by the user. The personal information and photographs may be included into the user profile via a “Edit Profile” link that is provided in some embodiments of the user description 2604. The user description 2604 may also include an “Actions” link which allows the user to engage in various actions, including editing the user profile, viewing the activity stream, viewing other community information, viewing the health management home page (e.g., the screenshot 2400) and/or information relating to the user's current program schedule, and the like.

The screenshot 2600 also includes the progress bar 2602. The progress bar 2606 may include information viewable to the user relating to general progress. For example, in some embodiments, the progress bar 2606 includes the current life score, progress score, and points earned. The progress bar 2606 may also include one or more links to the view the history or the life score, progress score, and/or points earned/redeemed.

The screenshot 2600 also includes the recent activity 2608. The recent activity 2608 may include any recent activity accomplished by the user. For example, the recent activity 2608 may include any recent challenge completed, groups joined, connections made, events attended, or the like. Also, the recent activity 2608 may include information related to any goals, plans, programs, and daily activities recently begun or completed by the user.

The side bar 2610 includes community information such as the user events 2612, the user connections 2614, and the user groups 2616. The side bar 2610 may further include one or more links to more information about the user's events, connections, and/or groups. Furthermore, the side bar 2610 may include links so that the user may create events, groups, challenges, or the like. In some embodiments, the side bar 2610 may also include links to search for social connections to add to the user's community.

In general, the screenshot 2600 depicts a user profile as viewed by the user. However, selected information from the screenshot 2600 may be selected to be publicly presented. Thus, in some embodiments, if a second user clicked a link to view the user's profile, a similar screenshot as that shown in the screenshot 2600 may be viewed, however, only information that the user chooses to be publicly displayed will be shown.

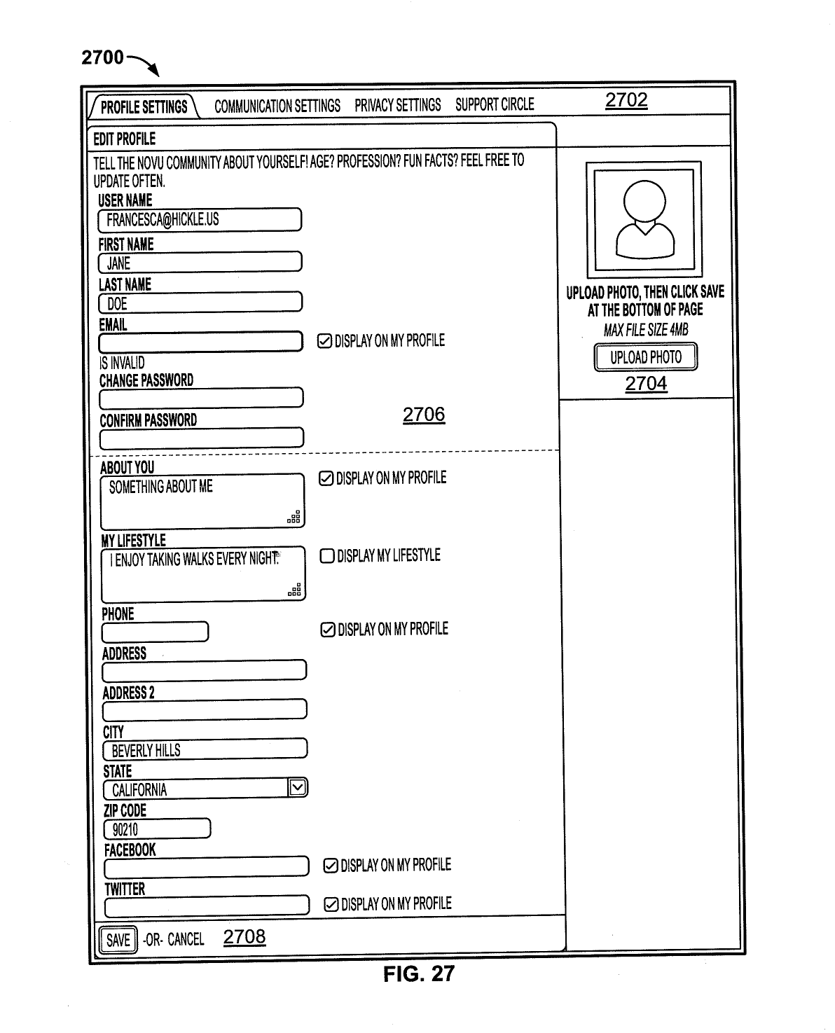

Now referring to FIG. 27, a screenshot 2700, which is one example of screen that is displayed upon clicking the “Edit Profile” link shown in the screenshot 2600, is shown. The screenshot 2700 includes a heading 2702, an upload photo link 2704, queries 2706, and one or more continuation buttons 2708.

In general, the screenshot 2700 is one example of a screen that allows a user to edit his/her profile. The screenshot 2700 includes a heading 2702 which includes various setting pages. By clicking on the various links on the heading 2702, the user is enabled to modify various settings, such as profile settings, communication settings, privacy settings, and support circle settings/information.

The screenshot 2700 also includes the upload photo link 2704 and the queries 2706 which allow the user to voluntarily input personal information. In some embodiments, the user is may indicate whether certain information is publicly display on the user profile. The user may input information via text boxes, as shown in the screenshot 2700. However, in alternate embodiments, various different question-answer types, such as those described herein, may be utilized.

Upon inputting information and/or uploading a photograph, the user may utilize the one or more continuation buttons 2708 to either save the inputted information or cancel. In some embodiments, by selecting “cancel”, the user will lose all information recently inputted as answers to the queries 2706.

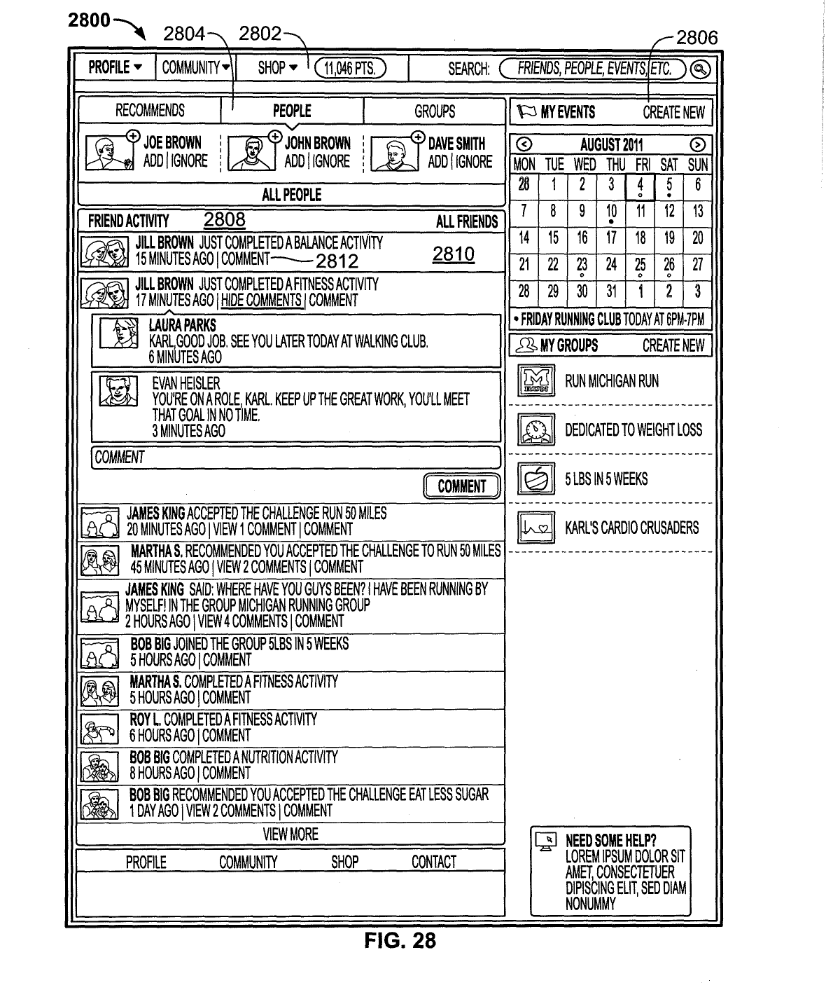

Now referring to FIG. 28, an example screenshot 2800, which is one embodiment of an activity stream page. The screenshot 2800 includes a heading 2802, recommendations 2804, user information 2806, and friend information 2808. The friend information 2808 includes posts 2810 and one or more post links 2812. The activity stream page is one example of a screen that is displayed by the activity-stream management engine 806, discussed above with reference to FIG. 8.

In general, the screenshot 2800 illustrates an example embodiment of an activity stream page. The activity stream page includes updated information about a user's social connections, groups, events, and challenges. Furthermore, the activity stream page also includes information about scheduled events and groups that the user is associated with. Finally, the activity stream page also includes system recommendations which indicate friends, group, events, challenges, or the like that the system determines that the user may be interested in connecting with or joining.

The heading 2802 is the same or similar to the heading 2602 and provides the same or similar functionality to the user. In general, the heading 2802 allows the user to navigate from the activity stream page to other screens that may be of interest to the user.

The recommendations 2804 includes suggested social connections and groups that the system determines the user may be interested to connect with or join. The system determines the recommendations based on information stored in the database 114, goals, information that may be stored based on previous searches by the user, and/or people, groups, challenges, or events that are similar to those previously connected with or joined by the user.

The activity stream page also includes the user information 2806. The user information includes events and/or groups that the user is affiliated with. Furthermore, as shown in the screenshot 2800, the user information 2806 may include a calendar visually indicating future events that the user has scheduled to attend. In some embodiments, the user information 2806 includes links to view the event and/or group details. Further, the user information 2806 may include one or more links to create an event, group, or challenge. In other embodiments, the user information 2806 may additionally or alternatively include a link to a user mailbox to view any new messages received from a group, event, challenge, administrator, and/or social connection.

The screenshot 2800 also includes the friend information 2808. The friend information 2808 includes the posts 2810. The posts 2810 are a compilation of different information about the user's social connections. In general, the posts 2810 are a way for a user to share information with his/her social connections.

For example, the latest information about a friend's program completion, challenges, scheduled events, and/or group membership may appear as a post on the friend information 2808. Further, public messages from friends may also appear as a post on the friend information 2808. Each post may include a “Comment” link which allows the user to comment on the post. In some embodiments, each post may also include a “Hide Comments” link which hides comments made by other users on the post. In other embodiments, the posts may also include links to groups, challenge, events, and/or other social connections.

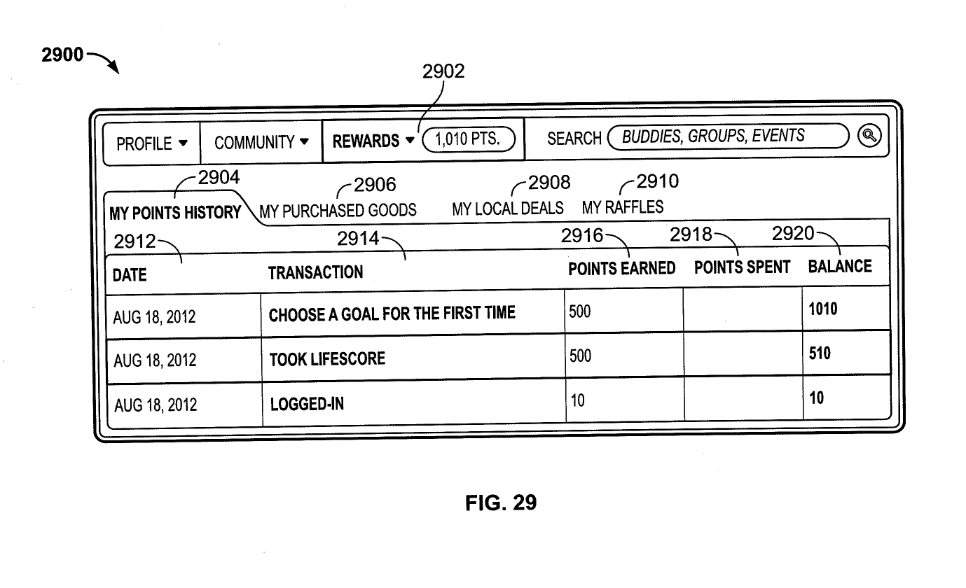

Referring now to FIG. 29, an example screenshot 2900, which is one embodiment of a rewards page. The screenshot 2900 includes a heading 2902, a history tab 2904, a purchased good tab 2906, a deals tab 2908, and a raffles tab 2910. The history tab 2904 includes a date row 2912, a transaction row 2914, a points earned row 2916, a points spent row 2918, and a balance row 2920.

In general, the rewards page depicted in the screenshot 2900 is one embodiment of what is displayed to a user to track the earning and redeeming of his/her points.

The heading 2902 is the same or similar to the headings 2602, 2802 and provides the same or similar functionality to the user. In general, the heading 2902 allows the user to navigate from the rewards page to other screens that may be of interest to the user.

The history tab 2904 shows the user all transactions involving points. For example, the date row 2912 indicates the date in which points were either earned or redeemed. The transaction row 2914 indicates the type of transaction that transpired. The points earned row 2916 indicates the amount of points that were earned by the user, if any. The points spent row 2918 indicates the amount of points that were spent by the user, if any. Finally, the balance row 2920 indicates the remaining balance of user points that existed after the transaction was complete.

The screenshot 2900 also includes the purchased good tab 2906, the deals tab 2908, and the raffles tab 2910. The purchased good tab 2906 includes a display of all of the good purchased by the user by redeeming points. The deals tab 2908 includes a display of all deals purchased by the user by redeeming points. As state above, and discussed in more detail below, deals include discounted offers, such as, for example, coupons, purchased by the user by redeeming points. The raffles tab 2910 includes a display of all raffles that the user is involved in, including point sweeps and task sweeps, as discussed above. In some embodiments, the raffles tab 2910 also includes previous sweeps that the user was involved in and/or any sweeps that the user won.

The purchased good tab 2906 and any information presented on the associated page is developed and presented by the merchandise engine 1002 in conjunction with the database 114. The purchased good tab 2906 may include order history and access to order status and tracking information. The deals tab 2908 and any information presented on the associated page is developed and presented by the deals engine 1006 in conjunction with the database 114. The raffles tab 2910 and any information presented on the associated page is developed and presented by the sweepstakes engine 1008 in conjunction with the database 114.

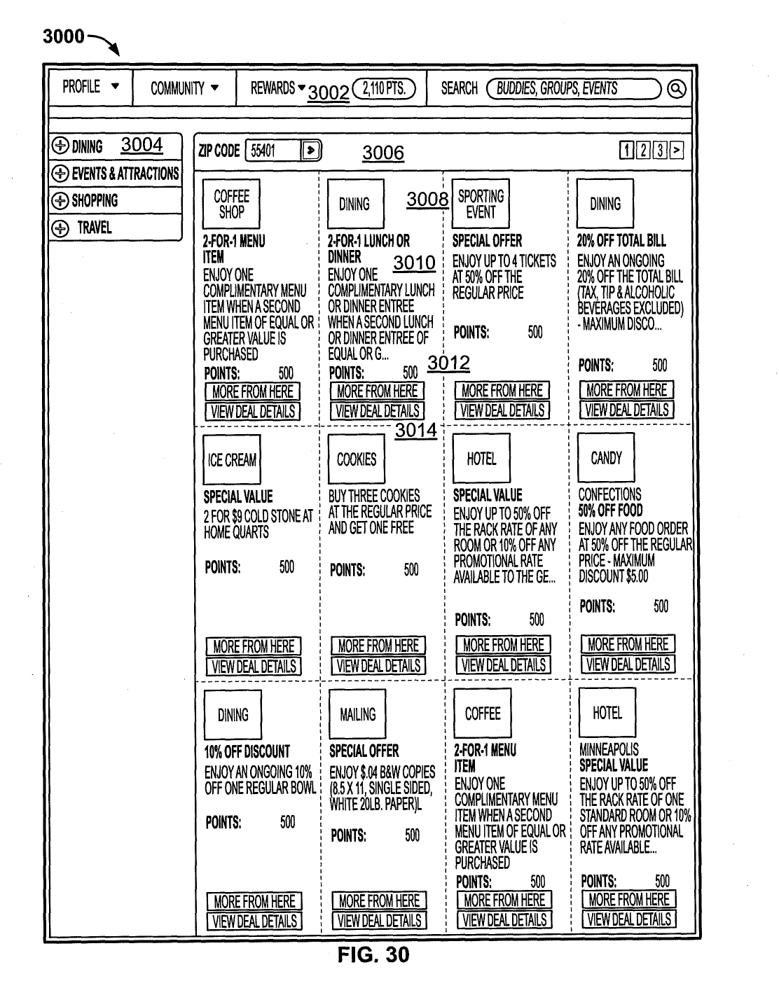

Now referring to FIG. 30, a screenshot 3000, which is one embodiment of a page by which users may view deals, is shown. The screenshot 3000 includes a heading 3002, a side bar 3004, a zip code input 3006, and one or more deals, such as deal 3008. The deal 3008 includes an explanation 3010, a point value 3012, and a similar deals link 3014. The deals page is one example of a screen that is developed and presented by the deals engine 1006.

In general, the screenshot 3000 allows a user to browse deals by region and buy one or more deals, if the user has collected enough points. The deals are similar to coupons and enable the user to spend points to collect special values on products or services provided by various third parties.

The screenshot 3000 includes the heading 3002. The heading 3002 is the same or similar to the headings 2602, 2802, 2902 and provides the same or similar functionality to the user. In general, the heading 3002 allows the user to navigate from the deal viewing page to other screens that may be of interest to the user.

The screenshot 3000 also includes the side bar 3004. The side bar 3004 enables the user to narrow the field of search by selecting a topic, such as, for example, “Dining”, “Events & Attractions”, “Shopping”, and “Travel.” In some embodiments, the user may select one or more topics so that he/she can view deals relating to more than one topic. Furthermore, in other embodiments, the user may also click on the icons next to the fields of search to further narrow the search within the main fields. For example, within “Travel”, the user may further narrow the search to a particular airline, location, travel agency, or the like.

The zip code input 3006, allows the user to narrow the field of search regionally. Thus, if the user lives in downtown Minneapolis, for example, the user may input the zip code “55401” to view deals within downtown Minneapolis or proximally located to the user. In other embodiments, the screenshot 3000 alternatively or additionally includes a state name input, a city name input, a telephone number input, or any other region identifying input. Alternatively, the local deals may simply utilize personal information stored in the database 114 indicating the user's location, and default to showing deals within a predetermined number of miles from the user's address.

The screenshot 3000 further includes one or more deals, such as the deal 3008. The deal 3008 includes the explanation 3010 of the deal which describes what the user would be purchasing with the points. The user may learn more information about the deal by clicking a “View Deal Details” if present, such as shown in the screenshot 3000. Furthermore, the deal includes the point value 3012 which indicates to the user the amount of points he/she would have to spend to get the specified deal. In some embodiments, the deal 3008 also includes the similar deals link 3014 which, when clicked by the user, presents the user with deals from the same third party and/or deals including the same type of product and/or service as the deal 3008. In this way, the user may narrow the field of search by viewing deals of interest to the user.

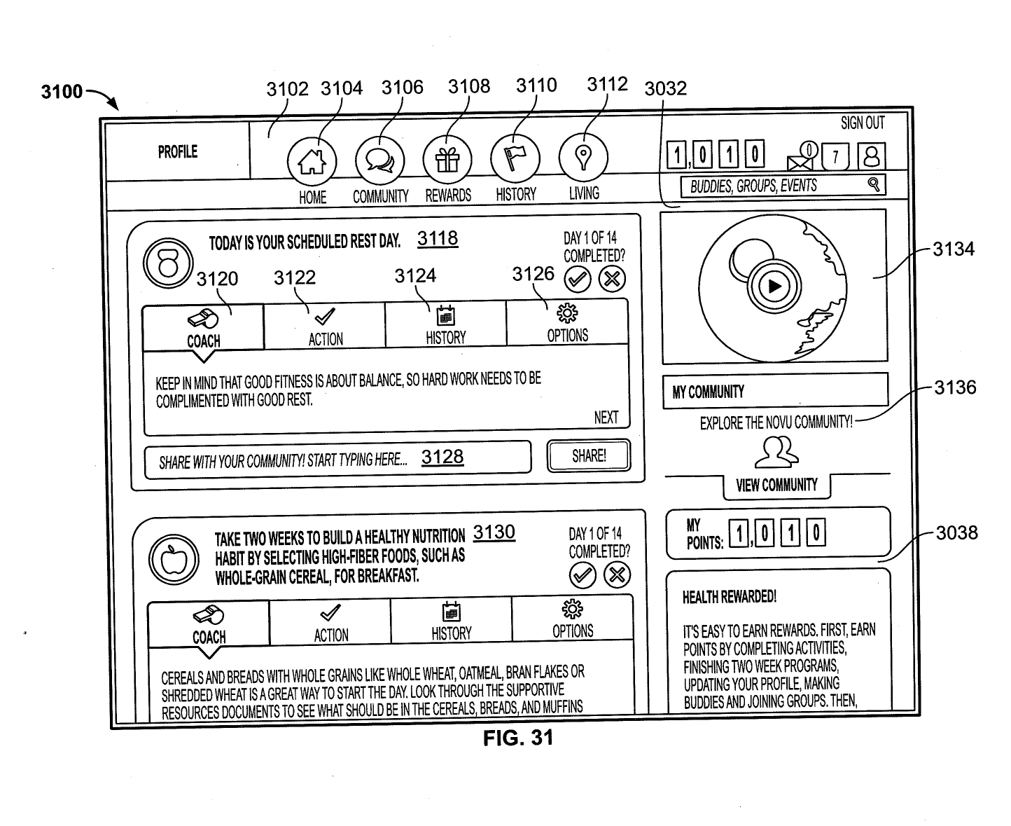

Referring now to FIG. 31, a screenshot 3100, which is an alternate embodiment of a user profile, is shown. The screenshot 3100 includes a header 3102, a sidebar 3032, a first program box 3118, and a second program box 3130. The header 3102 includes a home link 3104, a community link 3106, a rewards link 3108, a history link 3110, and a living link 3112. The sidebar 3032 includes an informational section 3134, a community section 3136, and a rewards section 3038. The first program box 3118 includes a coach section 3120, an action section 3122, a history section 3124, an options section 3126, and a community box 3128.

In general, the screenshot 3100 depicts an alternate example of a user profile. In particular, the screenshot 3100 illustrates a profile of a user that is concurrently participating in two programs. The program boxes 3118, 3130 present information to the user related to the respective programs. In addition, each program box 3118, 3130 includes several sections, such as the sections 3120, 3122, 3124, 3126 which enable a user to selectively choose which information to view about each program.

The first program box 3118 includes various informational sections which allow a user to explore a first program in depth. For example, in the present embodiment, the first program may be a strength program. In some embodiments, an icon indicative of the goal may be present in each program box. In yet further embodiments, the goal, plans, and/or program type is written within the program box 3118 in text. In this way, a user may differentiate between one or more concurrent programs.

The first program box 3118 includes the coach section 3120. The coach section 3120 may include, for example, inspirational, motivational, and/or informational messages to the user related to the program. Thus, the coach section 3120 includes messages related to the specific strength program, and may be related to a particular type of strength program enrolled in by the user. In some embodiments, the coach section 3120 is specifically tailored to the user's performance in past program activities. For example, the coach section 3120 may include messages encouraging the user to remain persistent with the program, if the system indicates that the user has failed to perform one or more required activities within the first program.

The first program box 3118 also includes the action section 3122. The action section 3122 includes information related to the daily action that is required by the user. For example, the action section 3122 may include a description of the action required by the program for the particular day. In addition, the action section 3122 may include general information about the program and why certain activities are healthy and/or beneficial to the user. In some embodiments, the action section 3122 may include tailored information related to the user's performance in prior activities. In yet further embodiments, the action section 3122 may describe an action and provide further information in the form of documents, videos, pictures, or links to the like which describe the action in greater detail.

The first program box 3118 also includes the history section 3124. The history section 3124 may include the user's activity history related to the specific program. For example, the history section 3124 may include information related to the user's previous activities, how regularly the user has engaged in activities for the specific program, user's persistence with the program, and other information related to the user's progress specific to the selected program. In addition, the history section 3124 may also include history related to the user's actions on the overall system not related to the specific program, such as, for example, the user's interaction with the community.

In some embodiments, the options section 3126 allows the user to view further information about the specific program, print the viewed information, end the program, switch to another program, and/or add a new program. For example, the user may select the options section 3126 to view his entire enrolled program, showing all daily activities for the entirety of the program. In some embodiments, this may be viewed as shown in FIG. 18. The user may also utilize the options section 3126 to change the specified program to another program, add a new program, or simply end the present program. Thus, in some embodiments, a user may actively engage in only one program, two programs, or more than three programs.

The number of programs that a user simultaneously engages in may be limited by the system administrators. For example, the system administrators may limit the number of programs that a user may engage in simultaneously. This number may be a general number for all users of the system. In other embodiments, this number may be specific to particular users based on several factors including age, health, prior history with the system, score values, etc.

The second program box 3130 is similar to the first program box 3118, but provides information related to a second program. The second program may be any other program that the user is enrolled in. In the example embodiment, the second program may be nutrition, as indicated by the icon depicting an apple enclosed in a circle. However, in other embodiments, the program type may be presented via alternate icons and/or text. The second program box 3130 includes the same sections as the first program box 3118, however, the sections in the second program box 3130 are each related to user-enrolled nutrition program. Though two programs are depicted in the present embodiment, it is understood that a user may enroll in more than two programs.

The sidebar 3032 includes the informational section 3134. The informational section 3134 is an applet provided to share user-tailored information to the user to promote healthy living. For example, the applet may be a communication applet, which enables the system to provide tailored messages to the user based on various factors, such as, for example, the user's age, health, performance in programs, interactions with the community, etc. In other embodiments, the applet may be a weather program customized to show the weather of the location of the user. For example, if the user's daily activity includes an outdoor action, the system may customize the applet to show the weather because weather is a factor relating to the user's activity. In yet further embodiments, the applet may be health related videos, messages, or information, such as, for example, a message to remind the user to perform a prostate exam, breast cancer check, or the like. These applets may be customized for the user based on the user's age, gender, overall health score, and the like. The applets may also be information related to the user's community, including external activities such as volunteer opportunities and other such activities that the user may have an interest in based on information the system knows about the user. The applets may also be more generalized information, such as, for example, local news, national news, stock market information, general health information which incentivizes healthy living, total rewards points information, score information, or any other information that may be relevant to the user.

The community section 3136 and the rewards sections 3038 allow a user to view information about the community and his/her rewards totals, respectively. The community section 3136 and rewards sections 3038 may, in some embodiments, enable a user to navigate to the same or similar locations in the system as the community link 3106 and the rewards link 3108 in the header 3102.

The header 3102 allows the user to navigate from the profile to other areas of the system. For example, the header provides for the home link 3104 which enables the user to navigate to a home page. In some embodiments, the screenshot 3100 is the home page. However, in other embodiments, the home page may be different than the screenshot 3100. The community link 3106 enables the user to view a community activity stream and other information about the community, as described above. The rewards link 3108 allows the user to navigate to a rewards page where users can determine point totals and redeem the points for different items, as described above. The history link 3110 enables the user to view a historical presentation of his/her interaction with the system. In some embodiments, the history includes presentation of all interactions with programs, the community, rewards system, score increases and decreases, and the like. The living link 3112 allows the user to navigate to a page where the user has an opportunity to view and/or search for local deals, activities, volunteer opportunities, outdoor community activities, events, or the like, based in the city of residence of the user.

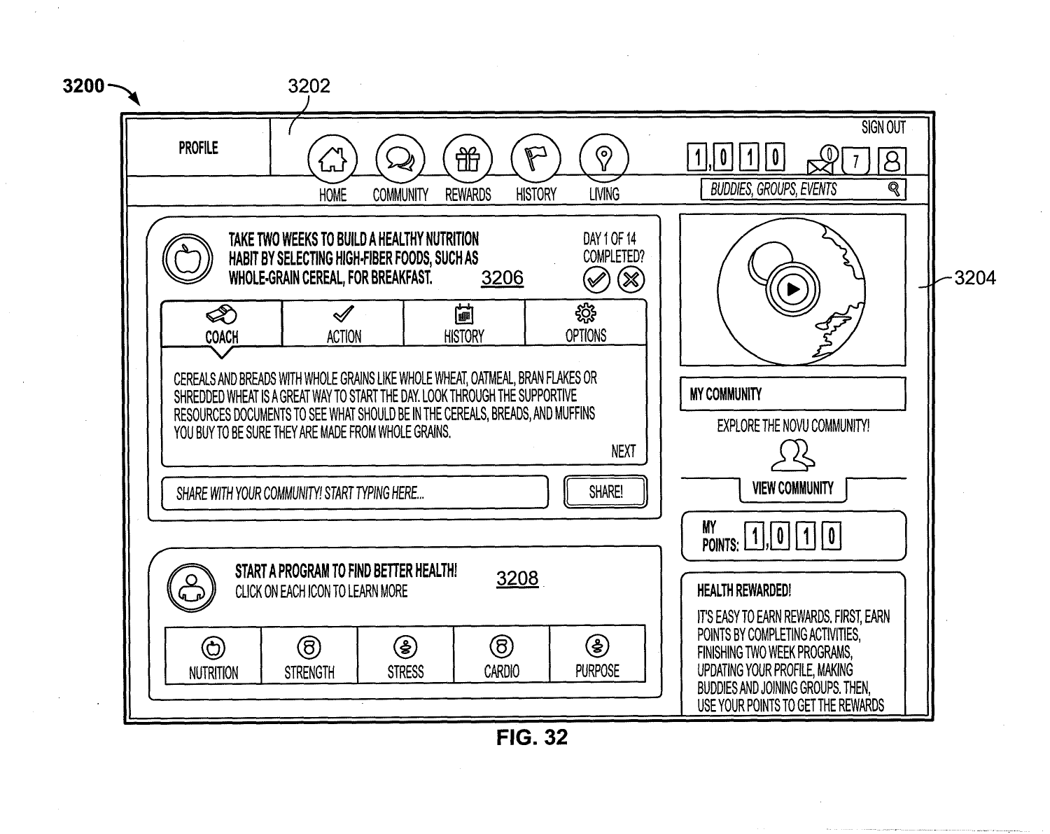

Now referring to FIG. 32, a screenshot 3200, which is an alternate embodiment of a user profile, is shown. The screenshot 3200 includes a header 3202, a sidebar 3204, a first program box 3206, and a second program box 3208. The header 3202 and the sidebar 3204 act similarly as the header 3102 and the sidebar 3032, described above with reference to FIG. 31.

In general, the screenshot 3200 is similar to the screenshot 3100; however, the second program box 3208 differs from the second program box 3130. In the present embodiment, the user is actively engaging in only one program, as depicted by the first program box 3206. The profile also includes the second program box 3130 to enable the user to begin a second program if so desired by the user. The second program box 3130 includes five goal options, for example, nutrition, strength, stress, cardio, and purpose. It is understood that in alternate embodiments, further program options may exist, as described above. In some embodiments, each goal may include an identifier associated with the goal type, such as, for example, icons as depicted in the second program box 3130. The user may click on one of the goal identifiers to begin a program within the selected goal. The process to being the program is similar to what has been described herein. In the embodiment, upon beginning a new program, the user's present program continues concurrently with the new program. It is also understood that, in some embodiments, a user may engage in more than two programs simultaneously.

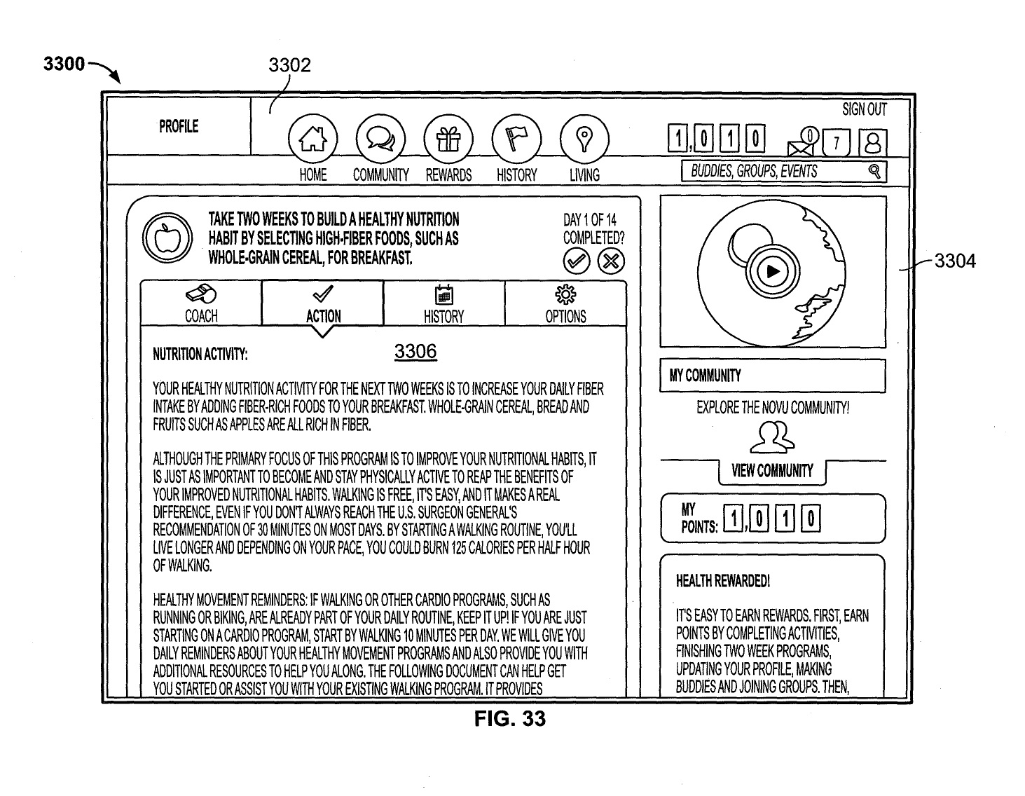

Referring now to FIG. 33, a screenshot 3300, which is an alternate embodiment of a user profile, is shown. The screenshot 3200 includes a header 3302, a sidebar 3304, and a first program box 3306. The header 3302 and the sidebar 3304 act similarly as the header 3102 and the sidebar 3032, described above with reference to FIG. 31.

The first program box 3306 is one embodiment of what is presented to a user upon selecting, for example, the action section 3122 of FIG. 31. When selected, the action section option enables the user to view detailed information related to the present activity associated with the program. For example, first program box 3306 may include information on how to properly perform the daily/weekly activity assigned by the program, why the daily/weekly activity is helpful, and other documents, videos, or guidance related to the activity. In some embodiments, this section may include links to videos showing how to efficiently perform the activity. In other embodiments, the section may include links to documents further explaining how to perform the activity. In yet further embodiments, links to podcasts discussing information related to the activity or the program in general may be found in this section.

The first program box 3306 may further include reminders and/or notifications regarding the daily/weekly activity and/or program. The reminders and/or notifications may be generic to all participants of the program and include health warnings about the daily/weekly activity. However, in other embodiments, the reminders and/or notifications may be customized to the particular user based on the user's previous performance in the program, interaction with the system, age, gender, and/or other information known about the user by the system.

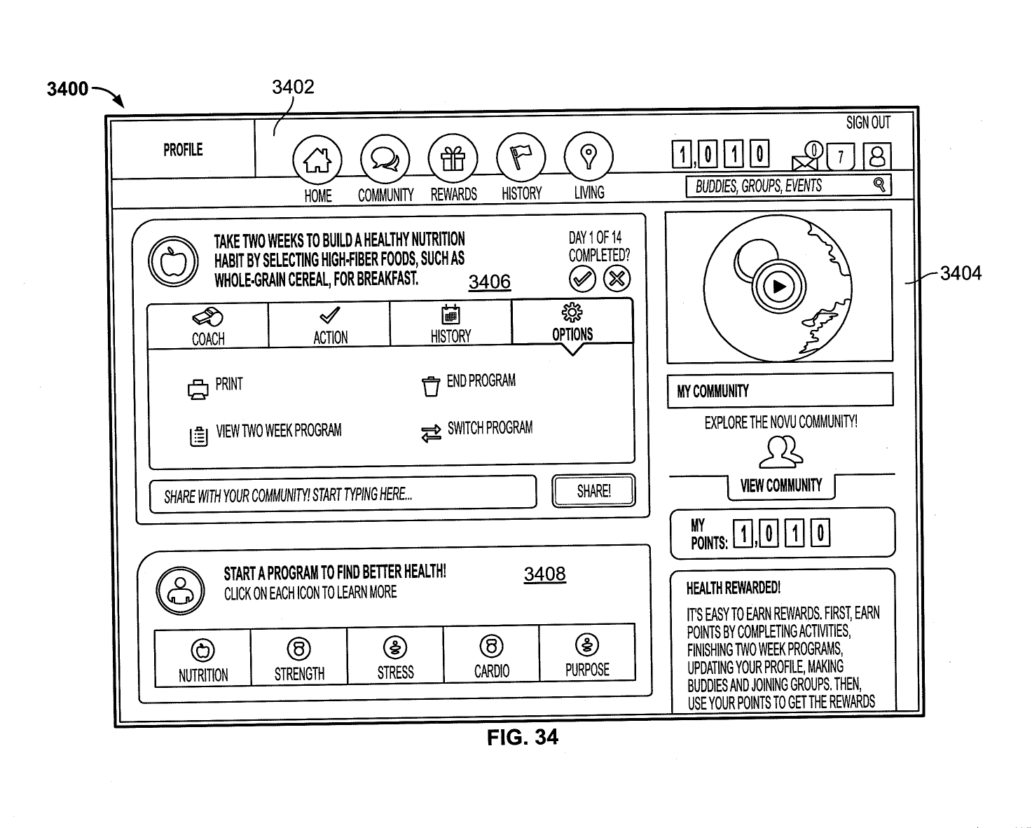

Referring now to FIG. 34, a screenshot 3400, which is an alternate embodiment of a user profile, is shown. The screenshot 3400 includes a header 3402, a sidebar 3404, a first program box 3406, and a second program box 3408. The header 3302 and the sidebar 3304 act similarly as the header 3102 and the sidebar 3032, described above with reference to FIG. 31. The second program box 3408 is similar to the second program box 3208 in FIG. 32.

The first program box 3406 is one embodiment of what is presented to a user upon selection of the options section 3126, as shown in FIG. 31. The first program box 3406 presents the user with several options related to the specific program. In particular, the user may print the program information, view the two-week program, end the program, or switch the program. It is understood that though the present program is a two-week program, other programs may be one week to four weeks long, in some embodiments.

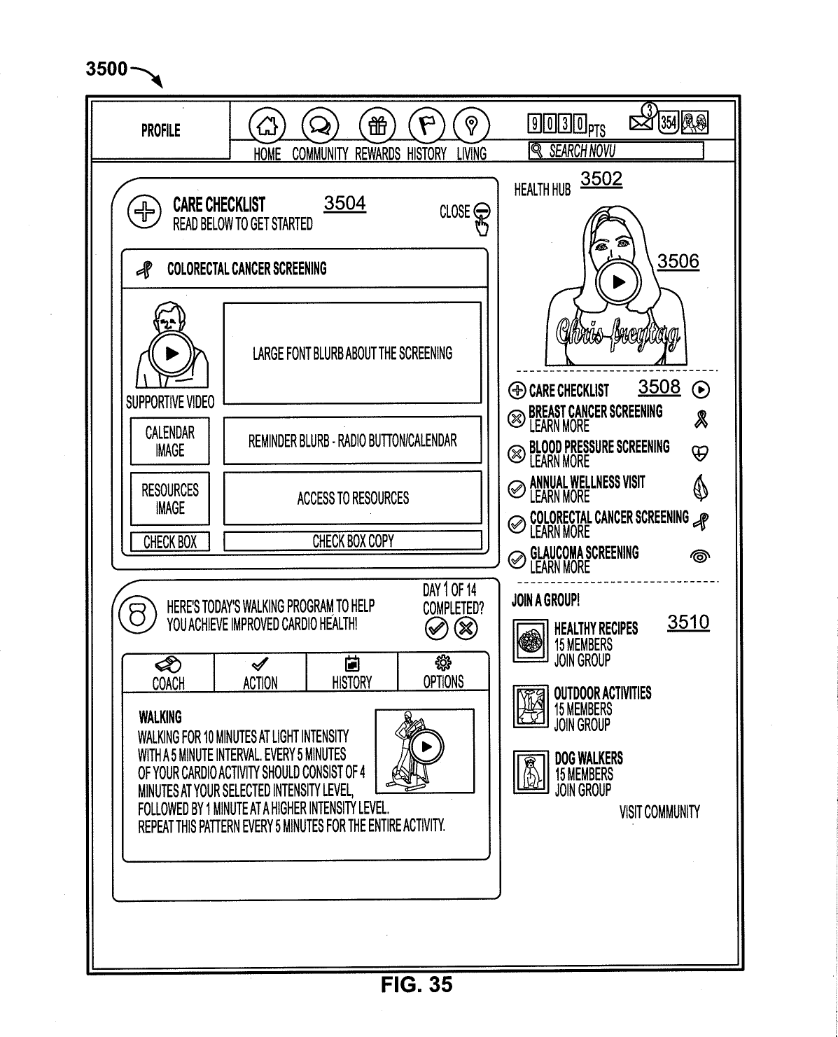

Referring now to FIG. 35, a screenshot 3500, which is an alternate embodiment of a user profile, is shown. The screenshot 3500 includes a health hub 3502, a care checklist 3504, and suggested groups section 3510. The health hub 3502 includes an applet 3506 and a checklist section 3508.

The health hub 3502 provides information to the user about health related information, such as health screenings. In some embodiments, the health hub 3502 includes the applet 3506. As stated above, the applet 3506 may include any message, video, information, or the like, which may be customized to the user. In the particular embodiment, the applet 3506 includes a video related to healthy living and fitness which the user may click to view.

The health hub 3502 also includes the checklist section 3508. In some embodiments, the checklist section 3508 may also be an applet. The checklist section 3508 may include information relating to various health relating activities, such as, for example, health screenings. For example, the checklist section 3508 may include information about breast cancer screening, blood pressure screening, annual wellness screening, colorectal cancer and/or other cancer screenings, glaucoma screenings, and the like. Based on the information provided by the user, the checklist section 3508 may also indicate whether the user has had the listed screening within a certain amount of time. For example, in the present embodiment, a check mark next to the screening name may indicate that the user has undergone the screening; however, an “X” may indicate that the user has yet to perform the identified screening. The checklist section 3508 may also include “learn more” links to further information about each screening or health related activity.

In some embodiments, the care checklist 3504 is what is presented to a user upon clicking a “learn more” link in the checklist section 3508. For example, in the present example, the user's input device has clicked “colorectal cancer screening” and the care checklist 3504 with more information about colorectal cancer screening has appeared on the user profile. In yet further embodiments, it is not necessary for the user to click on a link to view the care checklist 3504. Instead, the system presents information in the care checklist 3504 based on information about the user, such as when the user has scheduled the particular screening. The care checklist 3504 may act as a reminder for a user about the particular screening.

In the present embodiment, the care checklist 3504 includes further information about colorectal cancer screening. It is understood that in other embodiments, the care checklist 3504 may include information on other screenings relevant to the particular user. In some embodiments, the care checklist 3504 includes calendar information regarding when the user has scheduled the particular screening. The care checklist 3504 may also include the location of the screening, directions on how to get to the screening, information relating to food intake prior to the screening, other health-related information about the screening, and links to other information about the screening. In other embodiments, the care checklist 3504 may also include a video, message, and/or podcast which provides support to the user about the screening and other information that may be relevant to the screening.

The suggested groups section 3510 includes a listing of groups suggested to the user by the system based on information about the user. For example, the system may utilize information, such as the user's age, gender, interests, programs, community posts, other groups, and/or challenges, to determine recommendations that the user may appreciate based on this information. In other embodiments, the suggested groups section 3510 may not be customized for the particular user, but may include newly added groups to the system.

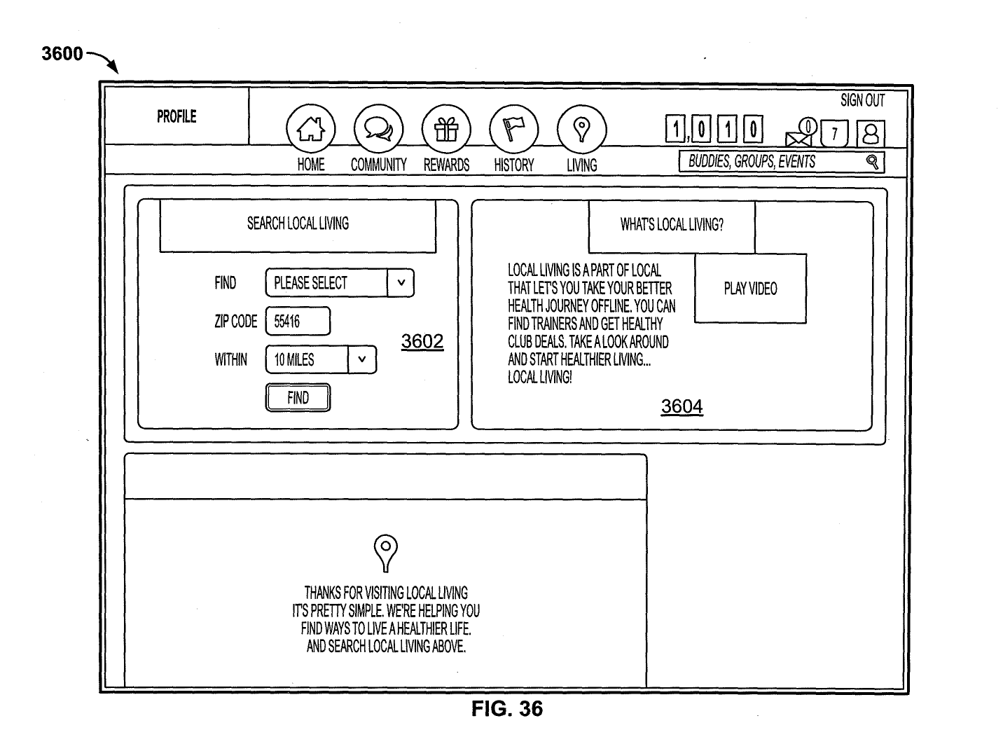

Now referring to FIG. 36, one embodiment of a screenshot 3600 is shown. The screenshot 3600 includes a search area 3602 and an informational section 3604. In general, the screenshot 3600 is one example of what is presented to the user upon selecting the living link 3112.

In general the screenshot 3600 allows the user to search for local facilities, events, and activities in a particular area where the user can engage in to better their lifestyle. For example, local opportunities may include gyms, trainers, health clubs, volunteer opportunities, support groups, entertainment events, such as shows, restaurants, and the like. The user may utilize the search area 3602 to select the type of opportunity, the zip code of the area, and a distance surrounding the zip code. This allows the user to engage in a healthy lifestyle when not interacting with the system. In other embodiments, more detailed searching may be available, which allows the user to input the specific type of activity or a name of a particular health club, restaurant, show, organization, or the like.

The informational section 3604 may enable the user to learn more information about the local aspects of healthy living. In some embodiments, the informational section 3604 may include a video or podcast explaining the opportunities available through the local living screen. In addition, the informational section may include links to further information about external opportunities or a link to all local opportunities in the particular area where the user lives.

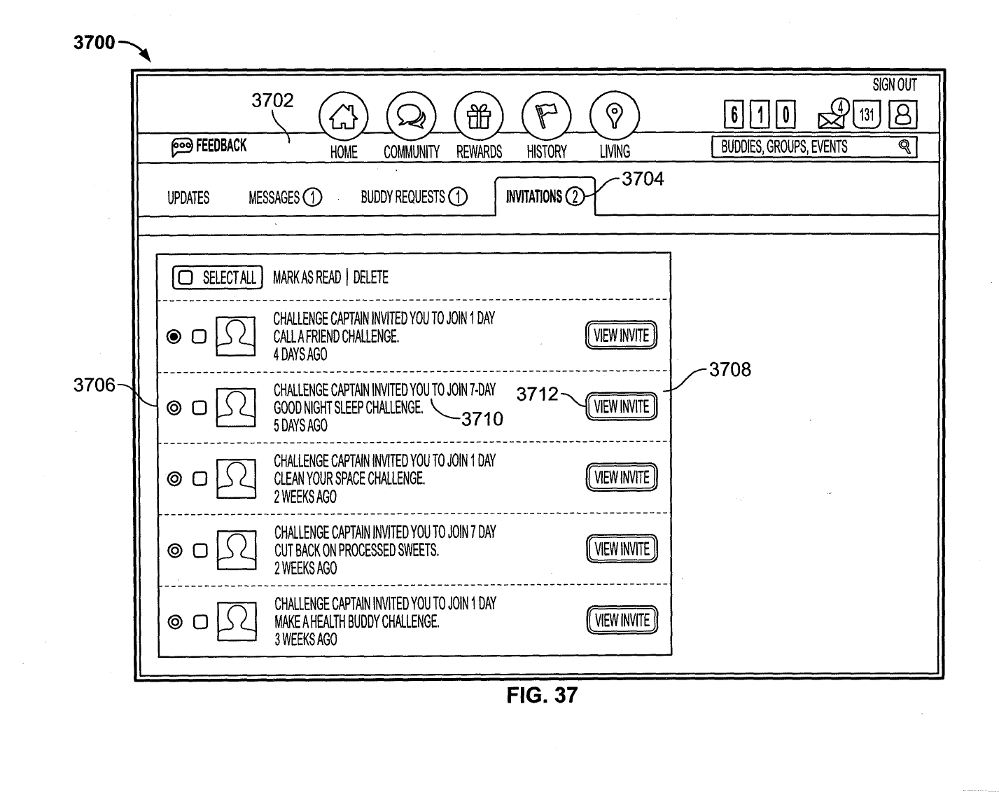

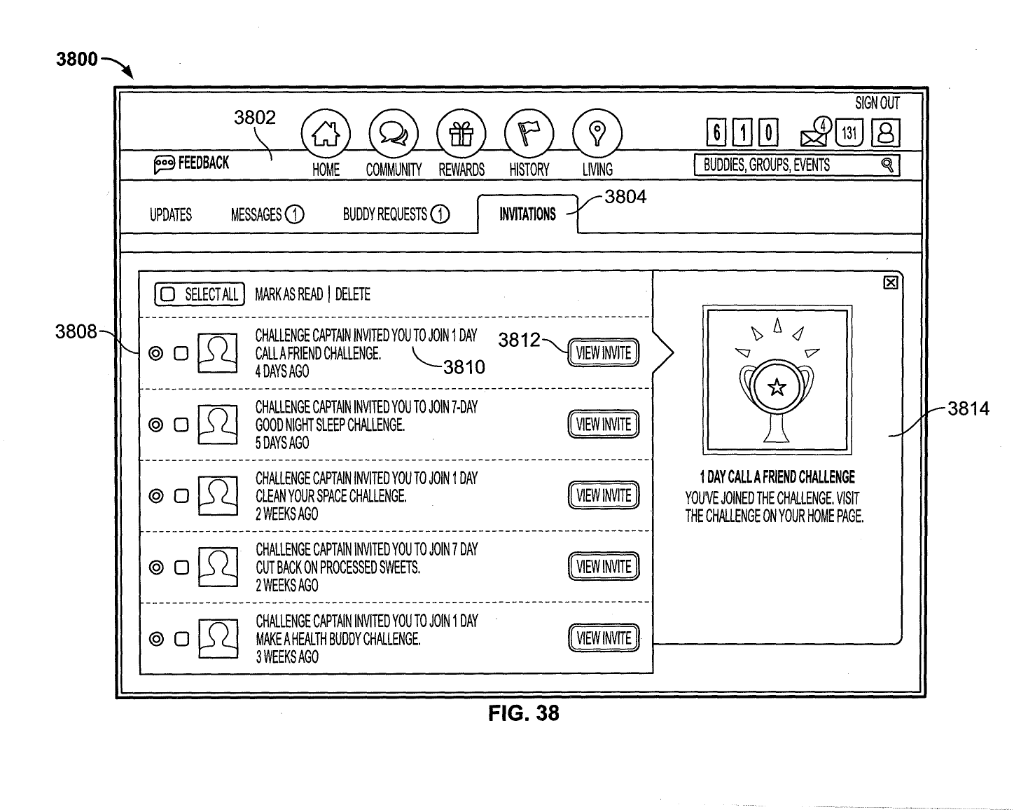

Now referring to FIG. 37, one embodiment of an invite screenshot 3700 is shown. The screenshot 3700 includes a header 3702, an invitations tab 3704, and invitations 3706. Each invitation in the invitations 3706 includes an inviter 3708, a challenge description 3710, and a view invitation button 3712.

In general, the invite screenshot 3700 is directed to challenge invitations. As stated above, the challenge engine 808 controls the creation and user engagement with challenges. In general, a challenge is an activity created by a user or an administrator. The challenge is then either sent to a user or found by a user for user engagement. For example, a user may create a challenge in which the activity is to run a half marathon. The user may then send the challenge to a social connection and “challenge” the social connection to engage in the challenge. If the social connection agrees to participate in the challenge, and accomplishes the challenge, the social connection may be awarded one or more points.

The invite screenshot 3700 is one example of a screen presented to a user illustrating all challenges sent to the user by other users or administrators of the system. Each of the challenge invitations 3706 indicate the inviter 3708 (e.g., the person who sent the invitation), the description of the challenge 3710, and allows the user to view further details about the challenge by selecting the view invitation button 3712.

The description of the challenge 3710 may include a variety of information in summary form. The summary enables a user to gather basic knowledge about a challenge to determine level of interest in the challenge. For example, some information in the summary may include: a title of the challenge, a start date and/or end date of the challenge, a picture indicative of the challenge, rewards and/or points associated with completing the challenge, the strenuous nature of the challenge, etc. If the user is intrigued by the summary, the user may select the view invitation button 3712 to learn more detailed information about the challenge.

Now referring to FIG. 38, one embodiment of an invite screenshot 3800 is shown. The screenshot 3800 includes a header 3802, an invitations tab 3804, invitations 3806, and an invitation viewer 3814. Each invitation in the invitations 3806 includes an inviter 3808, a challenge description 3810, and a view invitation button 3812. In general, the screenshot 3800 is one example of the screen viewable by a user upon selecting the view invitation button 3812.

Upon selecting the view invitation button 3812, the invite screenshot 3800 may present a detailed description of the challenge in the invitation viewer 3814. The detailed description may include, for example, a title of the challenge, a “join by” date of the challenge, start and/or end dates of the challenge, a description of the problems, goals, and solutions addressed and/or resolved by the challenge, resources relevant to the challenge (e.g., links, videos, articles, tutorials, websites), prizes associated with successful completion of the challenge, and/or a “join” button.

The “join-by” date is a date by which the user must sign up for a challenge. If the join-by date has passed, in some instances, the challenge invite may disappear. In other instances, upon selected the view invitation button 3812, the invitation viewer 3814 may indicate that the challenge “join-by” date has expired.

Upon reviewing the invitation viewer 3814, a user has the option to join the challenge by selecting the join button. If the join-by date has passed, in some example, the join button may not be present in the invitation viewer 3814.

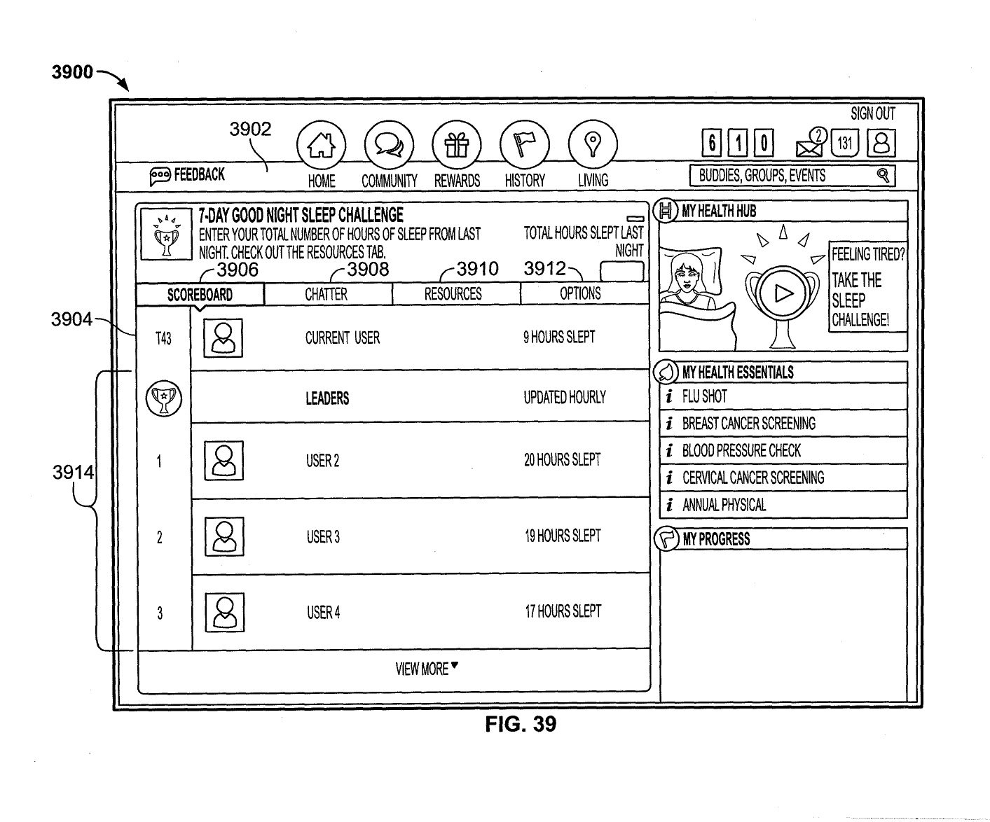

Now referring to FIG. 39, one embodiment of a screenshot 3900 is shown. The screenshot 3900 includes a header 3902 and a challenge monitoring box 3904. The challenge monitoring box 3904 includes a scoreboard tab 3906, a chatter tab 3908, a resources tab 3910, and an options tab 3912. The scoreboard tab 3906, when selected, displays a scoreboard 3914. In general, the screenshot 3900 is one example of a screenshot that is displayed to the user upon selecting the join button, as shown in the invite viewer 3814 in FIG. 38.

In some embodiments, such as the present example, the screenshot 3900 includes various tabs (e.g., tabs 3906-3912). The screenshot 3900 is one example of what is presented to a user selection of the scoreboard tab 3906. As shown in the illustration, selecting the scoreboard tab allows the user to view the scoreboard 3914. In some embodiments, the scoreboard 3914 includes a running list of all participants in the challenge and a score associated with each participant. The running list may be arranged from the highest scoring participant to the lowest scoring participant, vice versa, or in a random or other order.

In some embodiments, the user may be able to select a participant to view a history of all challenge entries associated with that participant for the challenge. If the challenge has completed, the scoreboard 3914 may provide a final list of participants and final scores and/or rankings associated with each participant. In other embodiments, the scoreboard 3914 may simply indicate the winner of the challenge or a ranking of the top number of participants in the challenge (e.g., the top five scoring participants in the challenge). The scoreboard 3914 may alternatively or additionally include a prize or prizes awarded to the listed participants.

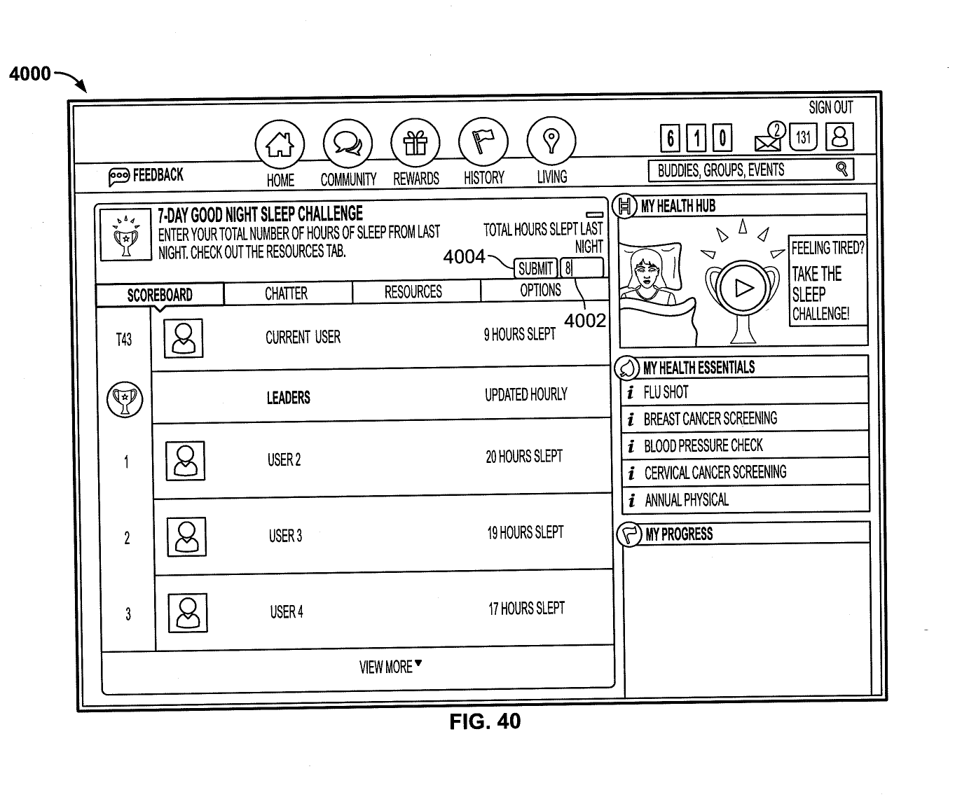

Now referring to FIG. 40, one embodiment of a screenshot 4000 is shown. In general, the screenshot 4000 is one example of the screenshot 3900. The screenshot 4000 includes a user entry box 4002 and a submit button 4004.

More specifically, the screenshot 4000 is an example screen presented to a user to enable user entry submission relating to a challenge. In the example, the user may utilize an input device to enter a number of hours slept in the “7-Day Good Night Sleep Challenge.” To enter a number of hours, the user types the number into the user entry box 4002. Once the user ensures that the number of hours is entered correctly, the users may select the submit button 4004 to submit the number into the challenge.

It is understood that in other embodiments, the challenge may require an entry in the form of a “Yes/No” response instead of a number or other types of entries. For example, in one embodiment, the challenge may be require that a user takes a walk each day. In the user entry, the user may submit the answer, “yes” if the user has taken a walk on a particular day or a “no” if the user has not taken a walk on a particular day. In some challenges, an entry may be required daily, whereas in other challenges, entries may be required hourly, weekly, semi-weekly, another periodic and predetermined time interval, or at other intervals.

After submitting the entry, in some embodiments, the user entry is publicly accessible to all members associated with the challenge, all friends of the user, or to the entire public. In other embodiments, the user entry may be private or somewhat private, and thus, the user entry may be limited to a certain audience dictated either by the challenge rules, the administrators, or the user.

The user's entries are tabulated to create a ranking of all users entered into the challenge. It is understood that scoring methods may differ for different challenges. For example, challenges that specify numerical user entries may require that the user with the highest added total wins the challenge. Alternatively, other challenges may specify that the user with the lowest added total wins the challenge. In cases where the challenge specifies a “yes/no” response, the user with the greatest number of “yes” responses may win. Alternatively, the user with the greatest number of “no” responses may win other challenges. In some embodiments, a challenge may require both sets of entries. In more complicated challenges, scoring may be dependent on consistency. For example, such scoring may be based on the greatest number of continuous “yes” or “no” responses. In general, it is understood that alternate challenges may require alternate scoring mechanisms. In some embodiments, the type of scoring is determined by the creator of the challenge during the template creation process.

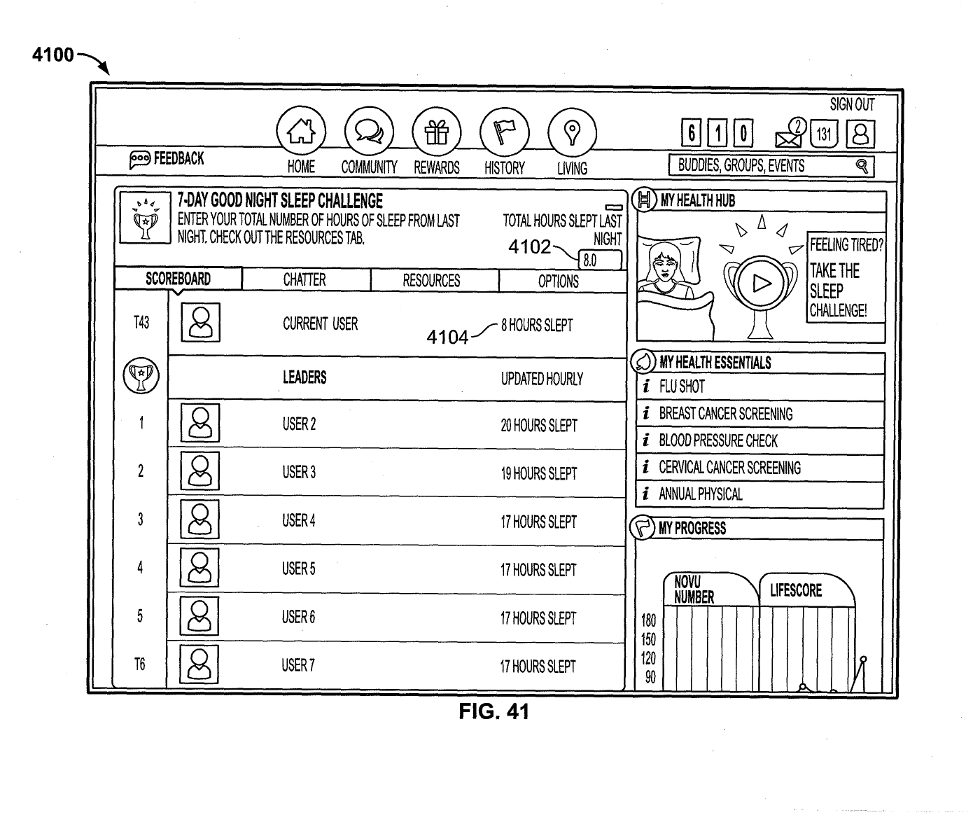

Now referring to FIG. 41, one embodiment of a screenshot 4100 is shown. In general, the screenshot 4100 is one example of what is presented to a user upon user entry in the screenshot 4000. The screenshot 4100 includes a user entry box 4102 and a user entry summary 4104.

In general, the screenshot 4100 depicts an example of what is presented to a user upon submitting an entry to a challenge. For example, the user entry box 4102 may indicate the user submission. In some examples, a user may correct any errors by resubmitting an entry via the user entry box 4102. In addition, in some embodiments, the user entry summary 4104 indicates what is presented to the audience of the entry. For example, in the screenshot 4100, the user entry summary 4104 includes the user's name, a picture depicting the user, and the user entry.

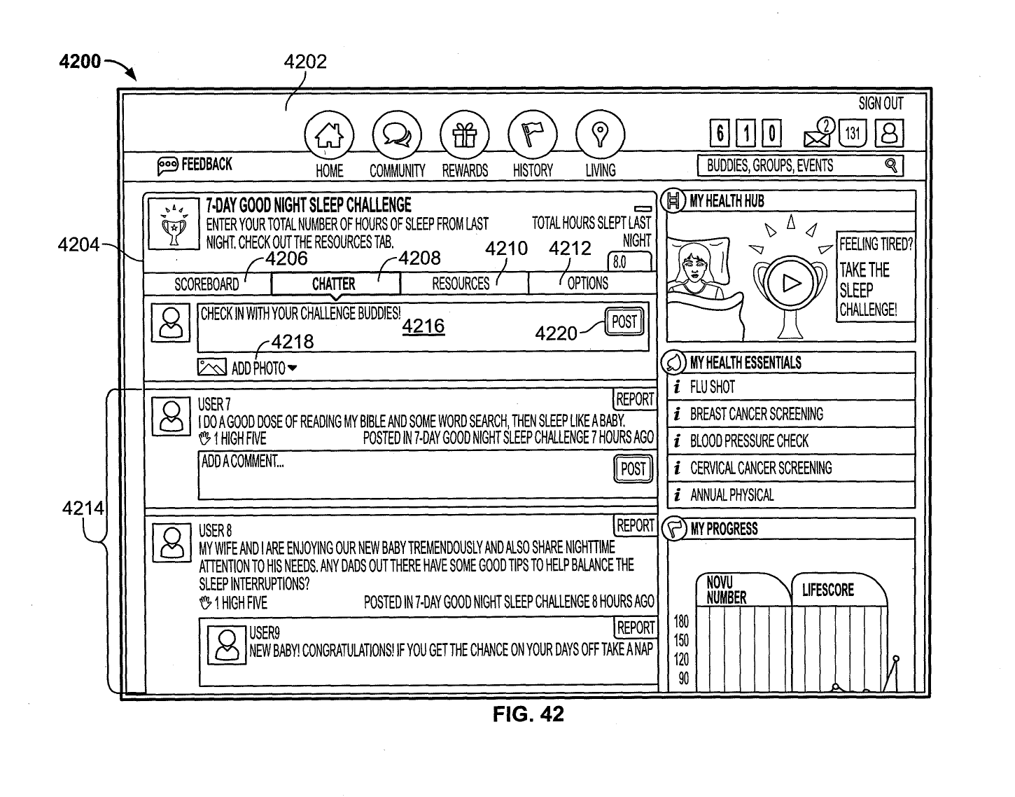

Now referring to FIG. 42, one embodiment of a screenshot 4200 is shown. The screenshot 4200 includes a header 4202 and a challenge monitoring box 4204. The challenge monitoring box 4204 includes a scoreboard tab 4206, a chatter tab 4208, a resources tab 4210, and an options tab 4212. The chatter tab 4208, when selected, displays a chatter stream 4214, a chatter entry box 4216, a photo submission button 4218, and a post button 4220. In general, the screenshot 4200 is one example of a screenshot that is displayed to the user upon selecting the chatter tab 4208, such as the chatter tab 3908 in FIG. 39.

More specifically, the screenshot 4200 depicts what is presented to the user upon beginning a challenge and selecting the chatter tab 4208. The chatter tab 4208 enables the user to interact with other members associated with the challenge. The chatter stream 4214 enables the user to view comments from other users and conversations relating to the challenge. Users may post messages or comments relating to the challenge, such as, for example, encouraging notes, inspirational posts, discussions about difficulties, or other related comments. Users may also respond to comments on the chatter stream 4214.

To add a post to the chatter steam 4214, the user may utilize the chatter entry box 4216. The user may input a message via an input device into the chatter entry box 4216. Thereafter, the user selects the post box 4220 to submit the entry to the chatter stream 4214. The chatter stream 4214 enables the user to interact with the community and potentially make connections with other users with similar interests. In addition, the chatter stream 4214 allows the user to engage in motivational and influential interaction with other users with potentially similar goals as the user.

In some instances, the photo submission button 4218 may exist to enable the user to add a photo to his/her entry. The photo submission button 4218, once selected, may enable the user to select from a list of photos present locally on the user's computer. In other embodiments, the photo submission button 4218 may also enable the user to select from a pre-selected library of photos or photos accessible on the Internet.

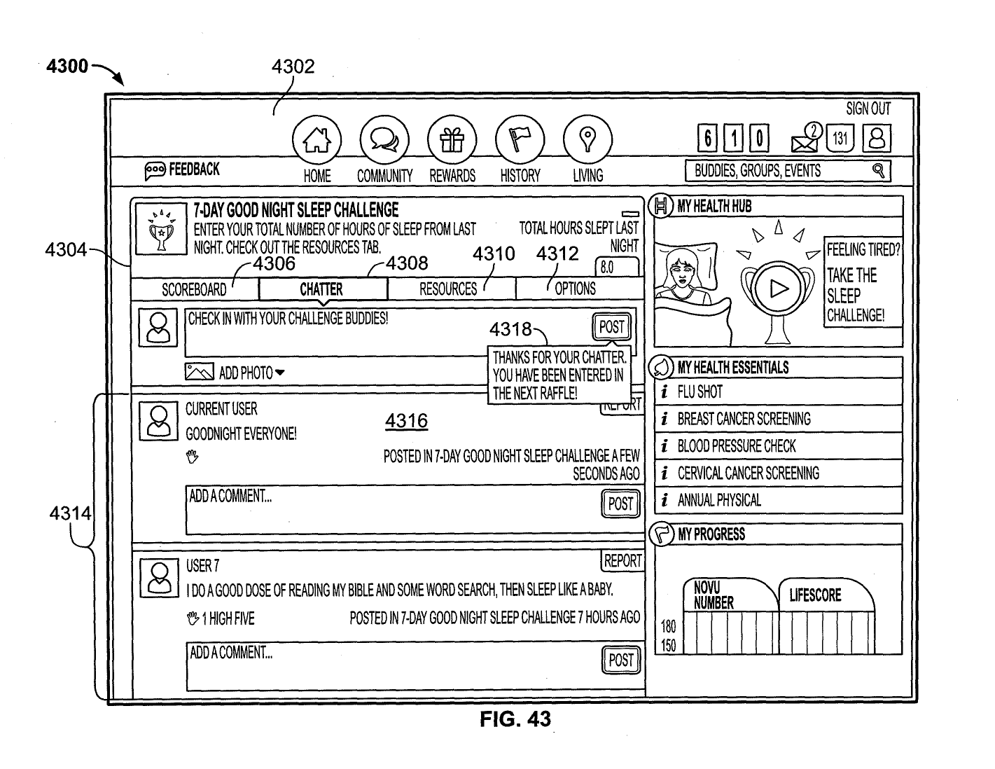

Now referring to FIG. 43, one embodiment of a screenshot 4300 is shown. The screenshot 4300 includes a header 4302 and a challenge monitoring box 4304. The challenge monitoring box 4304 includes a scoreboard tab 4306, a chatter tab 4308, a resources tab 4310, and an options tab 4312. The chatter tab 4208, when selected, displays a chatter stream 4314, a recent user entry 4316, and a raffle note 4318. In general, the screenshot 4300 is one example of a screenshot that is displayed to the user upon selecting the chatter tab 4308 and posting an entry to the chatter stream 4314 via the user entry box 4216, shown in FIG. 42.

As shown in the example, upon entering the message “Goodnight everyone!” into the user entry box 4216, the message appears in the chatter stream 4314 and is viewable by all members with access to the challenge. Further, upon submitting the post, the raffle note 4318 appears, which states, “Thanks for your chatter. You have been entered into the next raffle!” Though the raffle note 4318 may not always appear upon submitting a post, in some instances, the system provides incentives to engage with the community such as a raffle. Other incentives may include, for example, rewards, prizes, points, gifts, or the like.

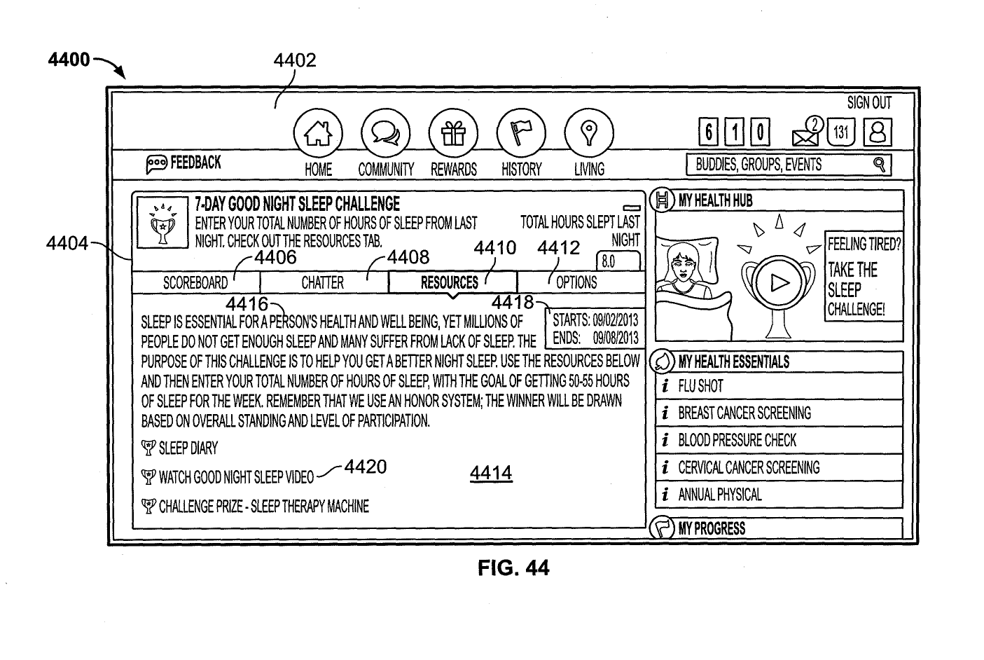

Now referring to FIG. 44, one embodiment of a screenshot 4400 is shown. The screenshot 4400 includes a header 4402 and a challenge monitoring box 4404. The challenge monitoring box 4404 includes a scoreboard tab 4406, a chatter tab 4408, a resources tab 4410, and an options tab 4412. The resources tab 4410, when selected, displays a resources box 4414. The resources box 4414 may include a description 4416, applicable dates 4418, and links 4420. In general, the screenshot 4400 is one example of a screenshot that is displayed to the user upon selecting the resources tab 4410, such as the resources tab 3910 in FIG. 39.

In particular, the screenshot 4400 displays what is presented to the user upon joining a challenge and selected the resources tab 4410. The resources box 4414 provides any variety of useful information to the user about the challenge. For example, the description 4416 may include the purposes, goals, and reasoning for the challenge. The description may also include health benefits of the challenge. In some embodiments, the description 4416 is created by the creator of the challenge. The applicable dates 4418 may include the start, end, and joining dates of the challenge. The links 4420 may include any links to photos, videos, articles, or the like which the user may access to learn more about the challenge and/or topics related to the challenge. It is understood that one or more of the items within the resources box 4414 may not exist in all embodiments of the resources box 4414. In addition, it is understood that further educational, motivational, inspirational, or useful information may be present in the resources box 4414.

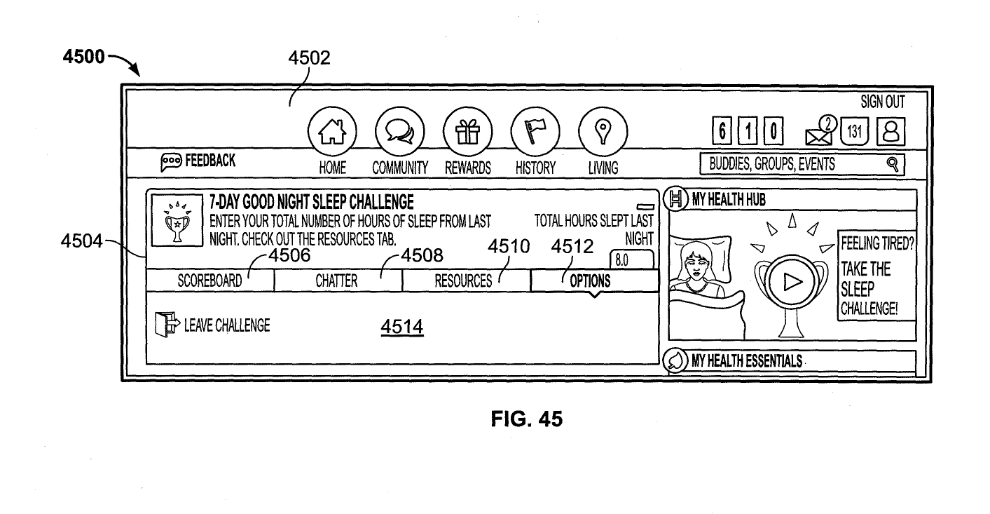

Now referring to FIG. 45, one embodiment of a screenshot 4500 is shown. The screenshot 4500 includes a header 4502 and a challenge monitoring box 4504. The challenge monitoring box 4504 includes a scoreboard tab 4506, a chatter tab 4508, a resources tab 4510, and an options tab 4512. The options tab 4512, when selected, displays an options box 4514. In general, the screenshot 4500 is one example of a screenshot that is displayed to the user upon selecting the options tab 4512, such as the chatter tab 3912 in FIG. 39.

In the example embodiment, the options box 4514 includes a link which, when selected, allows the user to leave the challenge. In other examples, the options box 4514 may include other options, such as privacy controls (e.g., audience control settings for chatter posts and user entries). Other options or tools which may be beneficial for the user to change settings relating to the challenge may exist in the options box 4516 in other embodiments.

The various examples and embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method comprising:
displaying, on a user interface, an initial assessment;
calculating one or more scores based on answers received in response to the initial assessment;
displaying, on the user interface, a recommended goal based on at least one of the one or more scores;
receiving a selected goal;
displaying, on the user interface, a recommended plan based on the selected goal and at least one of the one or more scores;
receiving a selected plan;
displaying, on the user interface, a recommended program based on the selected plan and at least one of the one or more scores;
receiving a selected program; and
based on user program performance, updating at least one of the one or more scores.

2. The method of claim 1 further comprising:
displaying, on the user interface, a secondary assessment based on at least one of: the selected goal, the selected plan, and the selected program.

3. The method of claim 2 further comprising:
updating at least one of the one or more scores based on secondary answers received in response to the secondary assessment.

4. The method of claim 1 further comprising:
awarding point based on the user program performance.

5. The method of claim 1 further comprising:
displaying, on the user interface, at least one of the one or more scores.

6. The method of claim 1 wherein the one or more scores comprises an overall progress score which indicates the user's motivation.

7. The method of claim 1 wherein the one or more scores comprises an addition of a first sub-score, a second sub-score, and a third sub-score, wherein the first sub-scores is related to commitment, the second sub-score is related to updating information, and the third sub-score is related to community participation.

8. The method of claim 6 further comprising displaying a success rate after a predetermined time period.

9. A method comprising:
sending, via an input device, answers based on an initial assessment of questions;
viewing, on a user interface, a recommended goal presented in response to the answers and further viewing at least one alternate goal;
selecting, via the input device, a goal;
viewing, on the user interface, a recommended plan presented in response to the goal selected and further viewing at least one alternate plan;
selecting, via the input device, a plan;
viewing, on the user interface, a recommended program presented in response to the plan selected and further viewing at least one alternate program; and
selecting, via the input device, a program.

10. The method of claim 9 comprising:
sending, via the input device, secondary answers based on a secondary assessment of questions.

11. The method of claim 9 comprising:
viewing, on the user interface, a program schedule in response to selecting the program.

12. The method of claim 11 wherein the program schedule includes an activity for each day in a two-week period of time.

13. The method of claim 9 comprising:
receiving points based on completing the program selected.

14. The method of claim 13 comprising:
redeeming the points for at least one of: products, charitable donations, deals, and sweepstakes.

15. The method of claim 14 wherein the sweepstakes comprise task sweepstakes and point sweepstakes.

16. The method of claim 9 further comprising:
viewing, on the user interface, at least one score presented in response to the answers.

17. A method of guiding a person toward a healthier lifestyle, the method comprising:
prompting the person to complete an initial assessment;
identifying a healthier lifestyle goal for the person based at least in part on one or more scores computed from answers to the initial assessment;
identifying and presenting to the person a recommended plan based at least in part on the selected goal and at least one of the one or more scores;
identifying and presenting to the person a recommended program based at least in part on the selected plan and at least one of the one or more scores; and
monitoring the person's progress according to the recommended program and updating at least one of the one or more scores based at least in part on the person's progress.

18. The method of claim 17, wherein the goal is one of: a stress reduction goal, a sleep improvement goal, a smoking cessation goal, a financial health goal, a cognitive goal, a relationship improvement goal, a chronic condition management goal, a depression reduction goal, an occupational health goal, a drug adherence goal, and a family wellness goal.

19. The method of claim 17, wherein the program comprises a short-term set of daily activities, wherein each of the daily activities, if performed by the person, assist the person to achieve the identified healthier lifestyle goal.

20. The method of claim 19, wherein a plan includes a set of multiple different programs, wherein each of the multiple different programs in the set are associated with the goal.

21. The method of claim 17, wherein the at least one score is a life score that provides an indication of the person's desire to change.

22. The method of claim 17, wherein the at least one score is a c-score that provides an indication of the person's overall wellness.

23. The method of claim 17, wherein the at least one score is a progress score that provides an indication of the person's progress at least toward the goal.

24. The method of claim 17, further comprising storing data associated with the person's progress toward the goal in an electronic medical record associated with the person.

25. The method of claim 17, further comprising retrieving information from an electronic medical record and using the information as part of the initial assessment.

26. The method of claim 17, further comprising adjusting the one or more scores using data retrieved from the person's electronic medical record.

27. A method of providing rewards to users of a system, the method comprising:
defining point rewarding activities within the system;
awarding points to users for performing one or more of the activities;
providing rewards to the users in exchange for at least some of the points, wherein the rewards have no per-unit cost to the system provider.

28. The method of claim 27, wherein the rewards are at least one of: a discount on goods or services, a vote for a charity to which a charitable contribution will be made, an entry into a raffle for an item, and a coupon that provides a discount on goods or services.

29. A method of rewarding activity within an online community, the method comprising:
providing a rewards engine configured to manage points for users within the online community;
providing a point definition engine, the point definition engine operable to receive an identification of events within the online community for which points are to be awarded; and
and operating the rewards engine to award points to users within the online community when the identified events occur within the online community.

30. The method of claim 29, wherein the point definition engine is operable to identify any detectable activities within the online community and to associate point values to such activities to reward users for the occurrence of the events.

31. A method of providing rewards to patients for following the advice of a health care professional, the method comprising:
receiving an identification of one or more actions recommended by a health care professional for a person;
awarding points to the person when the person performs the recommended actions; and
providing a reward to the person in exchange for at least some of the points.

32. A system including at least a processing device and a computer readable storage medium, wherein the computer readable storage medium stores data instructions, which when executed by the processing device cause the processing device to execute any one or more of the methods of claims 1-31.

33. Any one or more of the systems or methods described herein.

34. Any one or more of the systems or methods illustrated in the figures.

35. The method of claim 1, further comprising:
receiving a second selected program, and
based on user performance with respect to the second selected program, updating at least one of the one or more scores.

36. The method of claim 17, further comprising:
searching for local opportunities based on the person's residential location;
presenting to the person a listing of the local opportunities, wherein the local opportunities include at least one of: volunteer opportunities, restaurants, training events, health clubs, and entertainment opportunities.

37. The method of claim 17, further comprising:
presenting to the person information related to health screenings, wherein the health screenings include at least one of: breast cancer screening, blood pressure screening, annual wellness screening, colorectal cancer, and glaucoma screenings.

38. The method of claim 37, further comprising:
presenting to the person reminders about scheduled health screenings.

39. The method of claim 37, further comprising:
presenting to the person a customized applet based on the person's health-related information.

40. A method of challenging users, the method comprising:
presenting a list of challenges to a first user;
receiving a selection of a first challenge in the list of challenges from the first user;
receiving periodic user entries from the first user relating to the first challenge;
scoring the user entries in relation to entries received from other users;
ranking the first user in relation to the other users; and
presenting the ranking to the first user.

41. The method of claim 40, wherein the list of challenges include challenges created by at least one of the other users and administrators.

42. The method of claim 40, wherein the challenges include competitive health activities.

43. The method of claim 40, wherein the user entries are numerical.

44. The method of claim 40, wherein the user entries are received at least one of: daily, weekly, semi-weekly, and monthly.

45. The method of claim 40, further comprising:
rewarding the first user for interacting with the other users.

46. The method of claim 40, further comprising:
rewarding the first user for participating in the first challenge.

47. The method of claim 40, further comprising:
selecting a winner of the first challenge based on the scoring.
